(19) United States
(12) Patent Application Publication
(10) Pub. No.: US 2014/0234763 A1
(43) Pub. Date: Aug. 21, 2014

(54) IMAGE FORMING APPARATUS AND PROCESS CARTRIDGE

(71) Applicants: Akihiro SUGINO, Shizuoka (JP); Keisuke Shimoyama, Shizuoka (JP); Tomoharu Asano, Shizuoka (JP); Hidetoshi Kami, Shizuoka (JP); Nobutaka Eguchi, Kanagawa (JP); Kazuhiro Egawa, Shizuoka (JP); Tomoyuki Shimada, Shizuoka (JP); Ryota Arai, Shizuoka (JP); Masayoshi Nomura, Shizuoka (JP)

(72) Inventors: Akihiro SUGINO, Shizuoka (JP); Keisuke Shimoyama, Shizuoka (JP); Tomoharu Asano, Shizuoka (JP); Hidetoshi Kami, Shizuoka (JP); Nobutaka Eguchi, Kanagawa (JP); Kazuhiro Egawa, Shizuoka (JP); Tomoyuki Shimada, Shizuoka (JP); Ryota Arai, Shizuoka (JP); Masayoshi Nomura, Shizuoka (JP)

(21) Appl. No.: 14/174,279

(22) Filed: Feb. 6, 2014

(30) Foreign Application Priority Data
Feb. 20, 2013 (JP) 2013-031214
Aug. 2, 2013 (JP) 2013-161335

(51) Int. Cl. G03G 15/00; G03G 21/18; G03G 21/00

(52) U.S. Cl. CPC G03G 15/50
USPC 430/56; 399/111; 399/159; 399/346

(57) ABSTRACT

An image forming apparatus includes an image bearing member having a photosensitive layer and a sub-surface layer having a charge transportability, overlying the photosensitive layer
wherein the sub-surface layer is formed of a cured material formed of a radical polymerizable monomer having three or more functional groups with no charge transport structure and a radical polymerizable compound having a charge transport structure,
wherein the arithmetical mean roughness WRa of about each of frequency components of HMH, HML, and HLH obtained by wavelet conversion of values measured by a surface texture and the contour form measuring device ranges from 0.0002 μm to 0.005 μm and WRa (LLH) is 0.05 μm or less,
wherein the sub-surface layer contains at least one of a particular oxazole compound or a particular diamine compound.

### CROSS-REFERENCE TO RELATED APPLICATIONS

This patent application is based on and claims priority pursuant to 35 U.S.C. §119 to Japanese Patent Application Nos. 2013-031214 and 2013-161335, filed on Feb. 20, 2013 and Aug. 2, 2013, respectively, in the Japan Patent Office, the entire disclosures of which are hereby incorporated by reference herein.

### BACKGROUND

1. Technical Field

The present invention relates to an image forming apparatus and a process cartridge.

2. Background Art

Photoreceptors for use in photocopiers, laser printers, etc. typically contained inorganic compounds such as selenium, zinc oxide, or cadmium sulfide. However, organic photoconductors (OPC) are currently dominant because the organic photoconductors (photoreceptors) are more advantageous than such inorganic photoreceptors in terms of burden on the global environment, cost, and freedom of design. Currently, organic photoconductors account for close to 100% of all photoreceptor production. Increasing concern for protecting the global environment has of late led to increasing demand to switch organic photoreceptors from being consumables to being a constituent part of the machine. In addition, image forming apparatuses have been used in the field of commercial printing. For this reason, production of higher quality images is in demand than ever. In particular, stability of properties such as voltages over a long period of time of printing that affects the quality of images is in demand.

A number of attempts have been made to manufacture longer-lasting organic image bearing members having good durability. For example, JP-2000-66424-A describes film forming of a cross-linked resin layer on the surface of an image bearing member (photoreceptor). JP-2000-171990-A describes film forming of a sol-gel cured layer on the surface of an image bearing member.

The former has the advantage that cracking rarely occurs even when charge transport components are blended in the layer, thereby improving production yield. Among these, using polymerizable acrylic resins is advantageous to produce durable image bearing members with good sensitivity. In this approach, in which a cross-linked structure is formed, since the film is formed by multiple chemical bonds, abrasion does not immediately occur even when some of the chemical bonds are severed under stress.

In recent years, pressure to regulate emissions of carbon dioxide in an effort to protect the global environment has grown. In this context, image bearing members have been required to become part of the machines in which they are installed, and furthermore, to be recyclable.

Although image bearing members have until now been serving as mechanical parts, the working life including recycling of the image bearing members is not as long as the working life of the machines in which they are installed.

By forming a resin layer having a three-dimensional cross-linked structure on the surface of an image bearing member, production of highly durable image bearing members becomes more practical.

In addition, methods of applying a lubricant to the surface of an image bearing member are used in particular to improve the cleaning property of polymerized toner. In addition, by these methods, the image bearing member is protected from charging hazard, thereby prolonging the working life thereof.

However, although these technologies are used in combination, the image bearing members still need replacement before the image forming apparatus does.

This is because the surface property of the image bearing member is altered, which leads to production of defective images and deterioration of cleaning performance. Under these conditions, with regard to the whole life cycle of the image forming apparatus, from the discovery and exploitation of natural resources to disposal and recycling, nothing changes from the typical framework. As a result, image forming still requires a huge amount of energy and causes a massive amount of carbon dioxide emissions.

The mechanical strength of the image bearing members has almost reached its peak under the weight of cumulative technological advances. Therefore, usage technology is the key to stabilize the surface property of the image bearing member. Among such usage technology, application of a lubricant to the surface of an image bearing member is an extremely advantageous method. However, control of the usage amount of the lubricant is not satisfactory, resulting in the lubricant contaminating the area around the image bearing member in most cases. This is actually another factor leading to a prematurely shortened service life of the image forming apparatus.

In an attempt to solve these, JP-2012-208468-A describes a method of wavelet conversion of the surface roughness of an image bearing member into frequency components by multi-resolution analysis to separate into frequency components followed by regulating the arithmetical mean roughness of suitable bandwidths of the frequency components to a particular range. As a result, the circulating surface layer formed of a lubricant is formed on the surface of the image bearing member, succeeding in obtaining equivalence of the mass balance of the lubricant. Also, while protecting the surface of the image bearing member, the surface properties of the circulating surface layer is stabilized, which leads to longer service life of an image bearing member and stable image quality.

The circulating surface layer maintains the equivalence between the application amount and removal amount of lubricant while the application amount thereof is constant. However, for example, if the supply of the lubricant decreases due to consumption of the lubricant installed in a lubricant supplying member, the equivalence of the mass balance breaks. For this reason, the circulating surface layer is not formed uniformly, which changes abrasion of the surface of the image bearing member and the surface properties thereof. If the surface of the image bearing member is abraded, the surface roughness changes from the initial state. This makes it more difficult to maintain the uniformity of the circulating surface layer.

In addition, external additives such as silica and titanium oxide contained in toner are fixated on the surface of the image bearing member, which is so-called filming. To remove this filming, a lubricant containing filler is used in some cases. However, since the filler in the lubricant tends to remove the circulating surface layer, thereby degrading protection of the surface of the image bearing member. Therefore, abrasion of the image bearing member accelerates. If this occurs, the surface roughness changes from the initial state, uniformity of the circulating surface layer is lost easily in a relatively short period of time.

In an effort to solve this issue, abrasion resistance of the surface of the image bearing member is improved by increasing the hardness thereof. For example, in a case of forming a cured surface by exposure to an ultraviolet ray, UV ray power is increased or the exposure is prolonged to improve the hardness of the image bearing member. However, this invites side effects such as rise of the voltage at exposed portions, resulting in the image bearing member demonstrating low performance. On the other hand, singlet oxygen quencher (for example, nickel dithiolate complex) can be used as an additive to subdue decomposition reaction of dye or pigment.

However, the protective layer of an image bearing member containing such an additive loses photosensitivity completely.

As described above, usage of such a circulating surface layer in an image forming apparatus involves many issues.

### SUMMARY

The present invention provides an improved image forming apparatus including an image bearing member having a photosensitive layer and a sub-surface layer having a charge transportability overlying the photosensitive layer; a charger to charge a surface of the image bearing member; an irradiator to irradiate the surface of the image bearing member to form a latent electrostatic image thereon; a development device to develop the latent electrostatic image to obtain a visible image; a transfer device to transfer the visible image to a recording medium; a cleaning device to clean the surface of the image bearing member; and a circulating material applicator that contacts the image bearing member to apply a circulating material to the surface thereof to form a circulating surface layer as an uppermost surface layer of the image bearing member, the circulating material applicator being arranged upstream from the charger and downstream from the cleaning device relative to a rotation direction of the image bearing member, wherein the sub-surface layer contains a cured material formed of a radical polymerizable monomer having three or more functional groups with no charge transport structure and a radical polymerizable compound having a charge transport structure, wherein, when an arithmetical mean roughness WRa about each of frequency components is obtained by the following processes I to V of,

I. Making single dimensional data arrangement by measuring by a surface texture and the contour form measuring device;

II. Separating the single dimensional data arrangement into six frequency components of HHH, HHL, HMH, HML, HLH, and HLL) from high frequency components to low frequency components by wavelet conversion by multi-resolution analysis;

III. Thinning out a single dimensional data arrangement of a minimum frequency component of the six frequency components such that the number of data arrangement is reduced to 1/10 to 1/100;

IV. Conducting separation into additional six frequency components of LHH, LHL, LMH, LML, LLH, and LLL from high frequency components to low frequency components by wavelet conversion by multi-resolution analysis; and

V. Calculating the arithmetical mean roughness WRa of each of 12 frequency components obtained as above, of the frequency components obtained in II and IV, WRas of bandwidths of HMH, HML, and HLH range from 0.002 μm to 0.005 μm and WRa of LLH is 0.05 μm or less, wherein the sub-surface layer comprises at least one of an oxazole compound represented by a chemical formula 1 or a chemical formula 2 or a diamine compound represented by a chemical formula 3 or a chemical formula 4,

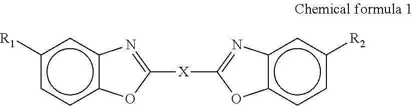

where, R₁ and R₂ each, independently represent hydrogen atoms or alkyl groups having one to four carbon atoms and X represents a vinylene group, a bifunctional group of an aromatic hydrocarbon having 6 to 14 carbon atoms, or 2,5-thiophenediyl group,

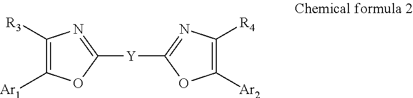

where, Ar₁ and Ar₂ each, independently represent monofunctional groups of aromatic hydrocarbons having 6 to 14 carbon atoms, Y represents a bifunctional group of an aromatic hydrocarbon having 6 to 14 carbon atoms, and R₃ and R₄ each, independently represent hydrogen atoms or methyl groups,

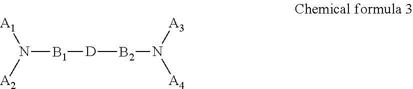

where, D represents an arylene group with or without a substitution group or a group represented by the following chemical structure,

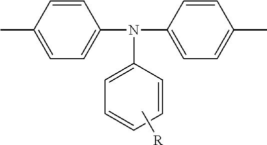

where, R represents a hydrogen atom, an alkyl group having one to four alkyl group, an alkoxy group having one to four carbon atoms,

A₁, A₂, A₃, and A₄ each, independently represent groups selected from the following i, ii, or iii,

i: an alkyl group having one to four carbon atoms,

ii: —CH₂(CH₂)mZ, where Z represents an aryl group, a cycloalkyl group, or a heterocycloalkyl group with or without a substitution group and m represents 0 or 1, and

iii: an aryl group with or without a substitution group, and

B₁ and B₂ each, independently represent —CH₂—, —CH₂CH₂—, —CH₂—Ar—, —Ar—CH₂—, —CH₂CH₂—Ar—, or —Ar—CH₂CH₂—, where Ar represents an arylene group with or without a substitution group,

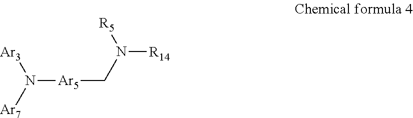

where, R₅ and R₁₄ each, independently, alkyl groups with or without a substitution group, aralkyl groups with or without a substitution group, or monofunctional groups of aromatic hydrocarbon with or without a substitution group, Ar₅ represents bifunctional groups of substituted or non-substituted aromatic hydrocarbon, Ar₇ and Ar³ each, independently represent, alkyl groups with or without a substitution group, aralkyl groups with or without a substitution group, or monofunctional groups of aromatic hydrocarbon with or without a substitution group, Ar₅ and Ar₇ or Ar₇ and Ar₃ are mutually bonded to share a substituted or non-substituted heterocyclic ring having a nitrogen atom,

wherein the frequency components are as follows:

WRa (HHH): Ra in a bandwidth in which a cycle length of convexoconcave ranges from 0.3 μm to 3 μm;

WRa (HHL): Ra in a bandwidth in which a cycle length of convexoconcave ranges from 1 μm to 6 μm;

WRa (HHL): Ra in a bandwidth in which a cycle length of convexoconcave ranges from 2 μm to 13 μm;

WRa (HML): Ra in a bandwidth in which a cycle length of convexoconcave ranges from 4 μm to 25 μm;

WRa (HLH): Ra in a bandwidth in which a cycle length of convexoconcave ranges from 10 μm to 50 μm;

WRa (HLL): Ra in a bandwidth in which a cycle length of convexoconcave ranges from 24 μm to 99 μm;

WRa (LHH): Ra in a bandwidth in which a cycle length of convexoconcave ranges from 26 μm to 106 μm;

WRa (LHL): Ra in a bandwidth in which a cycle length of convexoconcave ranges from 53 μm to 183 μm;

WRa (LMH): Ra in a bandwidth in which a cycle length of convexoconcave ranges from 106 μm to 318 μm;

WRa (LML): Ra in a bandwidth in which a cycle length of convexoconcave ranges from 214 μm to 551 μm;

WRa (LLH): Ra in a bandwidth in which a cycle length of convexoconcave ranges from 431 μm to 954 μm; and

WRa (LLL): Ra in a bandwidth in which a cycle length of convexoconcave ranges from 867 μm to 1,654 μm.

### BRIEF DESCRIPTION OF THE DRAWINGS

Various other objects, features and attendant advantages of the present invention will be more fully appreciated as the same become better understood from the detailed description when considered in connection with the accompanying drawings, in which like reference characters designate like corresponding parts throughout and wherein:

FIG. 1 is a schematic cross section illustrating an example of the image forming apparatus according to an embodiment of the present disclosure;

FIG. 2 is a schematic cross section illustrating another example of the image forming apparatus according to an embodiment of the present disclosure;

FIG. 3 is a schematic cross section illustrating another example of the image forming apparatus according to an embodiment of the present disclosure;

FIG. 4 is a schematic cross section illustrating another example of the image forming apparatus according to an embodiment of the present disclosure;

FIG. 5 is a schematic cross section illustrating another example of the image forming apparatus according to an embodiment of the present disclosure;

FIG. 6 is a schematic cross section illustrating another example of the image forming apparatus according to an embodiment of the present disclosure;

FIG. 7 is a schematic cross section illustrating an example of the image forming apparatus according for use in Comparative Examples;

FIG. 8 is a schematic cross section illustrating another example of the image forming apparatus according to an embodiment of the present disclosure;

FIG. 9 is a schematic cross section illustrating a device to supply a circulating material to an image bearing member;

FIG. 10 is a cross section illustrating an example of the layer structure of an image bearing member for use in the present invention;

FIG. 11 is a cross section illustrating another example of the layer structure of an image bearing member for use in the present invention;

FIG. 12 is a cross section illustrating another example of the layer structure of an image bearing member for use in the present invention;

FIG. 13 is charts illustrating an example of the results of multi-resolution analysis results of wavelet conversion;

FIG. 14 is a graph illustrating separation of frequency bandwidth in multi-resolution analysis for the first time;

FIG. 15 is a graph illustrating the minimum frequency data in multi-resolution analysis for the first time;

FIG. 16 is a graph illustrating separation of frequency bandwidth in multi-resolution analysis for the second time;

FIG. 17 is a graph illustrating an example of the coarse spectrum;

FIG. 18 is a diagram illustrating an example of the system to measure surface roughness and contour form;

FIG. 19 is a graph illustrating an infrared absorption spectrum (NaCl method) of diamine compound of Compound No. 4 synthesized in Examples;

FIG. 20 is a graph illustrating an infrared absorption spectrum (NaCl method) of diamine compound of Compound No. 5 synthesized in Examples; and

FIG. 21 is a graph illustrating an infrared absorption spectrum (NaCl method) of diamine compound of Compound No. 6 synthesized in Examples.

### DETAILED DESCRIPTION

The present invention provides an improved image forming apparatus having a long service life with low print cost by technology to highly stabilize the surface properties of an image bearing member at least to the level of the abrasion resistance thereof.

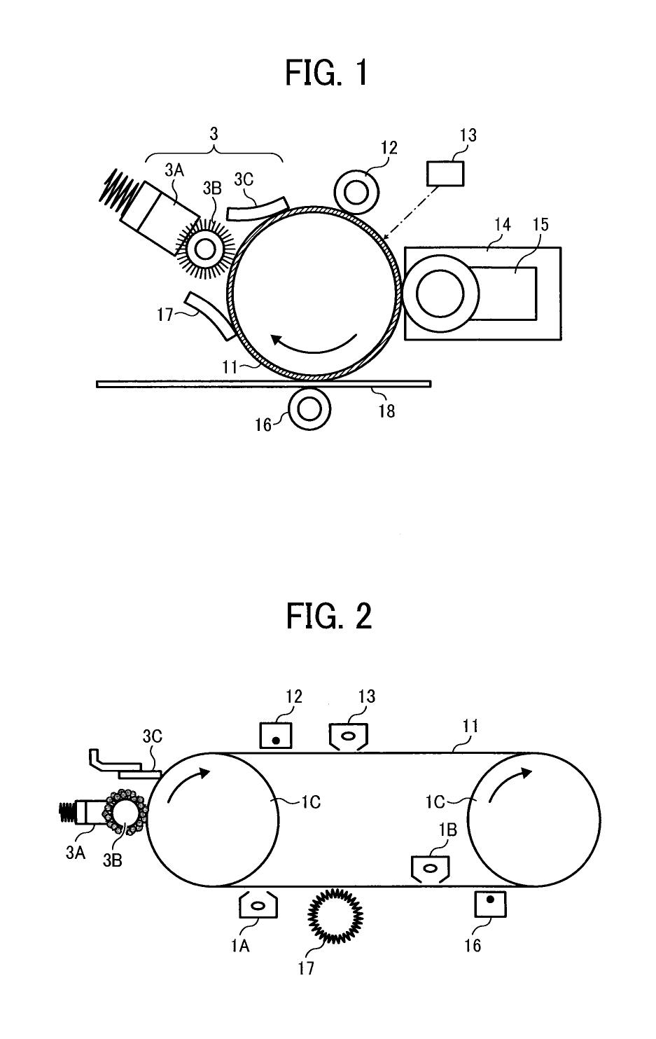

An image forming apparatus according to the present disclosure is described next with reference to FIG. 1.

The image forming apparatus illustrated in FIG. 1 includes the following elements.
an image bearing member (photoreceptor) 11 rotatably driven in a predetermined direction.
a charger 12 to charge the surface of the image bearing member 11
an irradiator 13 to form a latent electrostatic image by irradiating the image bearing member 11 with beams of light.
a development device 14 to develop the latent electrostatic image with a development agent containing toner 15 to form a toner image.
a transfer device 16 to transfer the toner image from the image bearing member 11 to a transfer medium.
a cleaner 17 to clean the surface of the image bearing member 11 after the toner image is transferred to the transfer medium (recording medium) 18.
a circulating material applicator 3 arranged in contact with the image bearing member 11 and downstream from the cleaner 17 and upstream from the charger 12 relative to the rotation direction of the image bearing member 11 to form a film of a circulating material 3A on the surface of the image bearing member 11.

The applicator 3 includes an application brush 3B and an application blade 3C.

The film on the image bearing member 11 forms a circulating surface layer formed of the circulating material 3A.

The application amount of the circulating material 3A by the circulating material applicator 3 in a single image forming cycle by the image forming apparatus is equal to the amount of the circulating material 3A removed from the surface of the image bearing member 11 by the time just before the circulating material applicator 3 applies the circulating material 3A in the next image forming cycle.

The image forming apparatus of the present disclosure is described in detail.

The image forming apparatus according to the present disclosure is described with reference to the accompanying drawings. It is to be noted that the embodiments described below are preferred embodiments, and the present invention is not limited thereto unless otherwise described.

In the present disclosure, since an applicator to coat the surface of the image bearing member with a film of a circulating surface layer formed of a circulating material is built in the image forming apparatus, the image bearing member is less abraded. As a consequence, the change of the surface texture is significantly subdued.

The image forming by the image forming apparatus of the present disclosure includes a process of applying a material (hereinafter referred to as circulating material) to form a circulating surface layer on a sub-surface layer of the image bearing member. In the present disclosure, preferably, the application amount of the circulating material is close to the amount of the circulating material removed by cleaning by the cleaner by the time the next coating process is initiated. This is a requisite to continue forming a circulating surface layer on the surface of the image bearing member. The mass balance of the circulating material in (=supplied to) and out of (=removed from) the image bearing member, etc. acquires equivalence by coating of the circulating material in a significantly same amount as removed.

The circulating material is considered to be removed mainly by a cleaner. In addition, the contacts between the image bearing member and the development agent and between the image bearing member and the intermediate transfer belt also effect removal of the circulating material. In the present disclosure, the removing process of the circulating material is conducted between successive applications of the circulating material, that is, from immediately after the circulating material is applied one time to immediately before the circulating material is applied the next time.

When more circulating material is applied after some circulating material is removed, the circulating material is immediately applied in the application process thereof even if the circulating material is completely removed from the surface of the image bearing member. Since the circulating material accumulates on the surface of the image bearing member until it is removed, the circulating material on the surface of the image bearing member is not completely depleted with repeated removal and reapplication of the circulating material. To be specific, for example, if 10% of the circulating material is applied after 100% is removed, the state in which 10% of the circulating material is applied is kept until the next removal. Thereafter, after the circulating material is completely removed in the removal process, 10% of the circulating material is applied again. That is, in the present disclosure, the circulating material on the surface of the image bearing member is not completely depleted because of this repetitive process.

In the present disclosure the circulating surface layer is laminated on the surface of the image bearing member to secure and sustain the lubrication property of the image bearing member. By contrast, the typical system has no such design concept.

In the typical system, the lubricant is just supplied to the image bearing member from outside to the surface of the image bearing member just to protect the surface of the image bearing member or lower the friction factor of the surface of the image bearing member to a predetermined level. In the case in which the lubricant is supplied from outside to the surface of the image bearing member, it is observed that lubricant particles are attached to the surface of the image bearing member. Such lubricant particles cause contamination inside the device.

In the present disclosure, the amount of the circulating material removed by cleaning can be calculated from the concentration of the circulating material contained in the collected toner. The concentration of the circulating material is monitored by Inductivity Coupled Plasma (ICP) analysis or X-ray Fluorescence (XRF) analysis as described in detail later. Thus, it is possible to achieve a balance between the amount of circulating material removed and the application amount thereof in the present disclosure by preliminarily calculating the disappearance speed (total amount of the consumption) of the circulating material.

Next, the method of determining an application amount of the circulating material to be equal to the amount removed by cleaning per cycle of image forming is described. The consumption amount of the circulating material consumed during image formation is determined by multiplying the coating efficiency of the circulating material to the image bearing member by the compensation for the loss occurring in the image forming process.

The loss ascribable to the image forming process is measured by collecting powder accumulating around the circulating material applicator, which is taken as the amount of the circulating material that is not applied to the surface of the image bearing member because the circulating material molded to powder by a brush falls and scatters.

In addition, the component of the circulating material removed from the surface of the image bearing member is calculated from the collected amount of the circulating material remaining after the cleaner does its job, taken generally in the path to a waste toner bottle. When toner is contained in the collected powder, the total amount thereof is obtained to analyze the concentration of the circulating material, thereby obtaining the mass of the circulating material removed from the surface of the image bearing member.

When there is a difference between the loss of the circulating material in the above-described process as against the total consumption amount, on the one hand, and the removal amount from the surface of the image bearing member on the other, the difference is regarded as the amount of the contamination of other modules and units such as the charger, etc.

The coating efficiency of the circulating material on the surface of the image bearing member is determined by how closely disposed are the image bearing member and an application blade or the like that applies the circulating material to the image bearing member. When the circulating material is thinly and uniformly applied to the surface of the image bearing member while covering the entire thereof by the application blade, the efficiency is not good if the application blade is so strongly pressed against the surface of the image bearing member that it completely dams the circulating material. In short, forming a suitable gap and preventing vibration of the application blade are requisites for good coating efficiency.

For example, if the surface of the image bearing member is roughened, a suitable gap can be formed and the vibration of the application blade can be prevented, thereby improving the efficiency of the performance of the application blade to easily form a circulating surface layer. In the case of the image forming apparatus in which the circulating surface layer is formed, it is possible to identify the point where the circulating surface layer is made possible by evaluating defects ascribable to an excessive amount of the circulating material and the level of the filming on the surface of the image bearing member ascribable to shortage of the circulating material by simply increasing or decreasing the consumption amount of the circulating material.

In the image forming apparatus of the present disclosure, the circulating material is coated on the sub-surface layer of the image bearing member. To secure forming a good circulating surface layer, the coating surface of the sub-surface layer is preferably clean and prevented from alteration even when the image forming apparatus is used for an extended period of time. To maintain the coating surface of the sub-surface layer clean, it is necessary to eliminate toner contaminating the coating surface as much as possible. For this reason, it is suitable to arrange an applicator of the circulating surface layer downstream from the cleaner relative to the moving direction of the surface of the image bearing member. Furthermore, to prevent alteration of the sub-surface layer, it is particularly suitable to prevent deformation of the sub-surface layer which has an adverse impact on the fit-in between the image bearing member and members that contact the image bearing member.

To prevent the sub-surface layer from being directly exposed to charging hazard, it is suitable to arrange the applicator upstream from the charger relative to the moving direction of the surface of the image bearing member to suitably apply the circulating surface layer

The relation between the amount of the circulating material removed and the amount attached is disregarded only when the circulating material is provided to the surface of a fresh image bearing member. This is because the circulating material is not utterly applied if the application amount of the circulating material is equal to or less than the removed amount when the circulating material is not present at all on the surface of the image bearing member.

Provision of the circulating material is conducted during a non-constant state, i.e., until when the image bearing member is installed on the image forming apparatus. To be specific, this means until when initial 1,000 or less images are printed with a fresh image bearing member after it is installed on an image forming apparatus.

The circulating material is provided to the surface of the image bearing member by accumulating the circulating material on the surface of the image bearing member while the cleaning performance of the image forming apparatus is insufficient because the circulating material has not been sufficiently applied to the surface of the image bearing member yet or preliminarily applying the circulating material to the surface using setting powder, etc.

The circulating surface layer of the surface of the image bearing member is defined as described above. However, it is not easy to continue forming a circulating surface layer inside the image forming apparatus or during the image forming process. This is because, in the image forming process, the physical property of the sub-surface layer of the image bearing member incessantly reflects and accumulates the history.

In the middle of the image forming process, toner is used to form images in addition to coating the sub-surface layer of the image bearing member with the circulating material. When the circulating surface layer is coated at the same time images are formed, if coating of the circulating material is not sufficient, paper dust of toner components causes filming (having a rice-fish-like form, etc.) on the sub-surface layer of the image bearing member. Due to such filming, applying the circulating material becomes difficult every time the image forming cycle is conducted. In addition, if the circulating material does not sufficiently cover the surface of the image bearing member so that forming the film of the circulating material does not catch up with the supply of the circulating material, the layer of the circulating material may become rough. In addition, if the circulating material accumulates on or slips through a member that contacts the image bearing member, the circulating material is attached to the surface of the image bearing member as if gravel were sprinkled.

Consequently, the circulating material contaminates members (e.g., a charger, an irradiator, a development device, and a transfer device) arranged around the image bearing member, resulting in shortening their working lives. Alternatively, the circulating material mingles into the development device, thereby degrading charging of toner. These become problems when the image forming apparatus are used for an extended period of time. Also, the coverage is insufficient so that the sub-surface layer of the image bearing member is easily abraded, which leads to changes of the surface form and furthermore degradation of the coverage feature of the circulating material. Although such a rough surface is not totally unacceptable at all, a rough standard to avoid such problems is that the area ratio of such a rough surface portion in an about 2 mm×2 mm area is less than 0.05% and preferably less than 0.03% when the surface of the image bearing member is observed. The area ratio of such a rough surface is calculated by using an image analysis software such as image J (manufactured by National Institutes of Health) and Image-Pro® Plus (manufactured by MediaCyabernetics, Inc.).

Currently, when a known lubricant is applied inside an image forming apparatus, the coverage ratio of the lubricant is about 85% in most cases. Such a rough surface accounts for from about 0.1% to about 2.5% although depending on print patterns. As a result, when such an image bearing member is used for an extended period of time, it tends to produce defective images or require replacement. That is, the circulating surface layer is not formed in fact.

To the contrary, in the present disclosure, by designing an image bearing member having a sub-surface layer having a particular surface form, the applicability of the circulating material is drastically improved. For this reason, even if images are formed at the same time with coating of a circulating surface layer, the problem of filming on the sub-surface layer and contamination on members are overcome, thereby prolonging the working life of the image bearing member.

In addition, a typical lubricant applicator can be used as the applicator of circulating surface layer for use in the image forming apparatus of the present disclosure. Therefore, the image forming apparatus of the present disclosure is advantageous in terms of economy. Improving the application capability requires control of the abrasion status between the image bearing member and the application blade. To be simple, a process to make these fitted in better is required.

According to the investigation made by the present inventors, it was found that the wearing-down of the application blade varied depending on the form of the sub-surface layer of the image bearing member when an image forming apparatus having the same configuration as the present disclosure was used to monitor the portion of the application blade abraded by the image bearing member. In this monitoring, the blade was observed from above the surface of the blade in a viewing field of 180 μm×180 μm by a confocal microscope with a magnification power of 100. In addition, the application blade was used in the trailing position against the image bearing member. The wearing-down of the application blade was measured for an area having a length of 180 μm and a width of 90 μm in the vertical direction from the edge of the cut surface of the application blade and calculated from the surface roughness Ra of the area and the average pitch Sm between the local peaks of the convexoconcave portions. In an attempt to classify the degree of the wearing-down from mapping the sizes of Ra and Sm, it was also found that the degree of the wearing-down (roughness) was small when the roughness about the low frequency component was small and the roughness about the middle-range frequency component was moderately high about the cross section curve of the sub-surface layer of the image bearing member. Furthermore, it was furthermore found that the roughness of the circulating surface layer tended to be increased as the roughness of the application blade increased after a long period of use.

The roughness of the application blade was observed by a confocal microscope (OPTELICS H-1200, manufactured by Lasertec Corporation) and its attached software (LMeye) to obtain the surface roughness Ra. It was found that a sample difference of from 0.3 μm to 0.6 μm was obtained. In addition, with regard to the average pitch Sm between the local peaks, the sample difference obtained was from 2.5 μm to 5.5 μm. The wearing-down of the application blade after the long period of use was considered to be a result reflecting the degree of the fit-in between the application blade and the surface of the image bearing member.

In the present disclosure, the image bearing member includes an electroconductive substrate on which a photosensitive layer, the sub-surface layer, and the circulating surface layer are laminated in this order. When the form of the sub-surface layer of the image bearing member to reduce the wearing-down of the application blade is obtained by the following procedures of I to V with regard to the arithmetical mean roughness WRa of each frequency component, WRa in the band widths of HMH, HML, and HLH among the frequency components obtained in the following procedures to II to IV ranges from 0.002 μm to 0.005 μm and WRa (LLH) is 0.05 μm or less.
I: Single dimensional data arrangement is made by measuring by a surface texture and the contour form measuring device;
II. The single dimension data arrangement is subject to wavelet conversion by multi-resolution analysis to separate the results into six frequency components (HHH, HHL, HMH, HML, HLL, and HLL) from the high frequency component to the low frequency component;
III. Thereafter, among the thus-obtained six frequency components, the single dimension data arrangement for the minimum frequency component is thinned out to reduce the number of the single dimension data arrangement to 1/10 to 1/100 to obtain a single dimension data arrangement;
IV. Furthermore, the single dimension data arrangement is subject to wavelet conversion by multi-resolution analysis to conduct separation into additional six more frequency components (LLH, LHL, LMH, LML, LLH, and LLL) from high frequency components to low frequency components; and
V. The arithmetical mean roughness WRa is calculated for each of the thus-obtained 12 frequency components.

Based on the arithmetical mean roughness Ra, which is defined in JIS-B0601:2001, of the sub-surface layer of the image bearing member, the arithmetical mean roughnesses in the individual bandwidths separated into the frequency components with regard to the length of one cycle of the convexoconcave portions by the wavelet conversion are represented as follows:
WRa (HHH): Ra in a bandwidth in which a cycle length of convexoconcave ranges from 0.3 μm to 3 μm;
WRa (HHL): Ra in a bandwidth in which a cycle length of convexoconcave ranges from 1 μm to 6 μm;
WRa (HHL): Ra in a bandwidth in which a cycle length of convexoconcave ranges from 2 μm to 13 μm;
WRa (HML): Ra in a bandwidth in which a cycle length of convexoconcave ranges from 4 μm to 25 μm;
WRa (HLH): Ra in a bandwidth in which a cycle length of convexoconcave ranges from 10 μm to 50 μm;
WRa (HLL): Ra in a bandwidth in which a cycle length of convexoconcave ranges from 24 μm to 99 μm;
WRa (LHH): Ra in a bandwidth in which a cycle length of convexoconcave ranges from 26 μm to 106 μm;
WRa (LHL): Ra in a bandwidth in which a cycle length of convexoconcave ranges from 53 μm to 183 μm;
WRa (LMH): Ra in a bandwidth in which a cycle length of convexoconcave ranges from 106 μm to 318 μm;
WRa (LML): Ra in a bandwidth in which a cycle length of convexoconcave ranges from 214 μm to 551 μm;
WRa (LLH): Ra in a bandwidth in which a cycle length of convexoconcave ranges from 431 μm to 954 μm; and
WRa (LLL): Ra in a bandwidth in which a cycle length of convexoconcave ranges from 867 μm to 1,654 μm.

When the form of the sub-surface layer of the image bearing member satisfies the relation described above, the form has a property in which the circulating material is efficiently applied. This mechanism is not clear yet but can be deduced as follows:

When the circulating material is applied to the sub-surface layer of the image bearing member by the application blade to form a circulating surface layer, application is not possible if the application blade dams the circulating material completely. To form a film having a moderate thickness of the circulating material, it is necessary to form a dynamic gap between the application blade and the sub-surface layer to make the circulating material slip through the application blade. For example, when the circulating material is applied by bringing the application blade made of rubber plate into contact with the image bearing member, the application blade dams the circulating material as described above if the application blade is brought into contact with the image bearing member like a typical cleaning blade, resulting in failure of application.

To apply the circulating material to the surface of the image bearing member, just controlling the contact state between the surface of the image bearing member and the application blade is insufficient to form the dynamic gap. Controlling the sliding state between the image bearing member and the application blade is also required in addition to controlling the contact state. The contact state means how the application blade is in contact with the surface of the image bearing member and the sliding state is how the application blade rubs the surface of the image bearing member.

The conditions under which a uniform film is made by a typical doctor blade are the following 1 to 5.
1. The gap between a blade to form a wet film having a uniform thickness and the coated surface is constant;
2. The blade is free from vibration;
3. The application speed is constant;
4. The coated surface is clean; and
5. The paint (liquid application) is uniform.

The same applies to the film-forming of the circulating material. Making the surface of the image bearing member coarse as described above is considered advantageous for coating. The application blade being made of rubber also is considered to have some good impact.

By forming a sub-surface layer of the image bearing member as described above, the application property of the circulating material is drastically improved. In addition, it is also possible to form a circulating surface layer having the circulating material in an amount significantly equal to the amount thereof removed.

Furthermore, since the circulating material is efficiently applied, the consumption amount of the circulating material is reduced.

To make it possible to have a circulating surface layer as the uppermost layer of the image bearing member installed in the image forming apparatus, it is preferable to use a circulating material which is easily removed from and applied to the sub-surface layer of the image bearing member. To sustain a circulating surface layer, it is particularly preferable to make the material amount applied to the image bearing member in one cycle equal to the material amount removed therefrom by cleaning. In addition, it is preferable that the consumption rate of the circulating material is not excessively high.

Considering the above-mentioned conditions, wax or metal salts of higher aliphatic acid is preferable as the circulating material. Specific examples of the wax include, but are not limited to, plant waxes such as sumac wax, Urushi wax, palm wax, and carnauba wax, animal waxes such as bees wax, spermaceti, Ibota wax, and wool wax, and mineral waxes such as montan wax and paraffin wax. These can be liquid or solid. Considering they are installed in an image forming apparatus, a solid bar form is preferable.

Most of known generally-used metal salts of higher aliphatic acid are preferable in terms of the properties of the material. A specific example of the typical compound thereof is zinc stearate, which can take a lamellar structure.

In the lamellar structure, layers in which molecules are regularly folded are laminated and arranged.

In the laminate structure of the lamellar structure, amphiphilic molecules are self-organized so that the crystal is broken and peeled off along the interface of the layers upon application of a shearing force. This is advantageous to form a circulating surface layer. According to the characteristics of the lamellar structure of zinc stearate that uniformly covers the surface of the image bearing member upon application of a shearing force, the surface of the image bearing member is effectively covered by a small amount of the circulating material.

When the circulating material is applied by this method, there are methods of controlling the application state of the circulating material. For example, increasing the contact pressure between a solid circulating material and the application brush or controlling the rotation speed of the application brush is possible. Moreover, the number of rotations of the application brush can be controlled according to the image forming data.

Wax and metal salts of higher aliphatic acid can be used alone or as a binder mixture with other functional materials such as charge transport materials and anti-oxidants.

Since a material which is easily applied to form a film and removed in an image forming apparatus is identified by using such a circulating material, the equivalence of the material amount is easily obtained during the repeated application and removal process of the circulating material. Therefore, the circulating material is applied and removed by a simple module (unit). In addition, the circulating surface layer can be formed for an extended period of time. Furthermore, the combinational use of the circulating material and the form of the sub-surface layer described above extremely improves the covering capability per image forming cycle, thereby reducing the consumption rate of the circulating material.

Metal salts of aliphatic acids that are capable of taking a lamellar structure can be used as the circulating material in the present disclosure. Specific examples of the aliphatic acid metal salts include, but are not limited to, zinc salts, aluminum salts, calcium salts, magnesium salts, and lithium salts of stearic acid, plamitic acid, myristic acid, and oleic acid. These can be used in combination.

In particular, zinc stearate is most preferable in terms of cost, quality, stability, and reliability because zinc stearate is produced at an industry level and used in many fields.

In addition, accumulated rich technologies for efficient application of lubricants are easily applied to zinc stearate.

Higher aliphatic acid metal salts generally used in the industry is not necessarily limited to only the single composition represented by the name of the compound. Other similar aliphatic acid metal salts, metal oxides, and isolated aliphatic acid are also included and the metal salts of higher aliphatic acids of the present disclosure follow this practice.

Using such a circulating material, the circulating surface layer is reliably formed with low cost. In addition, devices to which the accumulated application technology about application of lubricants is easily applied can be conveniently developed. In addition, technologies have been used recently which provides features of using a lubricant containing a filler to supply the filler to the surface of the image bearing member together with the lubricant to scrape filming including rice-fish-like form filming of the toner component on the surface of the image bearing member. This is a countermeasure to toner formed of a resin having a low melting point to lower the fixing point thereof, which easily leads to filming. In particular, metal oxide particulate fillers drastically improve the filming-removing power. In particular, aluminum oxide particulates are preferable because they can be easily dispersed in a circulating material in addition to improving the filming removing power.

The application property of the circulating material is drastically improved by the form of the sub-surface layer of the image bearing member described above. To sustain the improved property, it is advantageous to improve the strength of the form of the sub-surface layer. When an image bearing member is abraded during image forming process, the form of the surface thereof changes accordingly. Such a change is seen by the change of the surface roughness. The present inventors confirmed that the surface roughness tended to be increased as the abrasion of the image bearing member is increased.

The image bearing member for use in the present disclosure includes an electroconductive substrate on which at least a photosensitive layer and a sub-surface layer having a charge transportability are laminated in this order. The sub-surface layer contains at least a cured material of a radical polymerizable monomer having three or more functional groups with no charge transport structure and a radical polymerizable compound having a charge transport structure. The sub-surface layer contains an oxazole compound represented by Chemical formula 1 or Chemical formula 2 or a diamine compound represented by Chemical formula 3 or Chemical formula 4. The image bearing member has a surface layer of a three-dimension cross-linked layer on a conventional photosensitive layer, which is mainly formed by radical chain polymerization of a mixture of the radical polymerizable compound having a charge transport structure and the radical polymerizable monomer having three or more functional groups with no charge transport structure upon irradiation of active energy line. The present disclosure contains at least one of a particular oxazole compound or a particular diamine compound in the surface layer when forming the three-dimension cross-linked layer as the surface layer.

The oxazole compound in the surface layer prevents occurrence of charge trap and uneven occurrence thereof in the surface layer. For this reason, it is possible to prevent variance of the charge over time due to charge trap, thereby making it possible to print quality images with little or no change of the image density for continuous image forming, which is demanded for commercial printing.

In addition, additives such as anti-oxidants added to the surface layer may degrade the charge transport feature. However, since the diamine compound is added, the charge transport property is sustained and degradation by oxidized gas of resins, etc. can be prevented. As a result, quality images with little or no change of the image density for continuous image forming, which is demanded for commercial printing, can be printed.

The surface layer contains at least one of an oxazole compound represented by Chemical formula 1 or Chemical formula 2 or a diamine compound represented by Chemical formula 3 or Chemical formula 4. It does not necessarily contain both compounds. Containing only one of the oxazole compound and the diamine compound ensures the corresponding features described above. In addition, it is also possible to contain both compounds, which is preferable because both features are demonstrated.

An image bearing member that forms quality images meeting the demand in commercial printing is required to have stable irradiation voltage without change between image forming operations for continuous printing for an extended period of time. For this reason, in addition to particular conditions about the thickness or uniformity of a cross-linked protective layer, preventing the occurrence of charge trap inside the surface layer is demanded.

The sub-surface layer has a suitable surface form in order to form a circulating surface layer of circulating material as described above. However, if the sub-surface layer is abraded due to repetitive use, the surface texture changes, which causes trouble to form a circulating surface layer. Therefore, the mechanical strength of the sub-surface layer is improved by a three-dimensional network structure. If the sub-surface layer is used as a surface protective layer, the layer does not lose the feature of protecting underlying layers unless it is lost. However, like the present disclosure, the feature of forming a circulating surface layer is lost if the surface texture changes. Therefore, the mechanical strength of the sub-surface layer is further improved.

For example, in an attempt to prevent degradation of the mechanical strength, the irradiation amount of active energy lines such as ultraviolet rays is increased to completely cross-link the entire of the sub-surface layer of an image bearing member. However, this also invites degradation of the electric properties of the image bearing member. This mechanism is inferred that an increase of the irradiation amount of active energy lines produces photodecomposed materials of a radical polymerizable charge transport compound having charge transportability and the photodecomposed materials become charge traps, raising the voltage of irradiated portions over repetitive use. Considering this, if this photodecomposition is subdued, the occurrence of charge trap is prevented so that the rise of the voltage of irradiated portions over repetitive use is reduced.

Accordingly, as a result of the investigation made by the present inventors about prevention of this photodecomposition and findings of an additive that does not inhibit curing polymerization reaction upon exposure to active energy lines such as ultraviolet rays, it was found that a particular oxazole compound was suitable. The working mechanism of this particular oxazole compound is not clear but can be inferred that a radical polymerizable charge transport compound excited by active energy lines and the particular oxazole compound forms an intermolecular exciplex and thereafter deactivated, which prevents decomposition reaction from the excited state of the radical polymerizable charge transport compound.

Furthermore, since the particular oxazole compound satisfies the following conditions, the photodecomposition of the charge transport compound upon exposure to active energy lines such as ultraviolet rays is subdued, thereby preventing charge trap from occurring in the surface layer without impairing fundamental electric properties and mechanical properties of an image bearing member.
An oxazole compound having a larger oxidation potential than a radical polymerizable charge transport compound is selected to prevent charge trap from occurring in a surface layer without reducing charge transport power;
Most oxazole compounds absorb short wavelengths, thereby not inhibiting cross-linking reaction initiated by exposure to ultraviolet ray because absorption occurs little in the wavelength range required to initiate polymerization;
In comparison with radical polymerizable charge transport compounds, oxazole compounds have low excited potential levels, thereby easily forming exciplex

As described above, since charge traps are decreased in the surface layer, the voltage stability is improved over repetitive use. By using such an image bearing member, the voltage and the surface form are stabilized for an extended period of time. Therefore, quality images meeting the requirement about image density in the commercial printing are output even over continuous printing for an extended period of time.

In addition, in an attempt to improve the mechanical strength and electric properties of a sub-surface layer of an image bearing member, an anti-oxidant is added to subdue degradation of resins and charge transport compounds due to oxidized gases in the surface. The mechanical strength is improved but the electric properties of the image bearing member are worsened. This mechanism is inferred that the added anti-oxidant becomes charge traps, thereby increasing the voltage after irradiation. Taking this into consideration, the present inventors thought that if the charge trap by the anti-oxidant was inhibited, the rise of the voltage at irradiated portions could be subdued.

Therefore, an additive to inhibit charge trap by the anti-oxidant was then sought and a particular diamine compound was found suitable. This mechanism is that since the diamine compound itself has a charge transportability, charges are not trapped, thereby transporting charges efficiently.

The reason such a diamine compound succeeds in improving the strength of a resin is inferred that since the amino group in the molecular of a diamine compound is strongly basic, durability of the resin to oxidized gas is improved, thereby subduing alteration of the resin and maintaining the strength. Moreover, since, unlike an anti-oxidant, the diamine compound does not have a polar group that easily traps charges and is charge transportable, the impact of raising the voltage at irradiated portions and residual voltage is lessened in spite of addition of the diamine compound to some degree.

Next, the surface form of the present disclosure is described. First, film forming by a wet process is suitable to make the surface form of the present disclosure described above. Since the texture of a surface is controlled in the magnitude of from micron to mm in the wet process, it is advantageous over mechanical processing in terms of technology and cost. With regard to the viscosity of a liquid application in the film forming by the wet process, the range of the form control is wide when the viscosity of the liquid application is low. To be specific, the range of from about 0.9 mPa·s to about 10 mPa·s is suitable. The allowable lowest limit of the viscosity of the liquid application is determined by the value asymptotic to the solvent viscosity and the allowable highest limit is determined in terms that the form control becomes difficult. To secure a sub-surface layer having a practically sufficient strength after the film is formed with a liquid application having a low viscosity, it is good to select a reactive-type resin monomer employing a three-dimensional cross-linked structure as the main component of the liquid application.

By using a resin having a three dimensional cross-linked structure for the sub-surface layer of the image bearing member, the sub-surface layer has an excellent abrasion resistance. The mechanism of this is deduced that if part of the chemical bonding forming the resin firm is severed but the chemical bonding at other portions still remains, the image bearing member is not directly abraded. Excellent abrasion resistance directly contributes to the stability of the surface form. As a result, when a resin having a three dimensional cross-linked structure is used for the sub-surface layer, the application property of the circulating material is stabilized.

Among resins having three dimensional cross-linked structures, acrylic resins are preferable in terms that the impact on the electrostatic property due to the rough form is small because acrylic resins have relatively large dielectric constants in comparison with solid solutions of polycarbonates and charge transport materials.

As described above, by using a resin having a three dimensional cross-linked structure in the sub-surface layer, forming the sub-surface layer on the circulating surface layer is made easy, thereby easily improving the application property of the circulating material. In addition, the change in the special form of the sub-surface layer is reduced and the application property of the circulating material is stabilized.

When forming the sub-surface layer, the surface is roughened by adding fillers to a liquid application having a relatively low viscosity. By controlling the agglomeration state of the filler, a variety of rough surfaces can be formed. Technologies of using a resin having a three dimensional cross-linked structure at the uppermost surface layer of an image bearing member together with fillers blended therein are already known. However, these mainly focus on improving the mechanical strength of the image bearing member in most cases. However, surprisingly enough, filler dispersant is never or little used in combination therewith. Furthermore, controlling the surface form of an image bearing member by changing the agglomeration state of fillers by a dispersant is a new concept. Among fillers, it is preferable to use metal oxide fillers having a primary average particle diameter in the magnitude of nano meter. Specific examples thereof include, but are not limited to, α-alumina, tin oxide, titania, silica, and ceria.

Some organic particulate fillers and inorganic particulate fillers are not easily dispersed. Also, they have a surface roughness in the order of micron or higher or many prickles on the surface, thereby damaging the blade of the application blade and the cleaning blade. On the other hand, metal oxide fillers are free of such concerns in most cases.

Similarly, the content of metal oxide is preferably from 1% by weight to 20% by weight of the sub-surface layer. The allowable lowest and highest limits of the content of metal oxide is determined by the difficulty of controlling the form of the sub-surface layer.

In addition, on account of a combinational use of metal oxide, the mechanical strength is also improved in the present disclosure.

The dispersant of an ester of phosphoric acid improves the stability of the dispersed filler in the liquid application, reduces the size of the filler, and imparts the affinity with the binder resin. The size reduction of the filler and the affinity to the binder resin are arbitrarily controlled as factors to control the form of the surface form. For this control, a dispersant having a suitable acid value and amino value is selected according to the acidity and the basicity of the filler. Alternatively, a dispersant having components having high compatibility with a binder resin and a filler is selected. In addition, selecting a filler having a stable dispersion property in a liquid application is preferable when manufacturing an image bearing member. This is achieved by selecting a dispersant having a functional group adsorbed with a filler or a component having high compatibility with a solvent. The allowable upper limit of the content of the dispersant is normally set to be from 1% by weight to 2% by weight based on the total of the solid portion of the sub-surface layer considering the impact on the electrostatic property of the image bearing member.

As described above, by containing a dispersant of an ester of phosphoric acid and a metal oxide filler, the sub-surface layer of the circulating surface layer is easily formed. The application property of the circulating material is easily improved. In addition, the abrasion resistance of the sub-surface layer is also easily improved.

If the circulating material is not sufficiently applied, it is anticipated that paper dust and toner components are attached to the sub-surface layer of the image bearing member, which may cause filming such as a rice-fish like form filming. If such filming occurs, the wettability of the sub-surface layer is altered, which may break up the circulation process of the circulating material. Addition of α-alumina particulates having significantly spherical forms to the sub-surface layer of an image bearing member is good to greatly reduce this filming, which was experimentally confirmed.

The mechanism of this is not clear yet but is deduced as follows: α-alumina has a high hardness, which contributes to protection from damage to the sub-surface layer, resulting in reduction of the chance of filming; or even if the circulating material is short, the convexoconcave of α-alumina has some effect of stably keeping the sliding status between the image bearing member and the application blade or the cleaning blade.

In many cases of α-alumina filler particulates having significantly spherical forms, the particle diameter thereof is from 0.01 μm to 2 μm and preferably from 0.03 μm to 1.5 μm. In this range, since extreme convexoconcave forms such as prickles are not easily formed when forming a layer, the form conforming to the sub-surface layer is easily made.

As described above, by containing α-alumina particulates having particle diameters of from 0.01 μm to 2 μm, alteration of the surface of the image bearing member is prevented. For this reason, the surface of such an image bearing member is stabilized. The average primary particle diameter of α-alumina is particularly preferably from 0.2 μm to 0.5 μm.

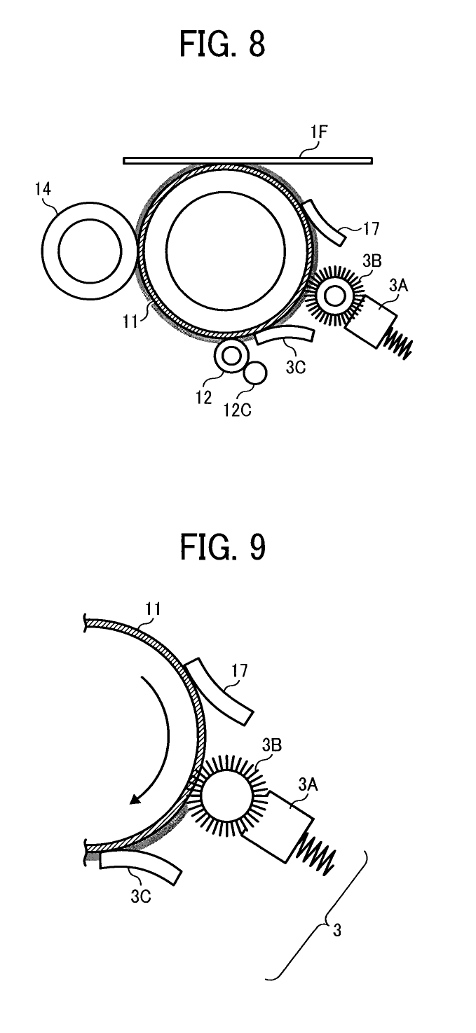

An example of the image forming apparatus using the circulating material is described with reference to FIG. 8. In the device illustrated in FIG. 8, a circulating material 3A is supplied to an surface of an image bearing member 11 by an application brush 3B, regulated by an application blade 3C, removed by a cleaning blade 17, and returned to the application brush 3B. Toner is also input to and output from the surface of the image bearing member 11. Therefore, the circulating material 3A is mixed with the toner thereon.

A charger 12 has a charger cleaner 12C provided in contact with the charger 12 to clean the charger 12.

In the present disclosure, as illustrated in FIG. 7, a system without using an intermediate transfer element is also suitable, in which images are directly transferred from the surface of the image bearing member 11 to a transfer medium 18 by a transfer device 16.

In addition, in the present disclosure, properties such as the attachability of the circulating material when it is supplied (input) to the surface of the image bearing member, smooth spreading of the circulating material, and timely removal property of the circulating material discharged outside the image bearing member system are improved to improve the circulation efficiency of the circulating material.

For smooth spreading, an application blade is used to spread the circulating material in most cases. With regard to discharging of the circulating material, a cleaning blade is in charge in most cases. Each blade is required to stabilize the sliding state between the image bearing member and each blade.

Alteration and the sliding state of the application blade can be subdued by the form of the sub-surface layer of an image bearing member if WRas in the bandwidths of HMH, HML, and HLH among the frequency components described above range from 0.002 μm to 0.005 μm and WRa (LLH) is 0.05 μm or less.

The sub-surface layer can have an excellent abrasion resistance by using a cross-linked resin having an excellent abrasion resistance as a material for the sub-surface layer. The sustainability of the form of the surface is obtained accordingly. This is because if part of the chemical bond forming a resin film is severed but the chemical bond at other portions still remains, abrasion of the image bearing member can be prevented.

Among the resins having a cross-linked structure, acrylic resins are preferable in terms that the impact on the electrostatic property due to a rough form is small because acrylic resins have a relatively large dielectric constant in comparison with a solid solution of a polycarbonate and a charge transport material.

It is possible to make a surface having a minute convexoconcave form by adding a filler to the surface layer. Accordingly, the circulation efficiency of the circulating material is improved. By blending the filler, a soft-feel texture (film) is formed on the surface of the image bearing member, which is suitable to improve the texture effect described above. In addition, by blending the filler, the abrasion resistance is further improved, which is furthermore advantageous to the sustainability of the form of the surface. The filler to be blended preferably has an average primary particle diameter in the magnitude of nano meter and alumina, tin oxide, titania, silica, and ceria are suitable. In particular, α-alumina having a particle diameter of from 0.2 μm to 0.5 μm is preferable.

The filler prevents the surface of an image bearing member from becoming prickly, thereby reducing the damage to members slidably contacting the image bearing member.

If an image forming apparatus in which the circulating material is supplied to the surface of the image bearing member is provided with a mechanism to scrape the circulating material with a brush and supply (input) the scraped circulating material to the surface of the image bearing member, not only the consumption amount of the circulating material is easily controlled but also the circulating material is supplied to all over the surface of the image bearing member, which is advantageous. Furthermore, in addition to the cleaning blade described above, by providing an application blade downstream from the brush mentioned above and upstream from the cleaning blade relative to the rotation direction of the image bearing member, it is possible to regulate the amount of the circulating material supplied to the surface of the image bearing member and promote smooth spreading of the circulating material. These brush and the application blade are suitable to adjust the circulation of the circulating material.

In addition, a brush or a sponge roller that is equal thereto in terms of function can be provided as the application blade.

Next, the multi-resolution analysis of the profile curve of the image bearing member is described.

In the present disclosure, the profile curve of the surface state of the parts of an image forming apparatus is obtained as defined in JIS B0601 to obtain a single dimensional data arrangement being the profile curve.

This single dimensional data arrangement being the profile curve can be obtained as digital signals by a surface texture and contour form measuring device or by A/D converting the analogue outputs from the surface texture and contour form measuring device.

In the present disclosure, the measuring length of the profile curve to obtain the single dimensional data arrangement is preferably a measuring length defined in JIS and is preferably from 8 mm to 25 mm.

The sampling interval is not greater than 1 μm and preferably from 0.2 μm to 0.5 μm. For example, when the measuring length of 12 mm is measured by the number of samplings of 30,720, the sampling interval is 0.390625 which is suitable to conduct the present disclosure.

As described above, this single dimensional data arrangement is subject to multi-resolution analysis by wavelet conversion (MRA-1) to separate the single dimensional data arrangement into multiple frequency components {e.g., six components of (HHH), (HHL), (HMH), (HML), (HLH), and (HLL)} from the high frequency component (HHH) to the low frequency component (HLL). Furthermore, another single dimensional data arrangement is made by thinning-out the obtained lowest frequency component (HLL). The thus-obtained another single dimensional data arrangement is subject to multi-resolution analysis by wavelet conversion (MRA-2) to separate the single dimensional data arrangement into multiple frequency components {e.g., six components of (LHH), (LHL), (LMH), (LML), (LLH), and (LLL)}. Arithmetical mean roughness is obtained for each of the thus-obtained 12 frequency components, which is referred to as WRa, in this specification to distinguish it from the typical Ra.

The arithmetical mean roughness WRa of each frequency component is an arithmetical mean roughness of the single dimensional data arrangement obtained by the multi-resolution analyses (MRA-1) and (MRA-2) described above which separate the single dimensional data arrangement obtained by measuring the convexoconcave form of the surface of an image bearing member by a surface texture and contour form measuring device into frequency components from the high frequency component to the low frequency component by wavelet conversion. In the present disclosure, the wavelet conversion in the present disclosure is conducted by using a software product of MATLAB. Since the definition of the bandwidth is a constraint from a software point of view, there is no special meaning for these ranges. In addition, WRa is limited by the definition of the bandwidth described above so that the coefficient changes accordingly as the bandwidth changes.

Individual bandwidths of HML components and HLH components, LHL components and LMH components, LMH components and LML components, LML components and LLH components, and LLH components and LLL components are overlapped. The reason of this overlapping is as follows.

In the wavelet conversion, original signals are decomposed into L (Low-pass components) and H (High-pass components) by the first wavelet conversion (Level 1) and L is further decomposed into LL and HL by wavelet conversion. If the frequency component f contained in the original signal matches the frequency F to be separated, f is a border of the separation so that it is separated into both L and H. This is inevitable in the multi-resolution analysis. Therefore, it is suitable to set the frequency contained in the original signal so as not for monitored frequency bandwidths to be separated at the wavelet conversion as described above.

Wavelet Conversion (Multi-resolution Analysis) and Symbols of Each Frequency

In the present disclosure, the wavelet conversion is conducted twice. The first wavelet conversion is referred to as wavelet conversion (MRA-1) and the second wavelet conversion is referred to as wavelet conversion (MRA-2). To separate the first conversion from the second conversion, H (first time) or L (second time) is put in front of the abbreviation of each frequency bandwidth for convenience.

Variety of wavelet functions can be use as the mother wavelet function for use in the first and the second wavelet conversion. Specific examples thereof include, but are not limited to, Daubecies function, haar function, Meyer function, Symlet function, and Coiflet function. In the present disclosure, haar function is used but the present invention is not limited thereto.

In addition, when multi-resolution analysis is conducted to separate data arrangement into multiple frequency components from the high frequency component to the low frequency component by wavelet conversion, the number of the components is preferably from 4 to 8 and more preferably 6.

In the present disclosure, after separation into the multiple frequency components by the first wavelet conversion, the thus-obtained lowest frequency component is thinned out and taken out (sampling) to make a single dimensional data arrangement reflecting the lowest frequency component. This single dimensional data arrangement is subject to the second wavelet conversion and thereafter, multi-resolution analysis is conducted to separate into the multiple frequency components from the high frequency component to the low frequency component.

In the thinning-out for the lowest frequency component (HLL) obtained from the first wavelet conversion (MRA-1), the number of data arrangement is reduced to 1/10 to 1/100.

By this thinning-out of the data, the frequency of the data is raised (widening the logarithm scale width of X axis). For example, if the number of the arrangement of the single dimensional arrangement obtained from the first wavelet conversion is 30,000, the number of arrangement becomes 3,000 after 1/10 thinning-out.

If this thinning-out level is excessively small, for example, ⅕, the degree of raising the data frequency is not sufficiently high. Also, the data are not separated well even after multi-resolution analysis by the second wavelet conversion.

If the thinning-out level is excessively large, for example, 1/200, the frequency of the data becomes too high, the data are too concentrated into the high frequency components to be separated even after multi-resolution analysis by the second wavelet conversion.

As a way of thinning data, if the thinning-out degree is 1/100, the average of 100 data is obtained, which is the point set as the single representative point.

FIG. 18 is a diagram illustrating an example of the configuration of a surface roughness evaluation device of an image bearing member, to which the present disclosure is applied. In FIG. 18, 41 represents an image bearing member, 42 represents a jig to which a probe is attached to measure the surface roughness of the image bearing member 41, 43 represents a mechanism to move the jig 42 along a measuring target, 44 represents a surface texture and contour form measuring device, and 45 represents a home computer to analyze signals. In FIG. 18, the home computer 45 calculates the multi-resolution analysis described above. If the image bearing member takes a cylinder-like form, the surface roughness of the image bearing member is measured along any suitable direction, for example, the circumference direction or the longitudinal direction.

FIG. 18 is just an example for the illustration purpose only and any suitable configuration can be employed in the present disclosure. For example, a special numerical calculation processor can be used for the multi-resolution analysis instead of using a home computer. Moreover, this processing can be conducted by the surface texture and contour form measuring device. The result is shown by any suitable method, for example, displayed on a CRT or a liquid display, or printing. In addition, the result can be transmitted as electric signals to another device or stored in a USB memory or an MO disk.

In the measurement, the present inventors use the following devices:
Surface texture and contour form measuring device: Surfcom 1400D (manufactured by Tokyo Seimitsu Co., Ltd.)
Home computer: home computer manufactured by International Business Machines Corp.
Cable: RS-232-C cable to link Surfcom 1400D and the home computer of IBM.

Processing of the surface roughness data transmitted from Surfcom 1400D to the home computer and its multi-resolution analysis calculation are conducted by software made by the present inventors, etc. based on C language.

Next, the procedure of the multi-resolution analysis for the surface form of an image bearing member is described with reference to specific examples.

First, the surface form of an image bearing member is measured by Surfcom 1400D (manufactured by Tokyo Seimitsu Co., Ltd.). Each of the measuring length is 12 mm and the total number of samplings is 30,720. Four points are measured once. The measuring results are taken in the home computer and thereafter subject to the first time wavelet conversion, thinning-out processing of 1/40 for the obtained lowest frequency component, and the second wavelet conversion using the program made by the present inventors, etc.

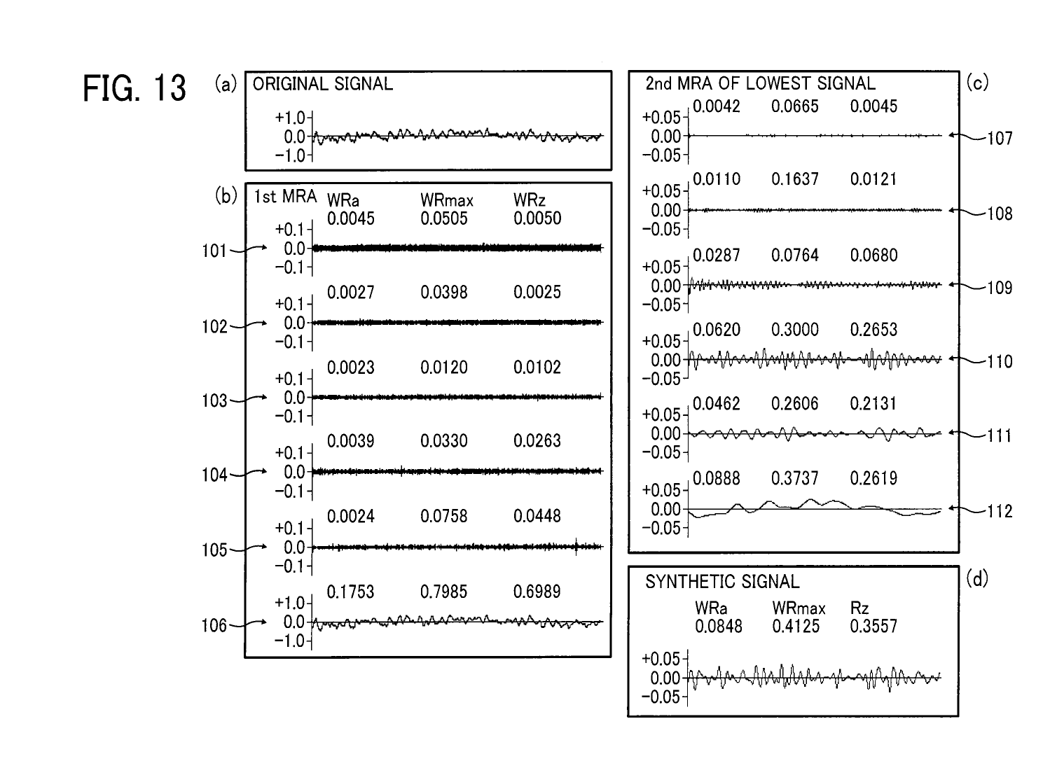

To the results of the multi-resolution analysis for the first time and the second time, the arithmetical mean roughness WRa, the maximum height Rmax, and the ten point height of irregularities Rz are obtained. An example of the calculation results is shown in FIG. 13.

The graph of (a) in FIG. 13 is formed by using the original data obtained by measuring the surface form by Surfcom 1400D and is also referred to as a roughness curve or a profile curve.

There are 14 graphs in FIG. 13 with a Y axis of the displacement of the surface form with a unit of μm.

The X axis represents the length and the measuring length is 12 mm although there is no scale thereon.

In the typical surface roughness measuring, the arithmetical mean roughness Ra, the maximum height Rmax, Rz, etc. are obtained from (a) of FIG. 13.

In addition, the six graphs in (b) of FIG. 13 are the results of the first multi-resolution analysis (MRA-1). The graph situated at the top is the graph of the highest frequency components (HHH) and the graph situated at the bottom is the graph of the lowest frequency components (HLL).

In (b) of FIG. 13, the graph 101 situated at the top is the highest frequency component of the results of the first multi-resolution analysis and is referred to as HHH in the present disclosure.

In (b) of FIG. 13, the graph 102 is the frequency one below the highest frequency component of the results of the first multi-resolution analysis and is referred to as HHL in the present disclosure.

In (b) of FIG. 13, the graph 103 is the frequency two below the highest frequency component of the results of the first multi-resolution analysis and is referred to as HMH in the present disclosure.

In (b) of FIG. 13, the graph 104 is the frequency three below the highest frequency component of the results of the first multi-resolution analysis and is referred to as HML in the present disclosure.

In (b) of FIG. 13, the graph 105 is the frequency four below the highest frequency component of the results of the first multi-resolution analysis and is referred to as HLH in the present disclosure.

In (b) of FIG. 13, the graph 106 is the lowest frequency component of the results of the first multi-resolution analysis and is referred to as HLL in the present disclosure.

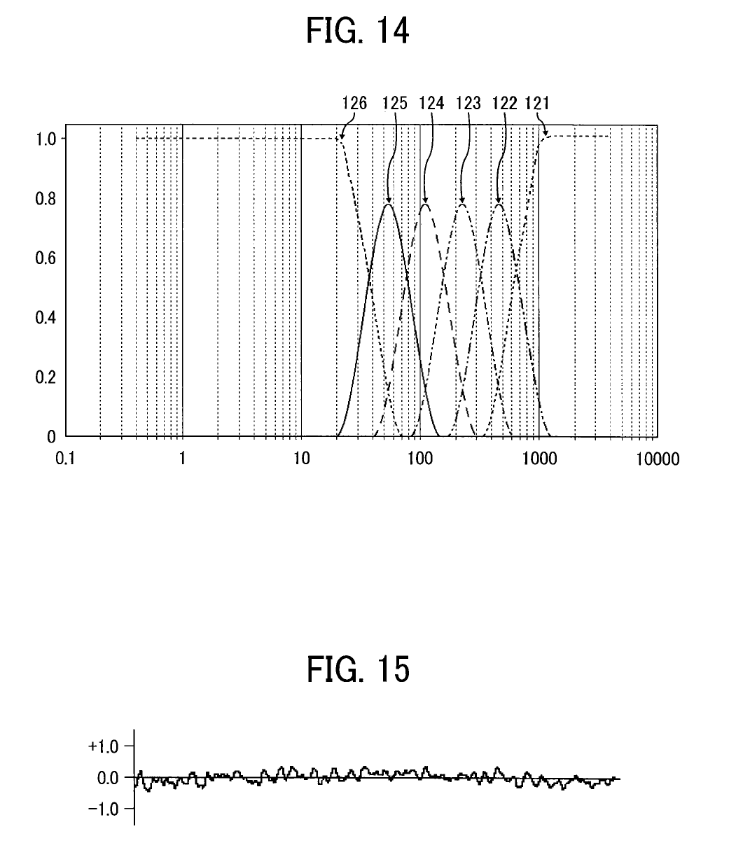

In the present invention, the graph of (a) in FIG. 13 is separated into the six graphs of (b) of FIG. 13 based on the frequency. The state of the frequency separation is illustrated in FIG. 14.

In FIG. 14, the X axis is the number of the convexoconcave portions per mm when the forms of the convexoconcave portions are regarded as sign waves. In addition, the Y axis indicates the ratio when separated into each bandwidth.

In FIG. 14, 121 represents the bandwidth of the highest frequency component (HHH) in the first multi-resolution analysis (MRA-1), 122 is the bandwidth of one below the highest frequency component (HHL) in the first multi-resolution analysis, 123 is the bandwidth of two below the highest frequency component (HMH) in the first multi-resolution analysis, 124 is the bandwidth of three below the highest frequency component (HML) in the first multi-resolution analysis, 125 is the bandwidth of four below the highest frequency component (HLH) in the first multi-resolution analysis, and 126 is the bandwidth of the lowest frequency component (HLL) in the first multi-resolution analysis.

FIG. 14 is described in detail. When the number of the convexoconcave portions per mm is 20 or less, all appears in the graph 126. For example, when the number of the convexoconcave portions per mm is 110, it appears most in the graph 124, which corresponds to HML in (b) of FIG. 13. For example, when the number of the convexoconcave portions per mm is 220, it appears most in the graph 123, which corresponds to HMH in (b) of FIG. 13. For example, when the number of the convexoconcave portions per mm is 310, it appears most in the graphs 122 and 123, which correspond to HHL and HMH in (b) of FIG. 13. Therefore, which of the six graphs of (b) of FIG. 13 the highest ratio appears in is determined depending on the frequency of the surface roughness. In other words, in the surface roughness, fine roughness appears on the graphs situated on the top side in (b) of FIG. 13 and large surface waviness appears on the graphs on the bottom side in (b) of FIG. 13.

In the present disclosure, the surface roughness is decomposed by the frequency. This is represented by the graphs of (b) of FIG. 13. The surface roughness in each of the frequency bandwidth is obtained from the graph per this frequency bandwidth. As the surface roughness, the arithmetical mean roughness, the maximum height, and the ten point height of irregularities are calculated.

In (b) of FIG. 13, the values of the arithmetical mean roughness WRa, the maximum height WRmax, and the ten point height of irregularities WRz are shown in each graph. “W” is put in front as in the arithmetical mean roughness WRa, the maximum height WRma, and the ten point height of irregularities WRz of the roughness curve obtained by the wavelet conversion to separate them from the typical representation.

In the present disclosure, as described above, the data measured by the surface texture and contour form measuring device are separated into multiple data by frequency so that the variance of the convexoconcave portions in each frequency bandwidth is measured.

Furthermore, in the present disclosure, the lowest frequency, i.e., FILL data are thinned out from the separated data as in (b) of FIG. 13 by frequency.

In the present disclosure, how data are thinned out, i.e., taking out from how many pieces of data can be determined by experiments so that the number of data to be thinned out can be optimized. Therefore, the frequency bandwidth separation in the multi-resolution analysis illustrated in FIG. 14 is made optimized, thereby setting the target frequency as the center of the bandwidth.

In FIG. 13, a single datum is left out of 40 pieces of data in this thinning-out.

The results of the thinning-out is shown in FIG. 15. In FIG. 15, the Y axis is the surface roughness with a unit of μm. The X axis represents the length with a measuring length of 12 mm without a scale.

In the present disclosure, the data in FIG. 15 are further subject to multi-resolution analysis, which is the second multi-resolution analysis (MRA-2).

The six graphs in (c) of FIG. 13 are the results of the second multi-resolution analysis (MRA-2) and the graph 107 situated at the top is highest frequency component of the results of the second multi-resolution analysis, which is referred to as LHH.

The graph 108 is the frequency one below the highest frequency component of the results of the second multi-resolution analysis and is referred to as LHL.

The graph 109 is the frequency two below the highest frequency component of the results of the second multi-resolution analysis and is referred to as LMH.

The graph 110 is the frequency three below the highest frequency component of the results of the second multi-resolution analysis and is referred to as LML.

The graph 111 is the frequency three below the highest frequency component of the results of the second multi-resolution analysis and is referred to as LLH.

The graph 112 is the lowest frequency component of the results of the second multi-resolution analysis and is referred to as LLL.

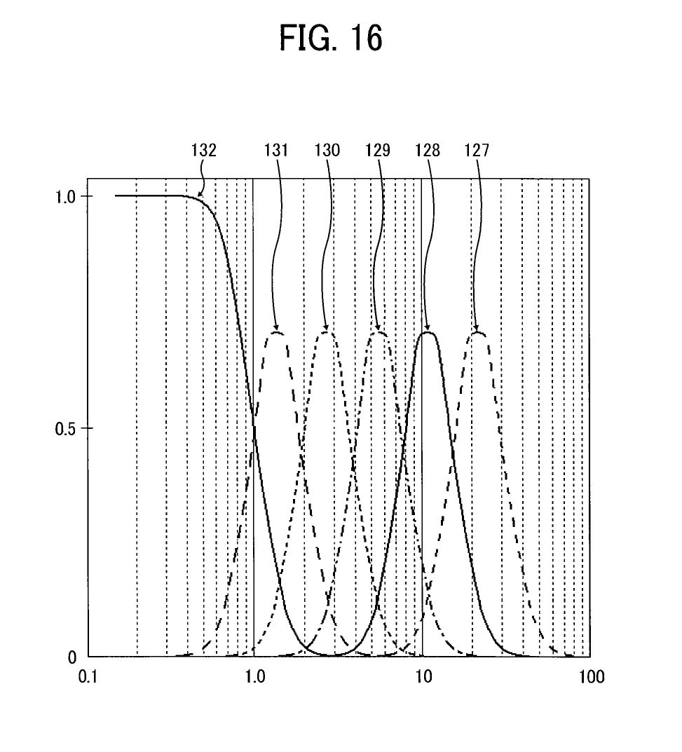

In the present invention, in (c) of FIG. 13, there are six separated graphs by frequency and the state of the frequency separation is illustrated in FIG. 16.

In FIG. 16, the X axis is the number of the convexoconcave portions per mm when the forms of the convexoconcave portions are regarded as sign waves. In addition, the Y axis indicates the ratio when separated into each bandwidth.

In FIG. 16, 127 represents the bandwidth of the highest frequency component (LHH) in the second multi-resolution analysis, 128 is the bandwidth of one below the highest frequency component (LHL) in the second multi-resolution analysis, 129 is the bandwidth of two below the highest frequency component (LMH) in the second multi-resolution analysis, 130 is the bandwidth of three below the highest frequency component (LML) in the second multi-resolution analysis, 131 is the bandwidth of four below the highest frequency component (LLH) in the second multi-resolution analysis, and 132 is the bandwidth of the lowest frequency component (LLL) in the second multi-resolution analysis.

FIG. 16 is described in detail. When the number of the convexoconcave portions per mm is 0.2 or less, all appears in the graph 132.

For example, when the number of the convexoconcave portions per mm is 11, it appears strongest in the graph 128, i.e., in the bandwidth of the frequency component one below the highest frequency component in the second multi-resolution analysis, meaning LML in (c) of FIG. 13.

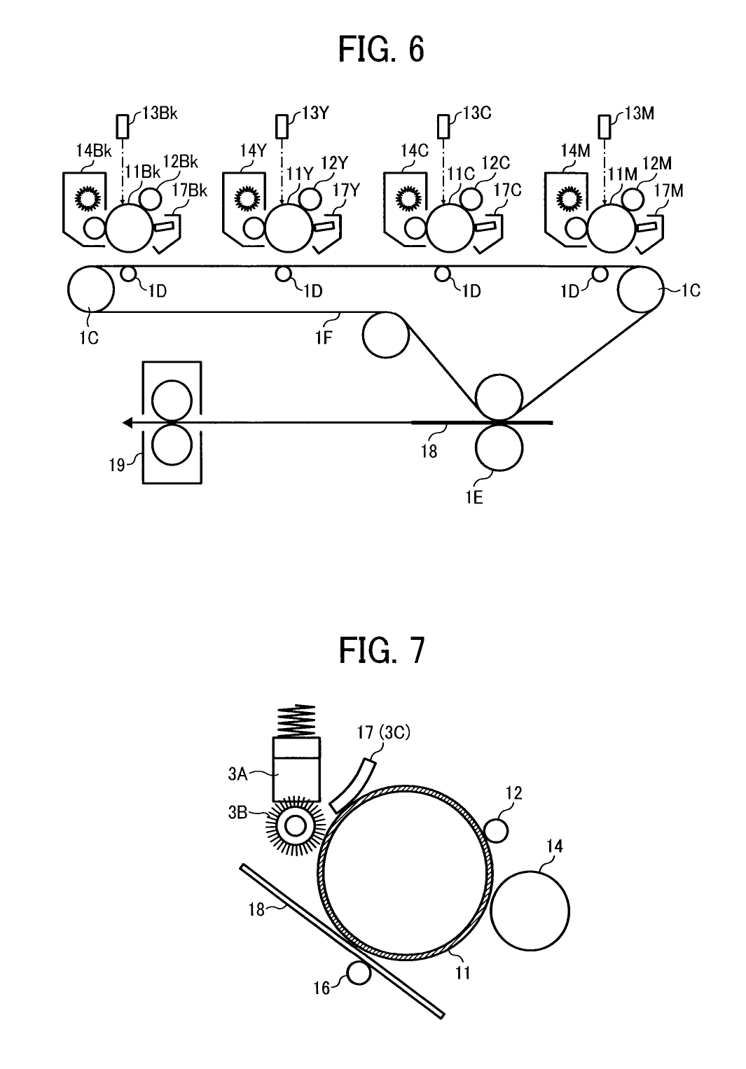

Therefore, which of the six graphs of (b) of FIG. 6 the highest ratio appears in is determined depending on the frequency of the surface roughness.

In other words, in the surface roughness, fine roughness appears on the graphs situated on the top side in (c) of FIG. 13 and large surface waves appear on the bottom side of the graphs of (c) of FIG. 13.

In the present disclosure, the surface roughness is decomposed by the frequency. This is represented by the graphs of (c) of FIG. 13. The surface roughness in each frequency bandwidth is obtained from the graph per the frequency bandwidth. As the surface roughness, the arithmetical mean roughness RA (WRa), the maximum height Rmax (WRmax), and the ten point height of irregularities RZ (WRz) are calculated.

The single dimensional data arrangement obtained by measuring the convexoconcave portions of the surface of the image bearing member is subject to the multi-resolution analysis of separating into multiple frequency components from high frequency components to low frequency components by wavelet conversion, and the lowest frequency component obtained here is thinned-out to obtain another single dimensional data arrangement. The single dimensional data arrangement is furthermore subject to wavelet conversion to conduct multi-resolution analysis of separating into multiple frequency components from high frequency components to low frequency components. For the thus-obtained each frequency component, the arithmetical mean roughness Ra (WRa)(μm), the maximum height Rmax (WRmax)(μm), and the ten point height of irregularities RZ (WRz)(μm) are calculated. The results are shown in Table 1.

TABLE 1

| | | Surface roughness obtained from results of | | |
|---|---|---|---|---|
| | | multi-resolution analysis | | |
| Number of | | Arithmetical | | Ten point |
| multi- | | mean | | height of |
| resolution | | roughness | Maximum | irregularities |
| analysis | Signal name | WRa | height WRmax | WRz |
| First time | HHH | 0.0045 | 0.0505 | 0.050 |
| | HHL | 0.0027 | 0.0399 | 0.0025 |
| | HMH | 0.0023 | 0.0120 | 0.0102 |
| | HML | 0.0039 | 0.0330 | 0.0283 |
| | HLH | 0.0024 | 0.0758 | 0.0448 |
| | HLL | 0.1753 | 0.7985 | 0.6989 |
| Second time | LHH | 0.0042 | 0.0665 | 0.0045 |
| | LHL | 0.0110 | 0.1632 | 0.0121 |
| | LMH | 0.0287 | 0.0764 | 0.0660 |
| | LML | 0.0620 | 0.3000 | 0.2663 |
| | LLH | 0.0462 | 0.2606 | 0.2131 |
| | LLL | 0.0888 | 0.3737 | 0.2619 |

The (d) of FIG. 13 represents the surface form dedicated from the fourth and the fifth of the 6 frequency components from the top obtained from the results of the second multi-resolution analysis and the values of the arithmetical mean roughness Ra, the maximum height Rmax, and the ten point height of irregularities Rz are shown in the graph.

The values are as follows:

Arithmetical mean roughness WRa: 0.0848 μm

Maximum height WRmax: 04125 μm

Ten point height of irregularities WRz: 0.3557 μm

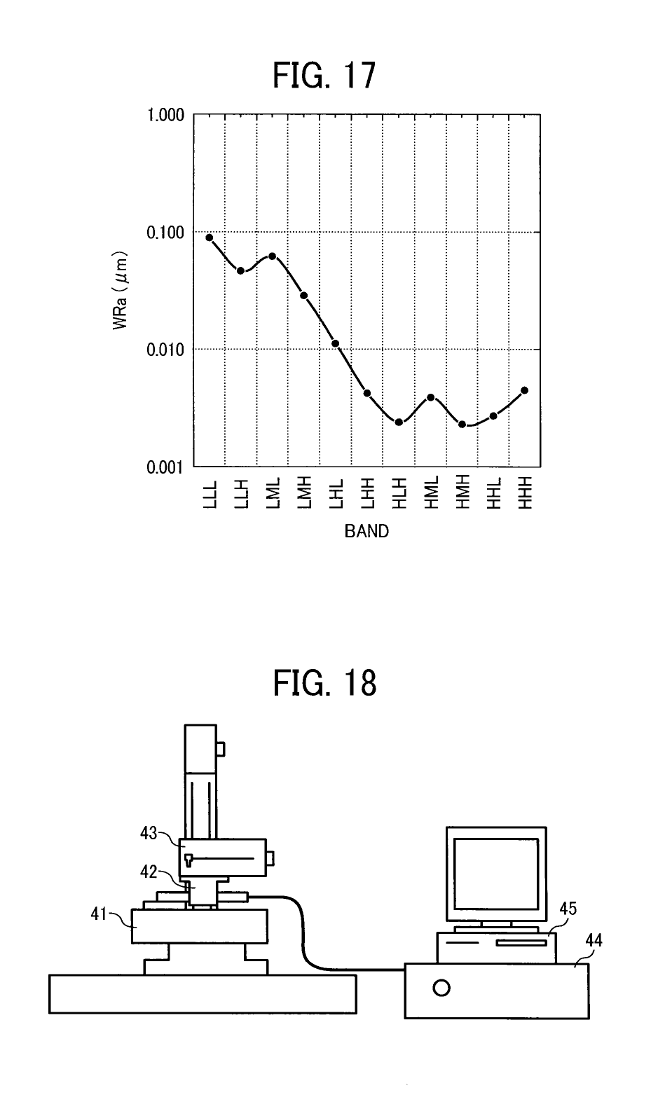

With regard to the profile curve of FIG. 13, the arithmetical mean roughnesses WRa obtained from the results of the multi-resolution analysis of the present disclosure are plotted according to the sequence of the signals and linked with lines to obtain a profile (graph) shown in FIG. 17. In this plotting, since HLL component is an arithmetically extreme value, the surface roughness obtained from the results of multi-resolution analysis of this bandwidth is omitted. In the present disclosure, this graph (profile) is referred to as the surface roughness spectrum or the roughness spectrum. Since the component obtained by the wavelet conversion for the roughness curve of HLL is LHH component or LLL component, the data about HLL is reflected on LHH component or LLL component. For this reason, omitting HLL component does not cause a problem in the profile.

Latent Image Bearing Member (Photoreceptor)

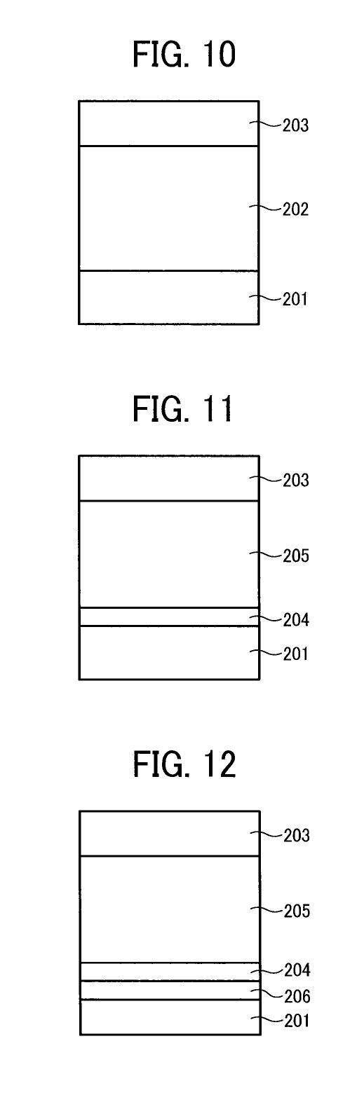

The latent image bearing member is described in detail with reference to FIGS. 10 to 12.

The image bearing member for use in the present disclosure includes an electroconducitve substrate, a laminar photosensitive layer of at least a photosensitive layer and a charge transportable sub-surface layer in this sequence is provided overlying the electroconducitve substrate, and other optional layers such as an intermediate layer.

FIG. 10 is a schematic cross section illustrating an example of the latent image bearing member of the present disclosure having a structure of a substrate 201 on which a photosensitive layer 202 and a charge transportable sub-surface layer 203 are provided. In addition, FIGS. 11 and 12 illustrate another layer structure examples of the latent image bearing member of the present disclosure. FIG. 11 is diagram illustrating a function separated type of a photosensitive layer formed of a charge generating layer 204 and a charge transport layer 205. FIG. 12 is a diagram of a structure formed of the substrate 201, and the function separated photosensitive layer having the charge generating layer 204 and the charge transport layer 205 with an undercoating layer 206 between the substrate 201 and the charge generating layer 204. In the present disclosure, the latent image bearing member having the photosensitive layer 202 and the charge transportable sub-surface layer 203 overlying the substrate 201 suitably employs any combination of the type of the photosensitive layer and the other optional layers.

Sub-Surface Layer

The sub-surface layer is a protective layer formed on the surface of the image bearing member. This protective layer is formed by a resin having a cross-linked structure by polycondensation reaction after a liquid application containing a resin (monomer) component is applied. Since the resin layer has the cross-linked structure, the sub-surface layer has the highest abrasion resistance among the layers of the image bearing member. Also, since the cross-linked charge transport structure unit is contained in the sub-surface layer, it has a charge transport property similar to that of the charge transport layer.

Roughening Surface

In the present disclosure, among the frequency components of the roughness of the surface of the image bearing member, WRa in the bandwidths of HMH, HML, and HLH ranges from 0.002 μm to 0.005 μm and WRA (LLH) is 0.05 μm or less. Therefore, the surface of the image bearing member is required to have a particular rough surface. To be specific, reagents that are expected to control the surface form are added, for example, blending fillers, sol-gel based paints, or resin polymers having different glass transition temperature, addition of organic particulates or foaming agents, and a mass amount of addition of silicone oil. By suitably designing the addition amount of such reagents and the state of filler dispersion, the surface roughness of the present disclosure can be made within the range of the present disclosure.

In addition, as to controlling of the film-forming conditions of the surface layer, a mass amount of water is added to the liquid application, liquid reagents having different boiling points are added, etc. It is possible to suitably adjust drying temperature, drying time, etc. to set the surface roughness in the range of the present disclosure when the content of a liquid application, application condition, or drying process is used.

In addition, it is possible to sprinkle an organic solvent or water to an uncured wet film immediately after coating the sub-surface layer with the liquid application thereof. Furthermore, as an optional additional processing after curing a cross-linking type resin film, the surface can be subject to sand blast processing or ground by sand paper such a wrapping film. When using such treatment, it is possible to adjust the particle diameter or material of media for use in sand blasting, angle a spraying nozzle or spraying speed, particle diameter or material of grinding paper, pressure, direction, speed during grinding to make the surface roughness within the range of the present disclosure.

Cross-linked Type Resin Layer

The present disclosure forms quality images required to commercial printing free from uneven image density over continuous printing by providing a three-dimension cross-linked layer as the surface layer, formed by initiating radical chain polymerization upon application of active energy to a mixture of a radical polymerizable compound having a charge transport structure and a multi-functional radical polymerizable monomer to a conventional laminar image bearing member. A particular oxazole compound is added to this surface layer when forming the three-dimension cross-linked layer to prevent occurrence of charge trap and uneven occurrence thereof, thereby charge variation during repetitive use over an expended period of time.

In addition, by adding a particular diamine compound to the surface layer, the charge transport capability is not or little degraded or resins are not degraded by oxidized gas. For this reason, gas resistance and charge stability of the surface layer can be maintained for an extended period of time, thereby subduing variation of charge during continuous printing. If an anti-oxidant is added to subdue degradation of the degradation of resins by oxidized gases, the charge transportability may be worsened.

An image bearing member that forms quality images in demand in commercial printing is required to have stable irradiation voltage without change between image forming operations for continuous printing for an extended period of time. For this reason, in addition to particular conditions about the thickness or uniformity of a cross-linked protective layer, preventing the occurrence of charge trap inside the surface layer is necessary.

The sub-surface layer described above has a cross-linked structure having a charge transport feature. It is formed by dissolving or dispersing in a suitable solvent a radical polymerizable monomer having three or more functional groups with no charge transport structure, a radical polymerizable compound having a charge transport structure, the oxazole compound represented by chemical formula 1 or chemical formula 2, and a diamine compound represented by chemical formula 3 or chemical formula 4 followed by application of the thus-obtained liquid application to the photosensitive layer. Subsequent to optional drying, the image bearing member is exposed to external energy such as ultraviolet ray for curing the liquid application.

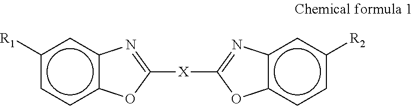

In the chemical formula 1. R₁ and R₂ each, independently represent hydrogen atoms or alkyl groups having one to four carbon atoms and X represents a vinylene group, a bifunctional group of an aromatic hydrocarbon having 6 to 14 carbon atoms, or 2,5-thiophenediyl.

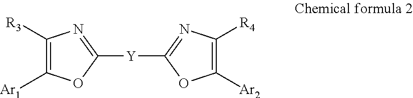

In the chemical formula 2, Ar₁ and Arₑ each, independently represent a monofunctional group of an aromatic hydrocarbon having 6 to 14 carbon atoms, Y represents a bifunctional group of an aromatic hydrocarbon having 6 to 14 carbon atoms, and R₃ and R₄ each, independently represent hydrogen atoms and methyl groups.

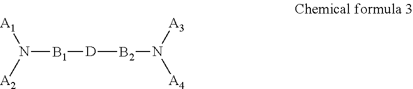

In the chemical formula 3, X represents an arylene group with or without a substitution group or a group represented by the following chemical structure,

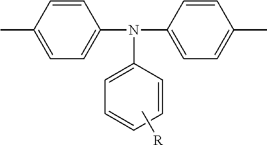

In the chemical structure, R represents a hydrogen atom, an alkyl group having one to four alkyl group, an alkoxy group having one to four carbon atoms.

A₁, A₂, A₃, and A₄ each, independently represent groups selected from the following i, ii, or iii.

i: an alkyl group having one to four carbon atoms,

ii: —CH₂(CH₂)mZ, where Z represents an aryl group, a cycloalkyl group, or a heterocycloalkyl group with or without a substitution group and m represents 0 or 1, and

iii: an aryl group with or without a substitution group.

In a case in which none of A₁, A₂, A₃, and A₄ is iii, it is preferable that A₁ or A₂ is i and A₃ or A₄ is i.

B₁ and B₂ each, independently represent —CH₂—, —CH₂CH₂—, —CH₂—Ar—, —Ar—CH₂—, —CH₂CH₂—Ar—, or —Ar—CH₂CH₂—, where Ar represents an arylene group with or without a substitution group,

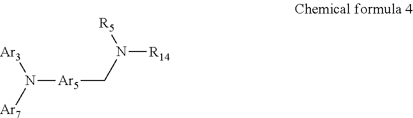

where, R₅ and R₁₄ each, independently, alkyl groups with or without a substitution group, aralkyl groups with or without a substitution group, or monofunctional groups of aromatic hydrocarbon with or without a substitution group, Ar₅ represents bifunctional groups of substituted or non-substituted aromatic hydrocarbon, Ar₇ and Ar³ each, independently represent, alkyl groups with or without a substitution group, aralkyl groups with or without a substitution group, or monofunctional groups of aromatic hydrocarbon with or without a substitution group, Ar₅ and Ar₇ or Ar₇ and Ar₃ are mutually bonded to share a nitrogen-containing heterocyclic ring with or without a substitution group,

The radical polymerizable functional group represents any radical polymerizable functional group which has a carbon-carbon double bond. For example, 1-substituted ethylene functional groups and 1,1-substituted ethylene functional groups are suitably used as the radical polymerizable functional groups.

A specific example of 1-substituted ethylene functional groups is the functional group represented by the following chemical structure 1.

CH₂═CH—X₁— Chemical structure 1

In the chemical structure 1, X¹ represents an arylene group such as a substituted or non-substituted phenylene group and naphtylene group, a substituted or non-substituted alkenylene group, —CO— group, —COO— group, —CON(R¹⁰)— group (where R¹⁰ represents a hydrogen atom, an alkyl group such as methoxy group and ethoxy group, an aralkyl group such as benzyl group, naphthylmethyl group, and phenethyl group, an aryl group such as phenyl group and naphtyl group), and —S— group.

Specific examples of such functional groups include, but are not limited to, a vinyl group, a styryl group, a 2-methyl-1,3-butadienyl group, a vinyl carbonyl group, an acryloyloxy group, an acryloyl amide group, and a vinylthio ether group.

A specific example of 1-substituted ethylene functional groups is the functional group represented by the following chemical structure 2.

CH₂═CE—X₂— Chemical structure 2

In the chemical structure 2, E represents a substituted or non-substituted alkyl group, a substituted or non-substituted aralkyl group, an aryl group such as a substituted or non-substituted phenyl group and a substituted or non-substituted naphtylene group, a halogen atom, a cyano group, a nitro group, an alokoxy group such as a methoxy group and an ethoxy group, —COOR¹¹ (R¹¹ represents a hydrogen atom, an alkyl group such as a substituted or non-substituted methyl group and an substituted or non-substituted ethyl group, an aralkyl group such as a substituted or non-substituted benzyl group and a substituted or non-substituted phenethyl group, an aryl group such as substituted or non-substituted phenyl group and a substituted or non-substituted naphtyl group, or —CONR¹²R¹³ (R¹² and R¹³ independently represent a hydrogen atom, an alkyl group such as a substituted or non-substituted methyl group and a substituted or non-substituted ethyl group, an aralkyl group such as a substituted or non-substituted benzyl group, a substituted or non-substituted naphthyl methyl group, and a substituted or non-substituted phenethyl group, or an aryl group such as a substituted or non-substituted phenyl group and a substituted or non-substituted naphtyl group). X₂ represents a single bond, the same substitution group as X₁ in the chemical structure 1, or an alkylene group. At least one of E and X₂ is an oxycarbonyl group, a cyano group, an alkenylene group, and an aromatic ring.

Specific examples of these substitution groups include, but are not limited to, α-acryloyloxy chloride group, methacryloyloxy group, α-cyanoethylene group, α-cyanoacryloyloxy group, α-cyanophenylene group, and methacryloyl amino group.

Specific examples of the substitution group substituted to the substitution group of X and E include, but are not limited to, a halogen atom, a nitro group, a cyano group, an alkyl group such as a methyl group and an ethyl group, an alokoxy group such as methoxy group and ethoxy group, an aryloxy group such as a phenoxy group, an aryl group such as a phenyl group and naphtyl group, and an aralkyl group such as benzyl group and a phenetyl group.

Among these radical polymerizable functional groups, in particular an acryloyloxy group and a methacryloyloxy group are preferable. A compound having one acryloyloxy group is obtained by conducting ester reaction or ester conversion reaction using, for example, a compound having one hydroxyl group in its molecule and an acrylic acid (salt), a halide acrylate, and an ester of acrylate. A compound having a methacryloyloxy group is obtained in the same manner.

The particular oxazole compound in the present disclosure is represented by the chemical formula 1 or the chemical formula 2.

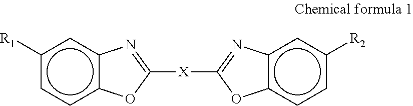

In the chemical formula 1, R₁ and R₂ each, independently represent hydrogen atoms or alkyl groups having one to four carbon atoms and X represents a vinylene group, a bifunctional group of an aromatic hydrocarbon having 6 to 14 carbon atoms, or 2,5-thiophenediyl.

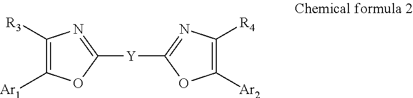

In the chemical formula 2, Ar₁ and Ar₂ each, independently represent a monofunctional group of an aromatic hydrocarbon having 6 to 14 carbon atoms, Y represents a bifunctional group of an aromatic hydrocarbon having 6 to 14 carbon atoms, and R₃ and R₄ each, independently represent hydrogen atoms and methyl groups.

Specific examples of the alkyl group having 1 to 4 carbon atoms of R¹ and R₂ include, but are not limited to, a methyl group, an ethyl group, an n-propyl group, an iso-propyl group, an n-butyl group, an iso-butyl group, a sec-butyl group, and a tert-butyl group. Specific examples of the bifunctional groups of the aromatic hydrocarbon having 6 to 14 carbon atoms of X include, but are not limited to, o-phenylene group, p-pheneylene group, 1,4-naphethalene diyl group, 2,6-naphenelene diyl group, 9,10-anthracene diyl group, 1,4-anthracene diyl group, 4,4′-biphenyl diyl group, and 4,4′-stilbene diyl group.

Specific examples of the monofunctional group of the aromatic hydrocarbon group having 6 to 14 carbon atoms of Ar₁ and Ar₂ include, but are not limited to, aromatic hydrocarbon groups such as a phenyl group, 4-methylphenyl group, 4-tert-butyl phenyl group, naphtyl group, and biphenyl group. Specific examples of the bifunctional groups of the aromatic hyfrocarbon having 6 to 14 carbon atoms of Y include, but are not limited to, o-phenylene group, p-pheneylene group, 1,4-naphethalene diyl group, 2,6-naphenelene diyl group, 9,10-anthracene diyl group, 1,4-anthracene diyl group, 4,4′-biphenyl diyl group, and 4,4′-stilbene diyl group.

Specific examples of the oxazole compound represented by the chemical formula 1 of 2 are shown below but are not limited thereto.

TABLE 2

| | |
|---|---|
| 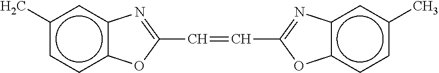 | Oxazole compound example II-1 |
| 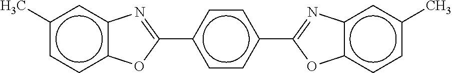 | Oxazole compound example II-2 |
| 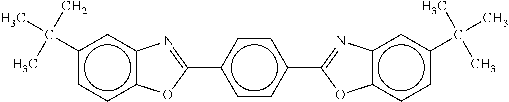 | Oxazole compound example II-3 |
| 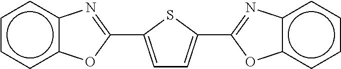 | Oxazole compound example II-4 |
| 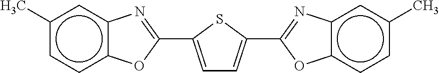 | Oxazole compound example II-5 |
| 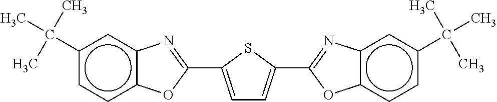 | Oxazole compound example II-6 |
| 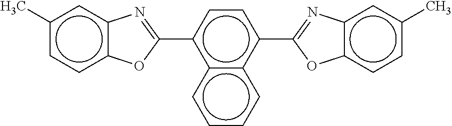 | Oxazole compound example II-7 |
| 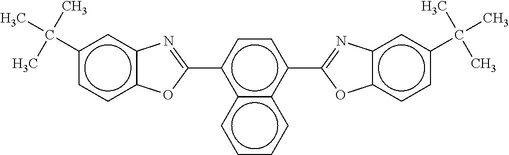 | Oxazole compound example II-8 |
| 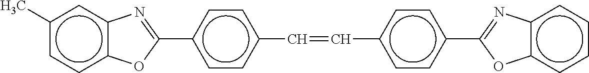 | Oxazole compound example II-9 |
| 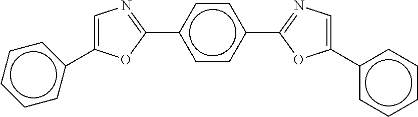 | Oxazole compound example II-10 |
| 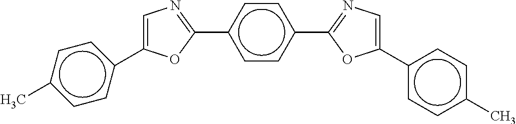 | Oxazole compound example II-11 |
| 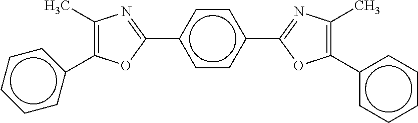 | Oxazole compound example II-12 |
| 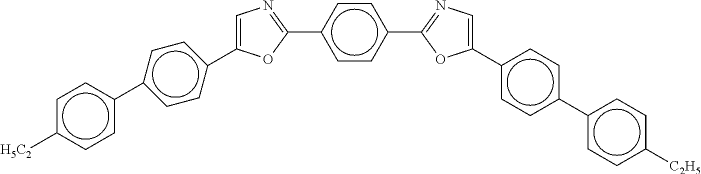 | Oxazole compound example II-13 |

these particular oxazole compounds are added to the sub-surface layer in an amount of from 0.1% by weight to 30% by weight. When this amount is too small, the variation of the voltage at irradiated portions over repetitive use for an extended period of time is not sufficiently reduced. When the amount is too large, the photosensitivity of an image bearing member tends to be worsened.

As described above, since these oxazole compounds do not demonstrate charge transportability, if added to the surface layer excessively, the charge transport compound is diluted, thereby degrading the charge transportability, resulting in degradation of the sensitivity, etc. In addition, since an addition of an excessive amount thereof reduces the cross-linking density by radical polymerization, the mechanical strength of the sub-surface layer is weakened and abrasion resistance deteriorates. Therefore, it is preferable to add it in an amount as small as possible in a range to keep the oxazole having a good impact. Addition of the oxazole compound in a mass ratio of from 0.5% by weight to 10% by weight to a radical polymerizable charge transport compound in the surface layer was confirmed by an experiment of changing the addition amount to clearly reduce occurrence of charge trap and is preferable in terms of less side effect on the surface layer.

The particular diamine compound in the present disclosure is represented by the chemical formula 3 or the chemical formula 4.

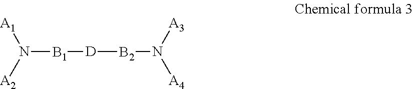

In the chemical formula 3, D represents an arylene group with or without a substitution group or a group represented by the following chemical structure.

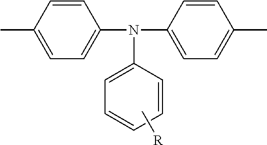

In the chemical structure, R represents a hydrogen atom, an alkyl group having one to four alkyl group, an alkoxy group having one to four carbon atoms.

A₁, A₂, A₃, and A₄ each, independently represent groups selected from the following i, ii, or iii,

i: an alkyl group having one to four carbon atoms,

ii: —CH₂(CH₂)mZ, where Z represents an aryl group, a cycloalkyl group, or a heterocycloalkyl group with or without a substitution group and m represents 0 or 1, and

iii: an aryl group with or without a substitution group.

In a case in which none of A₁, A₂, A₃, and A₄ is iii, it is preferable that A₁ or A₂ is i and A₃ or A₄ is i.

B₁ and B₂ each, independently represent —CH₂—, —CH₂CH₂—, —CH₂—Ar—, —Ar—CH₂—, —CH₂CH₂—Ar—, or —Ar—CH₂CH₂—, where Ar represents an arylene group with or without a substitution group

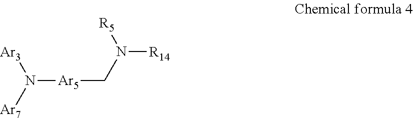

In the chemical formula 4, R₅ and R₁₄ each, independently, alkyl groups with or without a substitution group, aralkyl groups with or without a substitution group, or monofunctional groups of aromatic hydrocarbon with or without a substitution group, Ar₅ represents bifunctional groups of substituted or non-substituted aromatic hydrocarbon, Ar₇ and Ar³ each, independently represent, alkyl groups with or without a substitution group, aralkyl groups with or without a substitution group, or monofunctional groups of aromatic hydrocarbon with or without a substitution group, Ar₅ and Ar₇ or Ar₇ and Ar₃ are mutually bonded to share a substituted or non-substituted heterocyclic ring having a nitrogen atom,

Specific examples of the diamine compound represented by the chemical formula 3 are shown in Table 3 but are not limited thereto.

TABLE 3

| | Chemical Structures |
|---|---|
| A-1 | 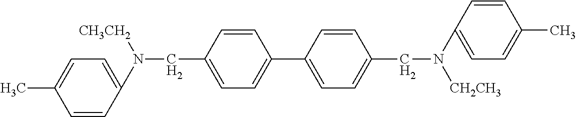 |
| A-2 | 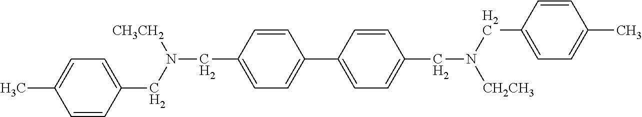 |
| A-3 | 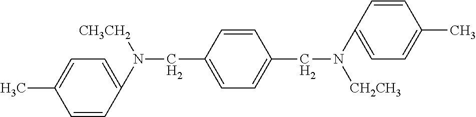 |
| A-4 | 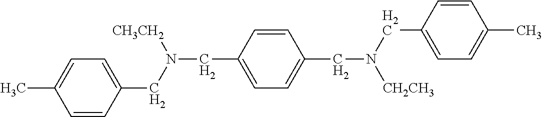 |
| A-5 | 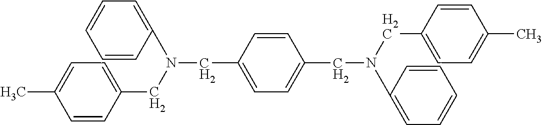 |
| A-6 | 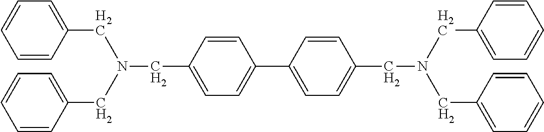 [SMILES: c1ccc(CN(Cc2ccccc2)Cc2ccc(-c3ccc(CN(Cc4ccccc4)Cc4ccccc4)cc3)cc2)cc1] |
| A-7 | 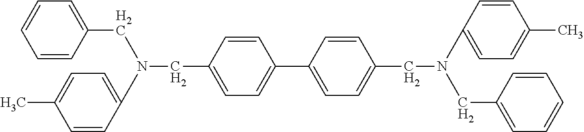 [SMILES: Cc1ccc(N(Cc2ccccc2)Cc2ccc(-c3ccc(CN(Cc4ccccc4)c4ccc(C)cc4)cc3)cc2)cc1] |
| A-8 | 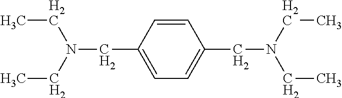 [SMILES: CCN(CC)Cc1ccc(CN(CC)CC)cc1] |
| A-9 | 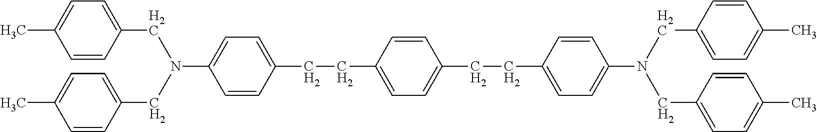 |
| A-10 | 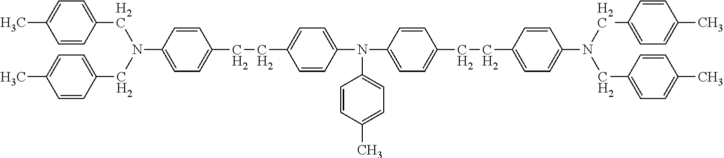 |

Specific examples of the diamine compound represented by the chemical formula 4 are shown in Table 4 but are not limited thereto.

TABLE 4

| Com- | | | | | |
|---|---|---|---|---|---|
| pound | | | | | |
| No. | Ar₅ | Ar₇ | Ar₃ | R₅ | R₁₄ |
| 1 | 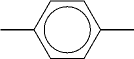 | 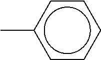 | 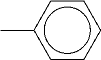 | —CH₃ | —CH₃ |
| 2 | 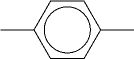 | 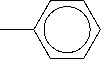 | 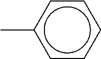 | —CH₂CH₃ | 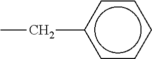 |
| 3 | 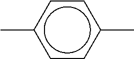 | 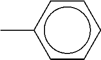 | 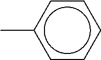 | —CH₃ | 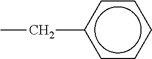 |
| 4 | 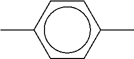 | 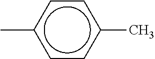 | 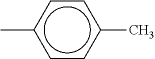 | 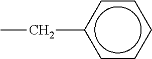 | 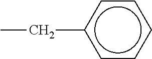 |
| 5 | 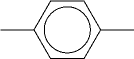 | 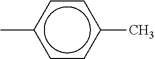 | 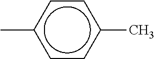 | —CH₂CH₃ | 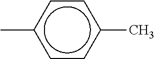 |
| 6 | 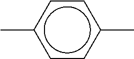 | 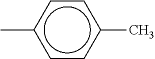 | 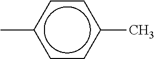 | —CH₂CH₃ | 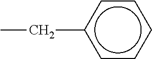 |
| 7 | 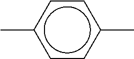 | 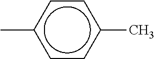 | 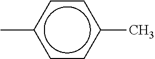 | —CH₃ | 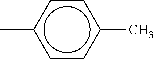 |
| 8 | 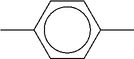 | 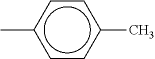 | 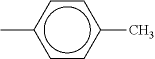 | —CH₂CH₂CH₃ | 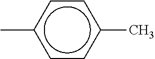 |
| 9 | 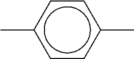 | 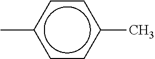 | 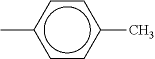 | —CH₂CH₃ | 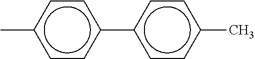 |
| 10 | 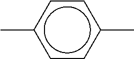 | 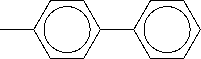 | 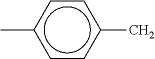 | 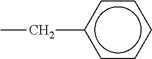 | 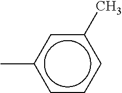 |
| 11 | 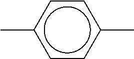 | 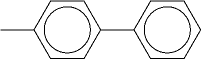 | 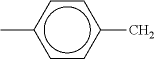 | 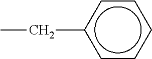 | 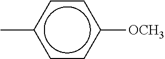 |
| 12 | 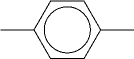 | 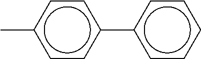 | 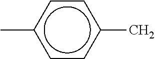 | 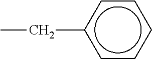 | 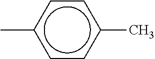 |
| 13 | 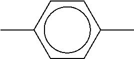 | 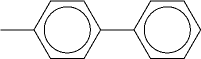 | 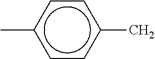 | 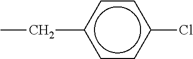 | 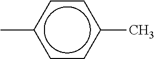 |
| 14 | 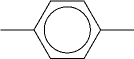 | 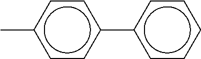 | 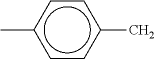 | —CH₂CH₃ | 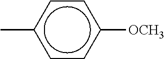 |
| 15 | 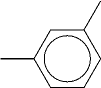 | 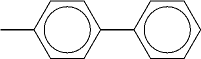 | 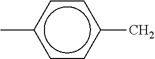 | —CH₂CH₃ | 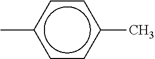 |
| 16 | 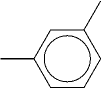 | 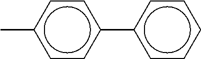 | 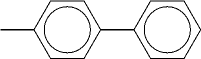 | 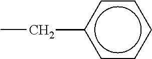 | 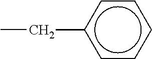 |
| 17 | 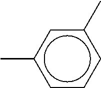 | 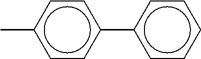 | 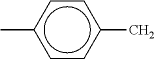 | —CH₂CH₃ | —CH₂CH₃ |
| 18 | 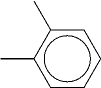 | 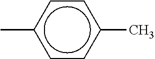 | 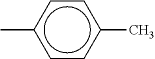 | —CH₂CH₃ | 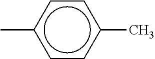 |
| 19 | 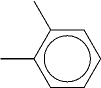 | 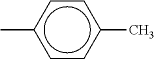 | 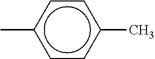 | 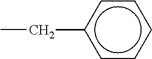 | 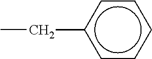 |
| 20 | 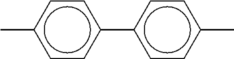 | 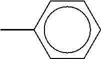 | 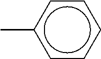 | —CH₃ | —CH₃ |
| 21 | 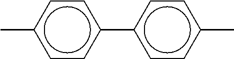 | 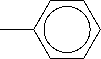 | 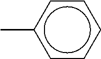 | —CH₂CH₃ | 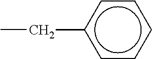 |
| 22 | 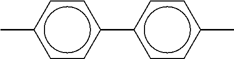 | 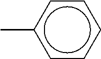 | 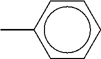 | 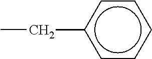 | 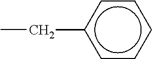 |
| 23 | 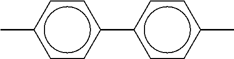 | 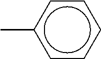 | 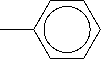 | —CH₂CH₃ | 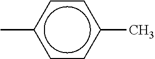 |
| 24 | 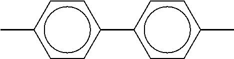 | 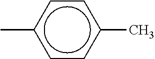 | 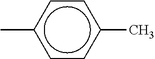 | —CH₃ | —CH₃ |
| 25 | 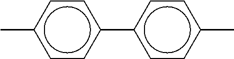 | 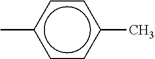 | 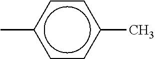 | —CH₂CH₃ | 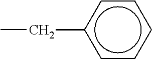 |
| 26 | 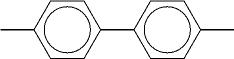 | 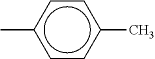 | 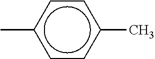 | 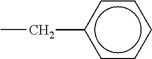 | 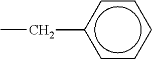 |
| 27 | 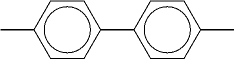 | 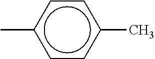 | 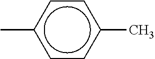 | —CH₂CH₃ | 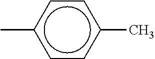 |
| 28 | 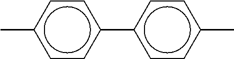 | 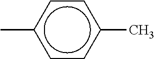 | 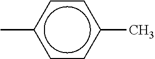 | 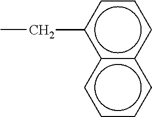 | 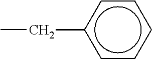 |
| 29 | 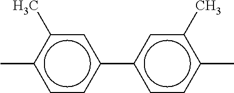 | 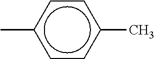 | 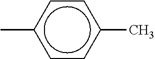 | 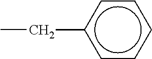 | 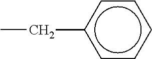 |
| 30 | 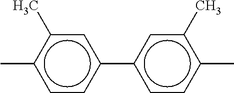 | 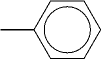 | 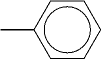 | 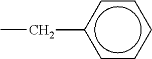 | 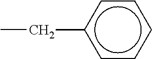 |
| 31 | 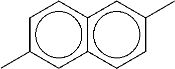 | 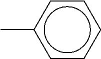 | 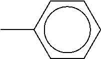 | —CH₂CH₃ | 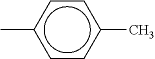 |
| 32 | 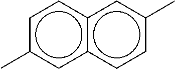 | 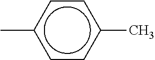 | 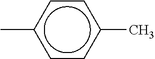 | —CH₂CH₃ | 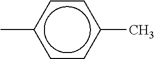 |
| 33 | 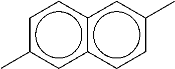 | 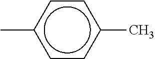 | 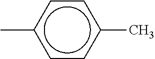 | 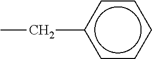 | 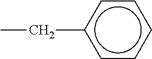 |
| 34 | 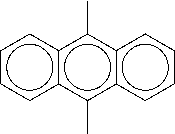 | 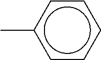 | 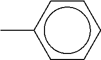 | 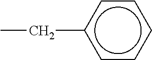 | 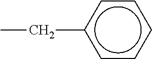 |
| 35 | 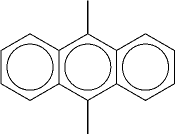 | 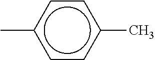 | 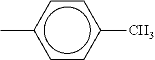 | 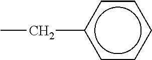 | 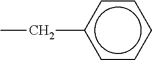 |
| 36 | 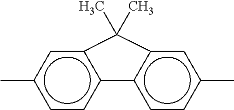 | 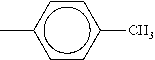 | 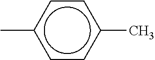 | 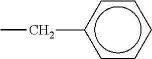 | 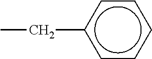 |
| 37 | 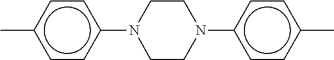 | 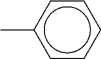 | 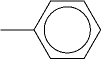 | 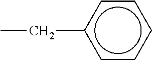 | 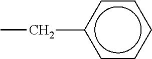 |
| 38 | 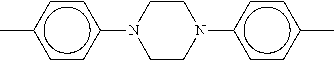 | 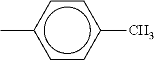 | 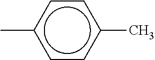 | 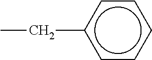 | 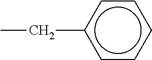 |
| 39 | 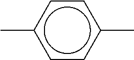 | 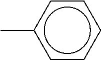 | 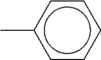 | —CH₂CH₃ | 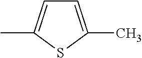 |
| 40 | 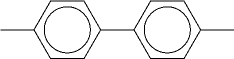 | 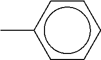 | 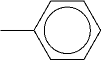 | —CH₂CH₃ | 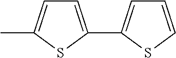 |
| 41 | 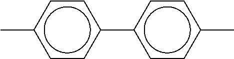 | 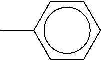 | 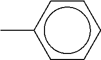 | 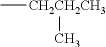 | 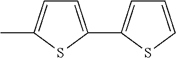 |
| 42 | 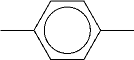 | 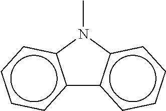 | | 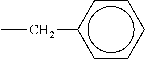 | 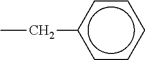 |
| 43 | 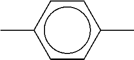 | 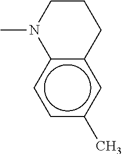 | | 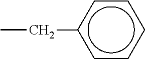 | 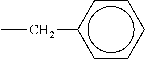 |
| 44 | 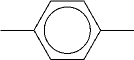 | 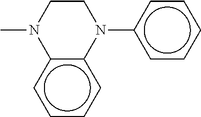 | | 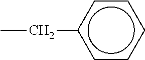 | 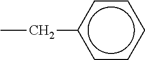 |
| 45 | 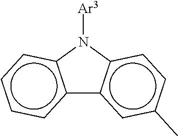 | | 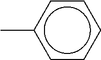 | 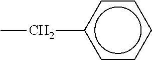 | 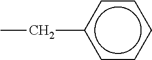 |
| 46 | 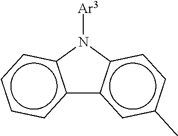 | | —CH₂CH₃ | 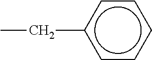 | 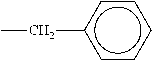 |
| 47 | 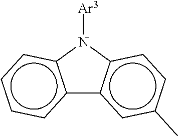 | | 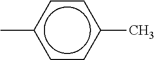 | —CH₂CH₃ | 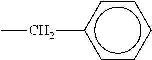 |
| 48 | 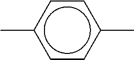 | 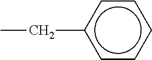 | 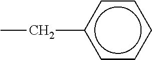 | —CH₂CH₃ | 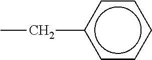 |

The mass ratio of the diamine compound in the surface layer preferably ranges from 0.5% by weight to 5.0% by weight. When the content of the diamine compound is 0.5% by weight or greater, degradation of the photosensitive layer by oxidized gas is reduced. When the content of the diamine compound is 5.0% by weight or less, the sensitivity of an image bearing member is not adversely affected, which eliminates causes of problems such as a rise in the residual voltage. In addition, in a case of a cross-linked surface layer, an addition of excessive amount of the diamine compound reduces the cross-linking density thereof so that the mechanical strength of the surface layer is weakened and abrasion resistance deteriorates. Therefore, the mass ratio of the diamine compound in the surface layer ranges from 0.5% by weight to 5.0% weight and preferably from 0.5% by weight to 2.0% weight to overcome the trade-off between reduction of occurrence of charge trap and abrasion resistance.

The radical polymerizable monomer having three or more functional groups with no charge transport structure for use in the present disclosure has no hole-carrier transport structure and a specific example thereof is a monomer having three or more radical polymerizable functional group. Another example is a monomer having three or more radical polymerizable functional group with no electron transport structure unlike condensed polycyclic quinone, diphenoquinone, or an electron withdrawing aromatic ring having a cyano group or a nitro group.

As the radical polymerizable functional groups, acryloyloxy group and methacryloyloxy group are preferable. A compound having at least three acryloyloxy groups is obtained by conducting ester reaction or ester conversion reaction using, for example, a compound having at least three hydroxyl groups therein and an acrylic acid (salt), a halide acrylate, and an ester of acrylate.

A compound having at least three methacryloyloxy groups is obtained in the same manner.

In addition, the radical polymerizable functional groups in a monomer having at least three radical polymerizable functional groups can be the same or different from each other.

In the present disclosure, if at least one of the radical polymerizable monomers having three or more functional groups with no charge transport structure described above is a compound having a radical polymerizable functional group equivalent of 300 or greater, the electric properties of the image bearing member is good, which is preferable.

The radical polymerizable compound having a charge transport structure, which is described later, has m electron having a diffusion in a molecule, which is suitable for charge transport. For this reason, a compound having relatively large molecular weight is preferable. The functional group equivalent of a radical polymerizable monomer having three or more functional groups that forms a three dimensional network structure being small means a structure having many cross-linking points and small meshes. The radical polymerizable compound having a charge transport structure having a relatively large molecular weight that is present in the cross-linked layer has small sterical freedom, which makes distortion in the conformation. That is, the diffusion π electron inherently has is shredded, which is considered to cause degradation of the charge transport power of the compound. As a result of the investigation made by the present inventors, it was found that the electric properties of an image bearing member was significantly improved by using a compound having a functional group equivalent of 300 or more as at least one of the radical polymerizable monomer having three or more functional groups as compared with a case in which no compound having a functional group equivalent of 300 or more is contained.

There is no specific limit to the radical polymerizable monomer having three ore more functional groups with no charge transport structure. Specific examples thereof include, but are not limited to, trimethylol propane triacrylate (TMPTA), trimethylol propane trimethacrylate, EO modified trimethylol propane triacrylate, PO modified trimethylol propane triacrylate, caprolactone modified trimethylol propane triacrylate, HPA modified trimethylol propane triacrylate, pentaerythritol triacrylate, pentaerythritol tetra acrylate (PETTA), glycerol triacrylate, ECH modified glycerol triacrylate, EO modified glycerol triacrylate, PO modified glycerol triacrylate, tris(acryloxyrthyl) isocyanulate, dipenta erythritol hexacrylate (DPHA), caprolactone modified dipenta erythritol hexacrylate, dipenta erythritol hydroxyl dipenta acrylate, alkylized dipenta erythritol tetracrylate, alkylized dipenta erythritol triacrylate, dimethylol propane tetracrylate (DTMPTA), penta erythritol ethoxy tetracrylate, EO modified phosphoric acid triacrylate, and 2,2,5,5-tetrahydroxy methyl cyclopentanone tetracrylate. These can be used alone or in combination. It is preferable that at least one of the monomers has a functional group equivalent of 300 or more.

EO modified and PO modified represent ethyleneoxy modified and propyleneocy modified, respectively.

Specific examples of the radical polymerizable monomer having three ore more functional groups with no charge transport structure having a functional group equivalent of 300 or more are as follows but they are not limited thereto.

TABLE 5

| | | Functional |
|---|---|---|
| | | group |
| | | Equivalent |
| No. III-1 | 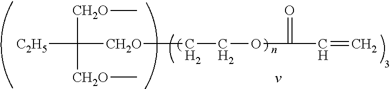 v = 3 × 20 | 407 |
| No. III-2 | 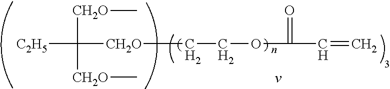 v = 5 | 319 |
| No. III-3 | 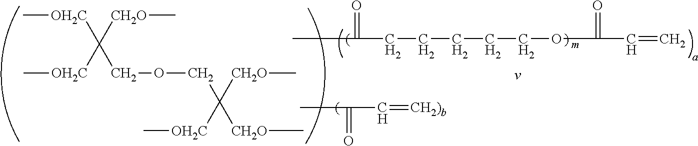 v = 2 a = 6 b = 0 | 325 |

In addition, the radical polymerizable monomer having three or more functional groups with no charge transport structure preferably has a functional group equivalent of 250 or less. Namely, it is more preferable to use a mixture of a monomer having a functional group equivalent of 300 or more and a monomer having a functional group equivalent of 250 or less. Without a monomer having a functional group equivalent of 250 or less, the abrasion resistance of an image bearing member may deteriorate.

The content of the radical polymerizable monomer having three or more functional groups with no charge transport structure in the sub-surface layer ranges from 20% by weight to 80% by weight and preferably from 35% by weight to 65% by weight. When the content of the radical polymerizable monomer having three or more functional groups with no charge transport structure is 20% by weight or more, abrasion resistance is sufficient. When the content of the radical polymerizable monomer having three or more functional groups with no charge transport structure is 80% by weight or less, the content of the radical polymerizable compound having one functional group with a charge transport structure in the sub-surface layer is sufficient, thereby not degrading electrostatic property.

The radical polymerizable compound (monomer) having a charge transport structure includes a hole carrier structure such as triaryl amine, hydrazone, pyrazoline, or carbazole or an electron transport structure such as condensed polycyclic quinone, diphenoquinone, and an aromatic ring having an electron withdrawing group such as a cyano group or a nitro group. The radical polymerizable group is the same as contained in the adical polymerizable compound having three or more functional groups with no charge transportability and preferably an acyloyloxy group or a methacyloyloxy group.

The radical polymerizable compound having a charge transport structure preferably has a monofunctional structure having a single radical polymerizable functional group in terms of electrostatic property. Furthermore, having a triaryl amine structure is preferable. A more preferable example of the compounds is as follows:

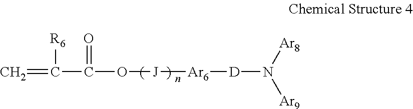

In the Chemical structure 4, R₆ represents a hydrogen atom, a halogen group, a substituted or non-substituted alkyl group, a substituted or non-substituted aralky group, a substituted or non-substituted aryl group, a cyano group, a nitro group, an alkoxy group, —COOR₁₅ (wherein R₁₅ represents a hydrogen atom, a substituted or non-substituted alkyl group, a substituted or non-substituted aralkyl group, or a substituted or non-substituted aryl group), a halogenated carbonyl group or CONR₁₉R₂₁ (wherein R₁₉ and R₂₁ independently represent hydrogen atoms, halogen groups, substituted or non-substituted alkyl groups, substituted or non-substituted aralkyl groups, or substituted or non-substituted aryl groups. Ar₆ represents a substituted or non-substituted divalent aromatic group. Ar₈ and Ar₉ independently represent monofunctional aromatic groups, D represents a single bond or -G-Ar₄— (wherein G represents a single bond, a substituted or non-substituted alkylene group, a substituted or non-substituted cycloalkylene group, a substituted or non-substituted alkyleneoxy group, an oxy group, a thio group, or a vinylene group. Ar₄ is a substituted or non-substituted divalent aromatic group). J represents a substituted or non-substituted alkylene group, a substituted or non-substituted alkyleneoxy group, or an alkyleneoxy carbonyl group. n represents 0 or an integer of from 1 to 3.

The alkyl group of R₆ is, for example, a methyl group, an ethyl group, a propyl group, and a butyl group. The aralkyl group R₆ is, for example, a benzyl group, a phenethyl group, and a naphtyl methyl group. The aryl group of R₆ is, for example, a phenyl group and a naphtyl group. The alkoxy group thereof is, for example, methoxy group, ethoxy group and propoxy group.

Specific examples of the substitution group of R₆ include, but are not limited to, a halogen group, a nitro group, a cyano group, an alkyl group such as a methyl group and an ethyl group, an alkoxy group such as a methoxy group and an ethoxy group, an aryloxy group such as a phenoxy group, an aryl group such as a phenyl group and a naphtyl group, and an aralkyl group such as a benzyl group and a phenethyl group. R₆ preferably a hydrogen atom or a methyl group.

Specific examples of the monofunctional aromatic group of Ar₈ and Ar₉ include, but are not limited to, condensed monofunctional polycyclic hydrocarbon groups, non-condensed monofunctional ring hydrocarbon groups, and a monofunctional heterocyclic groups.

Specific examples of the condensed monofunctional polycyclic hydrocarbon groups include, but are not limited to, a pentanyl group, an indenyl group, a naphtyl group, an azulenyl group, a heptalenyl group, a biphenylenyl group, an as-indacenyl group, an s-indacenyl group, a fluorenyl group, an acenaphtylenyl group, a pleiadenyl group, an acenaphtenyl group, a phenalenyl group, a phenanthryl group, an anthryl group, a fluorantenyl group, an acephenantrirenyl group, an aceantrirenyl group, a triphenylene group, a pyrenyl group, a chrysenyl group, and a naphthacenyl group. The condensed monofunctional polycyclic hydrocarbon group preferably has a ring having 18 or less carbon atoms.

Specific examples of the non-condensed monofunctional cyclic hydrocarbon groups include, but are not limited to, a group derived from a monocyclic hydrocarbon compound such as benzene, diphenyl ether, polyethylene diphenyl ether, diphenylthio ether, and diphenylsulfon, a group derived from a non-condensed polycyclic hydrocarbon compound such as biphenyl, polyphenyl, diphenyl alkane, diphenyl alkene, diphenyl alkyne, triphenyl methane, distyryl benzene, 1,1-diphenyl cycloalkane, polyphenyl alkane, and polyphenyl alkene, and a group derived from a ring aggregated hydrocarbon compound such as 9,9-diphenyl fluorene.

Specific examples of the heterocyclic groups include, but are not limited to, a group derived from a heterocyclic aromatic compound such as carbazol, dibenzofuran, dibenzothiophene, oxadiazole, and thiadiazole.

Specific examples of the substitution groups of Ar₈ and Ar₉ are as follows:
1. Halogen atom, Cyano group, and Nitro group;
2. Alkyl Group

The number of carbon atoms of the clkyl group is from 1 to 12, preferably from 1 to 8, and more preferably from 1 to 4. The alkyl group can be substituted by a fluoro group, a hydroxy group, a cyano group, an alkoxy group having one to four carbon atoms, a phenyl group, or a halogen group, or a phenyl group substituted by an alkyl group having one to four carbon atoms or an alkoxy group having one to four carbon atoms.

Specific examples thereof include, but are not limited to, a methyl group, an ethyl group, an n-butyl group, an isopropyl group, a t-butyl group, an s-butyl group, an n-propyl group, a trifluoromethyl group, 2-hydroxy ethyl group, 2-ethoxyethyl group, 2-cyanoethyl group, 2-methoxyethyl group, benzyl group, 4-chlorobenzyl group, 4-methyl benzyl group, and 4-phenyl benzyl group;

3 Alkoxy Group

The alkyl group in the alkoxy group is the same as the alkyl group in 2.

Specific examples of alkoxy group include, but are not limited to, a methoxy group, an ethoxy group, an n-propoxy group, an isopropoxy group, a t-butoxy group, an n-butoxy group, an s-butoxy group, an isobutoxy group, 2-hydroxy ethoxy group, a benzyloxy group, and a trifluoromethoxy group;

4. Aryloxy Group

Specific examples of the aryl group of the aryloxy group include, but are not limited to, a phenyl group and a naphtyl group. The aryloxy group can be substituted by an alkoxy group having one to four carbon atoms, an alkyl group having one to four carbon atoms, or a halogen group.

Specific examples of the aryloxy group include, but are not limited to, phenoxy group, 1-naphtyloxy group, 2-naphtyloxy group, 4-methoxyphenoxy group, and 4-methylphenoxy group;

5. Alkyl Mercapto Group or Aryl mercapto Group

Specific examples of the alkylmercapto group include, but are not limited to, methylthio group and ethylthio group. Specific examples of the aryl mercapto group include, but are not limited to, phenylthio group and p-methylphenylthio group;

6 Substituted or Non-Substituted Amino Group

The substituted or non-substituted amino group is represented as NR₇R₁₆, where R₇ and R₁₆ each, independently represent hydrogen atoms or alklyl groups or aryl groups specified in 2 and R₇ and R₁₆ can share a ring.

Specific examples of the aryl group of R₇ and R₁₆ include, but are not limited to, a phenyl group, a biphenyl group, and a naphtyl group. The aryl group can be substituted by an alkoxy group having one to four carbon atoms, an alkyl group having one to four carbon atoms, or a halogen group.

Specific examples of the substituted or non-substituted amino group include, but are not limited to, an amino group, a diethyl amino group, an N-methyl-N-phenyl amino group, an N,N-diphenyl amino group, an N,N-ditolyl amino group, a dibenzyl amino group, a piperidino group, a morpholino group, and a pyrrolidino group;

7. Alkylenedioxy Group or Alkylene Dithio Group

A specific example of alkylenedioxy group is a methylene dioxy group. A specific example of alkylenedithop group is a methylene dithio group.

8. Others

Specific examples of the other groups include, but are not limited to, a substituted or non-substituted styryl group, a substituted or non-substituted β-phenyl styryl group, diphenyl aminophenyl group, and a ditolyl aminophenyl group.

A specific example of the divalent aromatic group of Ar₆ and Ar₄ is a group derived from the monofunctional aromatic group of Ar₈ and Ar₉.

The number of the carbon atoms in the alkylene group in G is from 1 to 12, preferably from 1 to 8, and more preferably from 1 to 4. The alkylene group can be substituted by a fluoro group, a hydroxy group, a cyano group, an alkoxy group having one to four carbon atoms, a phenyl group, or a halogen group, or a phenyl group substituted by an alkyl group having one to four carbon atoms or an alkoxy group having one to four carbon atoms.

Specific examples thereof include, but are note limited to, methylene group, ethylene group, n-butylene group, i-propylene group, t-butylene group, s-butylene group, n-propylene group, trifluoromethylene group, 2-hydroxy ethylene group, 2-ethoxyethylene group, 2-cyanoethylene group, 2-methoxyethylene group, benzylidene group, phenyl ethylene group, 4-chlorophenyl ethylene group, 4-methylpheny ethylene group, and 4-biphenyl ethylene group.

The number of the carbon atoms in the cycloalkylene group in G is from 5 to 7. The cycloalkylene group can be substituted by a fluoro group, a hydroxy group, an alkyl group having one to four carbon atoms, or an alkoxy group having one to four carbon atoms.

Specific examples of the cycloalkylene group include, but are not limited to, a cyclohexylidene group, a cyclohexylene group, and a 3,3-dimethyl cyclohexylidene group.

Specific examples of the alkyleneoxy group in Y include, but are not limited to, —CH₂CH₂O—, —CH₂CH₂CH₂O—, —(OCH₂CH₂)_{w}O — (where w represents an integer of from 1 to 4), and —(OCH₂CH₂CH₂)ₗO— (where l represents an integer of from 1 to 4).

This alkyleneoxy group can be substituted by a substitution group such as a hydroxyl group, a methyl group, or an ethyl group.

Specific examples of vinylene group of Y include, but are not limited to, —(C(R₈)═CH)_{d}— (where R₈ represents a hydrogen atom, the same alkyl group as described in 2, the same divalent aromatic group as described in Ar₈ and Arₐ, and n represents 1 or 2), —C(R₁₇)═CH—(CH═CH)ᵤ, (where R₁₇ represents a hydrogen atom, the same alkyl group as described in 2, the same divalent aromatic group as described in Ar₈ and Ar₉, and m represents an integer of from 1 to 3).

The alkylene group of J is the same as the alkylene group of G. The alkyleneoxy group of J is the same as the alkyleneoxy group of G.

A specific example of the alkyleneoxy carbonyl group of J is a caprolactone modified group.

The radical polymerizable compound having one functional group with a charge transport structure is preferably the compound represented by the following chemical structure 5. In addition, R₁₈ and R₂₀ each, independently methyl groups or ethyl groups.

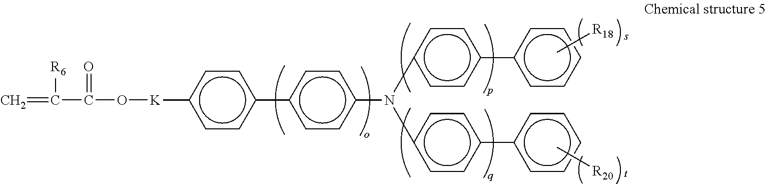

In the chemical structure 5, o, p, and q each, independently represent 0 or 1, s and t each, independently represent 0 or integers of from 1 to 3, R₉ represents a hydrogen atom or a methyl group, R₁₈ and R₂₀ each, independently represent a substituted or non-substituted alkyl group having 1 to 6 carbon atoms, and Z represents a single bond, a methylene group, an ethylene group, —CH₂CH₂O—, —CH₃CHCH₂O—, or —C₆H₄—CH₂CH₂—.

Preferably, R₁₈ and R₂₀ each, independently represent methyl groups or ethyl groups.

The content of the radical polymerizable monomer having a single functional group with a charge transport structure in the sub-surface layer ranges from 20% by weight to 80% by weight and preferably from 35% by weight to 65% by weight. When the content of the radical polymerizable monomer having a single functional group with a charge transport structure is 20% by weight or more, electrostatic property is sufficient. When the content of the radical polymerizable monomer having a single functional group with a charge transport structure is 80% by weight or less, the content of the radical polymerizable compound having three or more functional groups with no charge transport structure in the sub-surface layer is sufficient, thereby not degrading abrasion resistance.

The sub-surface layer optionally contains a radical polymerizable compound having two functional groups with no charge transport structure and/or a radical polymerizable oligomer.

Specific examples of the radical polymerizable compound having two functional groups include, but are not limited to, 1,3-butane diol acrylate, 1,4-butane diol acrylate, 1,4-butane diol dimethacrylate, 1,6-hexane diol diacrylate, 1,6-hexane diol dimethaacrylate, diethylene glycol diacrylate, neopentyl glycol diacrylate, bisphenol A-EO modified diacrylate, bisphenol F-EO modified diacrylate, and neopentyl glycol diacrylate.

Specific examples of the radical polymerizable oligomers include, but are not limited to, an epoxy acrylate based oligomer, a urethane acrylate based oligomer, and a polyester acrylate based oligomer.

The content of the radical polymerizable compound having two functional groups with no charge transport structure and the radical polymerizable oligomer is 50% by weight or less and preferably 30% by weight or less to the radical polymerizable compound having three or more functional groups with no charge transport structure in terms of abrasion resistance.

A polymerization initiator can be used to make cross-linking for the sub-surface layer of the present disclosure.

Specific examples of the thermal polymerization initiators include, but are not limited to, a peroxide based initiator such as 2,5-dimethyl hexane-2,5-dihydroperoxide, dicumyl peroxide, benzoyl peroxide, t-butylcumyl peroxide, 2,5-dimethyl-2,5-di(peroxybenzoyl)hexine-3, di-t-butyl beroxide, t-butylhydro beroxide, cumenehydro beroxide, and lauroyl peroxide, and an azo based initiator such as azobis isobutyl nitrile, azobis cyalohexane carbonitrile, azobis iso methyl butyric acid, azobis isobutyl amidine hydrochloride, and 4,4′-azobis-4-cyano valeric acid. These can be used alone or in combination.

Specific examples of the photopolymerization initiators include, but are not limited to, acetophenon based or ketal based photopolymerization initiators such as diethoxy acetophenone, 2,2-dimethoxy-1,2-diphenyl ethane-1-on, 1-hydroxy-cyclohexyl-phenyl-ketone, 4-(2-hydroxyethoxy)phenyl-(2-hydroxy-2-propyl)ketone, 2-benzyl-2-dimethylamino-1-(4-morpholinophenyl)butanone-1,2-hydroxy-2-methyl-1-phenyl propane-1-on, and 1-phenyl-1,2-propane dion-2-(o-ethoxycarbonyl)oxime; benzoine ether based photopolymerization initiators such as benzoine, benzoine methyl ether, benzoine ethyl ether, benzoine isobutyl ether, and benzoine isopropyl ether; benzophenone based photopolymerization initiators such as benzophenone, 4-hydroxy benzophenone, o-benzoyl methyl benzoate, 2-benzoyl naphthalene, 4-benzoyl biphenyl, 4-benzoyl phenyl ether, acrylized benzophenone, and 1,4-benzoyl benzene; and thioxanthone based photopolymerization initiators such as 2-isopropyl thioxanthone, 2-chlorothioxanthone, 2,4-dimethyl thioxanthone, 2,4-diethyl thioxanthone, and 2,4-dichloro thioxanthone.

Specific other examples of the photopolymerization initiators include, but are not limited to, ethyl anthraquinone, 2,4,6-trimethyl benzoyl diphenyl phosphine oxide, 2,4,6-trimethyl benzoyl phenyl ethoxy phosphine oxide, bis(2,4,6-trimethyl benzoyl)phenyl phosphine oxide, bis(2,4-dimethoxybenzoyl)-2,4,4-trimethyl pentyl phosphine oxide, a methylphenyl glyoxy ester, 9,10-phenanthrene, an acridine based compound, a triadine based compound, and an imidazole based compound.

In addition, a compound having an acceleration effect on photopolymerization can be used alone or in combination with a photopolymerization initiator to conduct cross-linking of the sub-surface layer of the present disclosure.

Specific examples of such a compound having an acceleration effect on photopolymerization include, but are not limited to, triethanol amine, methyl diethanol amine, 4-dimethyl amino ethyl benzoate, 4-dimethyl amino isoamyl benzoate, ethyl benzoate (2-dimethyl amino), and 4,4′-dimethyl amino benzophenone.

The content of the polymerization initiator ranges from 0.5% by weight to 40% by weight and preferably from 1% by weight to 20% by weight to the total amount of the compound having a radical polymerizable functional group.

The sub-surface layer of the present disclosure can be formed by applying a liquid application containing the radical polymerizable compound. The liquid application optionally contains a plasticizer, a leveling agent, and a charge transport compound.

Specific examples of the plasticizers include, but are not limited to, dibutylphthalate and dioctyl phthalate.

The content of the plasticizer is 20% by weight or less and preferably 10% by weight or less to the solid portion of a liquid application.

Specific examples of the leveling agent include, but are not limited to, silicone oils such as dimethyl silicone oil and methyl phenyl silicone oil and polymers or oligomers containing a perfluoroalkyl group in their side chain.

The content of the leveling agent is 3% by weight or less to the solid portion of a liquid application.

The liquid application may contain a solvent.

Specific examples of such solvents include, but are not limited to, alcohols such as methanol, ethanol, propanol, and butanol; ketones such as acetone, methyl ethyl ketone, methyl isobutyl ketone, and cycle hexanone; esters such as ethyl acetate and butyl acetate; ethers such as tetrahydrofuranm dioxane and propyl ether; halogen based solvents such as dichloromethane, dichloroethane, trichloroethane, and chlorobenzene; aromatic series based solvents such as benzene, toluene, and xylene; and cellosolve based solvents such as methyl cellosolve, ethyl cellosove, and cellosolve acetate. These can be used alone or in combination.

In addition, the sub-surface layer preferably contains filler particulates. In addition, by blending the filler, the abrasion resistance of the sub-surface layer is further improved, which is furthermore advantageous to the sustainability of the surface form. In addition, since fine concavoconvex portions are provided to the surface of a sub-surface layer, the circulating efficiency of a circulating material is easily improved.

By blending the filler, a soft-feel texture (film) is formed on the surface of the image bearing member, which is suitable to improve the texture effect described above.

Organic fillers and inorganic fillers can be used as the filler. There is no specific limit to the material that forms an organic filler. Specific examples thereof include, but are not limited to, a fluorine-containing resin such as polytetrafluoroethylene and a silicone resin. These can be used alone or in combination.

Specific examples of inorganic fillers include, but are not limited to, powder of metal such as copper, tin, aluminum and indium, metal oxides such as tin oxide, zinc oxide, titanium oxide, indium oxide, antimony oxide, and bismuth oxide, and inorganic material such as potassium titanate.

Inorganic fillers are preferable in terms of hardness. Metal oxides are preferable to form fillers in terms of electrostatic property. Silicon oxide, aluminum oxide, and titanium oxide are preferable in particular. Colloidal silica and colloidal aluminum are preferably used as an inorganic filler.

The average primary particle diameter of the filler is preferably from 0.01 μm to 0.5 μm. When the layer thickness is too thin, the charging property tends to deteriorate. When the layer thickness is too thick, the sensitivity may deteriorate.

The content of the filler in the sub-surface layer is from 5% by weight to 50% by weight and preferably from 5% by weight to 30% by weight. When the content of the filler in the sub-surface layer is 5% by weight or more, abrasion resistance is sufficient. When the content thereof is 30% by weight or less, the electrostatic property of an image bearing member or the optical transmittance of the sub-surface layer is not worsened.

The filler can be surface-treated by a surface treating agent such as a dispersant. There is no specific limit to the surface treating agent. Specific examples thereof include, but are not limited to, titanate coupling agents, aluminum coupling agents, zircoaluminate coupling agents, higher aliphatic acids, aluminum oxide, titanium dioxide, zirconium dioxide, silicone resins, aluminum sterate, organic acid ester-based dispersant, and phosphoric acid ester-based dispersant. These can be used alone or in combination. Titanate coupling agents, aluminum coupling agents, zircoaluminate coupling agents, higher aliphatic acids, organic acid ester-based dispersant, and phosphoric acid ester-based dispersant can be used in combination with silane coupling agents.

Of these, the phosphoric acid ester-based dispersant, as described above, improves the stability of the dispersed filler in a liquid application, reduces the size of the filler, and imparts the affinity with the binder resin, which is particularly preferable.

The content surface-treated by a surface treating agent is from 3% by weight to 30% by weight and preferably from 5% by weight to 10% by weight to filler. When the content surface-treated by a surface treating agent is 3% by weight or more, the dispersability of the filler in a sub-surface layer ameliorates. When the content surface-treated by a surface treating agent is 30% by weight or less, the electrosatatic property of an image bearing member does not deteriorate.

The dispersing solvent to prepare a liquid application of sub-surface layer preferably dissolves a monomer sufficiently. Specific examples thereof include, but are not limited to, ethers, aromatic compounds, halogens, and esters, cellosolves such as ethoxyethanol and propylene glycols such as 1-methoxy-2-propanol. Of these, methylethyl ketone, tetrahydrofuran, cyclohexanone, and 1-methoxy-2-propanol are preferable because these are less burden to the environment than chlorobenzene, dichlorormethane, toluene, and xylene. These solvents can be used alone or as a mixture thereof.

For example, when a triaryl amine-based donor serving as a charge transport material and a polycarbonate serving as a binder resin are used in a charge transport layer provided under the sub-surface layer and the sub-surface layer is formed by a spray-coating method, it is preferable to use teterahydrofuran, 2-butanone, or ethyl acetate as the solvent for the liquid application. The content of the solvent is 3 times to 10 times as much as the total weight of the acrylate compound.

The liquid application of the sub-surface layer can be applied by methods such as a dip coating method, a spray coating method, a ring coating method, a roll coater method, a gravure coating method, a nozzle coating method, and a screen printing method. In many cases, the liquid application does not have a long pot life so that methods using small but sufficient amounts of liquid applications are advantageous in terms of the burden on the environment and cost. Among these, the spray coating method and the ring coating methods are preferable. Furthermore, ink jet systems are suitable to impart a particular form of the present disclosure.

In the present disclosure, to form a sub-surface layer having a charge transportability, it is preferable to initiate polymerization upon application of active energy lines such as ultraviolet ray or electron beams to form a cross-linked layer containing a cured material.

This is preferable to polymerization reaction by heating using a thermal polymerization initiator, etc. to form a hard layer having a high cross-linking density with a large elastic power, which is preferable to secure the abrasion resistance of the present disclosure. However, since compared with heat, the energy level of active energy lines is high, excitation of the charge transport structure may occur.

To avoid such decomposition of materials by exposure to active energy lines, the oxygen concentration is reduced in nitrogen atmosphere or cooling is conducted to prevent rises of temperatures upon irradiation of active energy lines. In the present disclosure, the sub-surface layer is cross-linked in such conditions. Ultraviolet rays can be conducted by using a UV irradiation light source such as a high pressure mercury lamp and a metal halide lamp.

The irradiation amount is preferably from 50 mW/cm² to 1,000 mW/cm². When the irradiation amount is 50 mW/cm² or higher, it does not take a long time to conduct curing reaction. When the irradiation amount is 1,000 mW/cm² or lower, heat is not accumulated excessively or temperature rise is not controlled, resulting in deformation during cooling down. Degradation of electric properties does not become uncontrollable.

The thus-cured and manufactured cross-linked surface layer is preferably insoluble in an organic solvent. A film that is not sufficiently cured is soluble in an organic solvent and has a thin cross-linking density, which leads to insufficient mechanical strength.

Next, for example, the liquid of application prepared as described above is applied and dried by finger touch with, for example, a spray, to laminate an undercoating layer, a charge generating layer, and a charge transport layer on a latent image bearing member in this sequence followed by curing by exposure to light.

In the case of UV ray irradiation, a metal halide lamp, etc. is used with a preferable illuminance of from 50 mW/cm² to 1,000 mW/cm². For example, when a UV ray of 700 mW/cm² is used, the drum is rotated for curing exposing all the surface to light evenly for about three minutes. The surface temperature is controlled not to be extremely high by using a thermal medium, etc.

After completion of curing, the resultant is heated in a range of from 100° C. to 150° C. for 10 minutes to 30 minutes to reduce the residual organic solvent before a latent image bearing member of the present invention is obtained.

The cross-linked surface layer of the present invention preferably has a thickness of from 1 μm to 30 μm, more preferably from 2 μm to 20 μm, and furthermore preferably from 3 μm to 10 μm.

When the surface layer is 1 μm or thicker, the durability of the surface of a latent electrostatic image bearing member is secured because the thickness of the sub-surface layer is sufficient when carrier attaches to and dents in the surface. To the contrary, when the surface layer is 30 μm or thinner, problems such as a rise in the residual voltage do not arise. That is, it is preferable to form a sub-surface layer having a suitable thickness by which an allowance for abrasion and scar is secured and a residual voltage is reduced.

Next, methods of forming a sub-surface layer by exposure to electron beams is described.

Electron irradiation obviates addition of a photopolymerization initiator. For this reason, a three-dimensional cross-linked surface layer is formed by dissolving a radical polymerizable charge transport compound or a mixture of a radical polymerizable monomer therewith in a suitable solvent and applying the solution to a charge transport layer followed by exposure to electron beams. For example, JP-2004-212959-A discloses cross-linking conditions for these and known technologies are applicable. For example, it is preferable that the accelerated voltage of electron beams is 250 kV or less, the irradiation amount is from 1 Mrad to 20 Mrad, and the oxygen concentration upon irradiation is 10,000 ppm or less.

The active energy line in the present disclosure includes radioactive rays (alpha beam, beta beam, gamma beam, X-ray, accelerated ion beam) etc. in addition to the ultraviolet ray and electron beam (accelerated electron beam) mentioned above. Mainly, ultraviolet rays and electron beams are used for industrial application.

Photosensitive Layer

Next, the laminate type photosensitive layer and the single layer type photosensitive layer that form the latent image bearing member for use in the present invention are described.

Laminate Type Photosensitive Layer

The laminate type photosensitive layer has a structure in which a charge generating layer (CGL) and a charge transport layer (CTL) are typically laminated on a substrate in this order.

Charge Generating Layer

The charge generating layer contains at least a charge generating material and other optional materials such as a binder resin.

There is no specific limit to the selection of the charge generating material. Either one of an inorganic material and an organic material is suitably used.

There is no specific limit to the selection of the inorganic materials. Specific examples thereof include, but are not limited to, crystal selenium, amorphous-selenium, selenium-tellurium, selenium-tellurium-halogen, and selenium-arsenic compounds.

There is no specific limit to the selection of the organic materials. Specific examples thereof include, but are not limited to, phthalocyanine pigments, for example, metal phthalocyanine and metal-free phthalocyanine; azulenium salt pigments; squaric acid methine pigments; azo pigments having a carbazole skeleton; azo pigments having a triphenylamine skeleton; azo pigments having a diphenylamine skeleton; azo pigments having a dibenzothiophene skeleton; azo pigments having a fluorenone skeleton; azo pigments having an oxadiazole skeleton; azo pigments having a bis-stilbene skeleton; azo pigments having a distilyloxadiazole skeleton; azo pigments having a distylylcarbazole skeleton; perylene pigments, anthraquinone or polycyclic quinone pigments; quinoneimine pigments; diphenylmethane and triphenylmethane pigments; benzoquinone and naphthoquinone pigments; cyanine and azomethine pigments, indigoid pigments, and bis-benzimidazole pigments. These can be used alone or in combination.

There is no specific limit to the selection of the binder resin for use in the charge generating layer. Specific examples of the binder resin include, but are not limited to, polyamides, polyurethanes, epoxy resins, polyketones, polycarbonates, silicone resins, acrylic resins, polyvinylbutyrals, polyvinylformals, polyvinylketones, polystyrenes, poly-N-vinylcarbazoles, and polyacrylamides. These can be used alone or in combination.

A charge transport material can be optionally added. In addition, other than the binder resins mentioned above, a charge transport polymer can be also added.

Specific examples of the methods of forming the charge generating layer include, but are not limited to, vacuum thin layer forming methods and casting methods from a solution dispersion system.

In the vacuum thin layer forming methods, for example, there are glow discharging polymerization methods, vacuum deposition methods, chemical vacuum deposition (CVD) methods, sputtering methods, reactive sputtering methods, ion plating methods and accelerated ion injection methods. In these vacuum thin layer forming methods, the inorganic based materials and the organic based materials specified above can be suitably used.

To form a charge generating layer by the casting method, it is possible to use a typical method such as a dip coating method, a spray coating method and a beat coating method.

Specific examples of organic solvents for use in forming a liquid application for a charge generating layer include acetone, methyl ethylketone, methyl itopropylketone, cyclohexanone, benzene, toluene, xylene, chloroform, dichloromethane, dichloroethane, dichloropropane, trichloroethane, trichloroethylene, tetrachloroethane, tetrahydrofuran, dioxolane, dioxane, methanol, ethanol, isopropylalcohol, butanol, ethyl acetate, butyl acetate, dimethyl sulfoxide, methyl cellosolve, ethyl cellosolve, and propyl cellosolve. These can be used alone or in combination.

Among these, tetrahydrofuran, methyl ethylketone, dichloromethane, methanol and ethanol, which have a boiling point of from 40° C. to 80° C., are particularly preferred because drying after their coating is easy.

The liquid application for forming a charge generating layer is prepared by dispersing and dissolving the charge generating material and the binder resin in the organic solvent. As a method of dispersing an organic pigment in an organic solvent, there are a dispersion method using a dispersion medium such as a ball mill, a bead mill, a sand mill, and a vibration mill, and a high speed liquid collision dispersion method.

The electrophotographic characteristics, especially photosensitivity, vary depending on the thickness of the charge generating layer. In general, as a layer thickens, the photosensitivity thereof becomes high. Therefore, it is preferred to design the layer thickness of the charge generating layer in a suitable range according to the specification of a desired image forming apparatus. To obtain sensitivity suitable for an image bearing member, the layer thickness thereof is preferably from 0.01 μm to 5 μm and more preferably from 0.05 μm to 2 μm.

Charge Transport Layer

The charge transport layer is part of a laminate type photosensitive layer in charge of infusing and transporting the charges produced in the charge generating layer and neutralizing the surface charge (charge transport power) of the image bearing member.

The charge transport layer is mainly formed of a charge transport component and a binder component to bind the charge transport component.

As such a charge transport material, a low molecular weight charge transport material and a charge transport polymer can be used.

It does not matter whether the abrasion resistance of the charge transport layer is low because the image bearing member for use in the present disclosure has a structure in which a sub-surface layer is laminated on the charge transport layer. In addition, to achieve the objective of holding charges, the electric resistance is required to be high. Furthermore, in order to obtain a high surface voltage by the held charges, a small dielectric constant and good charge mobility are suitable for the charge transport layer.

The charge transport layer is mainly formed of a charge transport material and a binder resin. Charge transport materials such as hole carrier materials and electron transport materials having low molecular weights are used and charge transport polymers are optionally added thereto.

Specific examples of the hole carrier materials (electron donating materials) include oxazole derivatives, oxadiazole derivatives, imidazole derivatives, triphenyl amine derivatives, 9-(p-diethylaminostyryl anthracene), 1,1-bis-(4-dibenzyl aminophenyl)propane, styrylanthracene, slyrylpyrazoline, phenylhydrazones, α-phenylstilbene derivatives, thiazole derivatives, triazole derivatives, phenazine derivatives, acridine derivatives, benzfuran derivatives, benzimidazole derivatives and thiophen derivatives. These can be used alone or in combination.

Specific examples of the charge transport polymers include compounds having the following structure.

### (a) Polymer Having Carbazole Ring

Specific examples include, but are not limited to, poly-N-vinylcarbazole, and the compounds described in JP-S54-9632-A, JP-S54-11737-A, JP-H04-175337-A, JP-H04-183719-A, and JP-H06-234841-A.

### (b) Polymer Having Hydrazone Structure

Specific examples include, but are not limited to, the polymers described in JP-S57-78402-A, JP-S61-20953-A, JP-S61-296358-A, JP-H01-134456-A, JP-H01-179164-A, JP-H03-180851-A, JP-H03-180852-A, JP-H03-50555-A, JP-H05-310904-A, and JP-H06-234840-A.

### (c) Polysilylene Polymer

Specific examples include, but are not limited to, polymers described in JP-S63-285552-A, JP-H01-88461-A, JP-H04-264130-A, JP-H04-264131-A, JP-H04-264132-A, JP-H04-264133-A, and JP-H04-289867-A.

### (d) Polymer Having Triarylamine Structure

Specific examples include, but are not limited to, N,N,bis(4-methylphenyl)-4-aminopolystyrene, polymers described in JP-H01-134457-A, JP-H02-282264-A, JP-H02-304456-A, JP-H04-133065-A, JP-H04-133066-A, JP-H05-40350-A, and JP-H05-202135-A.

### (e) Other Polymers

Specific examples include, but are not limited to, a condensation polymerized formaldehyde compound of nitropropylene, and polymers described in JP-S51-73888, JP-S56-150749-A, JP-H06-234836, and JP-H06-234837.

In addition, there are other examples of the charge transport polymers, which are, for example, polycarbonate resins having a triaryl amine structure, polyurethane resins having a triaryl amine structure, polyester resins having a triaryl amine structure and polyether resins having a triaryl amine structure. Specific examples thereof include, but are not limited to, polymers described in JP-S64-1728-A, JP-S64-13061-A, JP-S64-19049-A, JP-H04-11627-A, JP-H04-225014-A, JP-H04-230767-A, JP-H04-320420-A, JP-H05-232727-A, JP-H07-56374-A, JP-H09-127713-A, JP-H09-222740-A, JP-H09-265197-A, JP-H09-211877-A, and JP-H09-304956-A.

Other than the polymers specified above, copolymers, block polymers, graft polymers, and star polymers with a known monomer, and cross-linked polymers having the electron donating groups described in JP-H03-109406-A can be used as the polymers having an electron donating group.

In addition, known electron carrying materials can be used in the charge transport layer. Specific examples thereof include, but are not limited to, trinitrofluorenone, fluorene-based compounds such as fluorenylidene methane derivatives, diphenoquinone, and quinone compounds such as anthraquinone derivatives. These can be used alone or in combination.

Specific examples of the binder resins for use in the charge transport layer include, but are not limited to, polycarbonate resins, polyester resins, methacryl resins, acrylic resins, polyethylene resins, polyvinyl chloride resins, polyvinyl acetate resins, polystyrene resins, phenol resins, epoxy resins, polyurethane resins, polyvinylidene chloride resins, alkyd resins, silicone resins, polyvinyl carbazole resins, polyvinyl butyral resins, polyvinyl formal resins, polyacrylate resins, polyacrylic amide resins, and phenoxy resins. These can be used alone or in combination.

The charge transport layer can also contain a copolymer of a cross-linkable binder resin and a cross-linkable charge transport material.

The charge transport layer can be formed by dissolving or dispersing these charge transport materials and the binder resins in a suitable solvent followed by coating and drying. In addition to the charge transport material and the cinder resin, the charge transport layer can optionally contain additives such as a plasticizing agent, an anti-oxidizing agent, and a leveling agent in a suitable amount if desired.

The layer thickness of the charge transport layer preferably ranges from 5 μm to 100 μm. The layer thickness of a charge transport layer has been thinned to satisfy the demand for improving the quality of images in recent years. It is preferred that the charge transport layer has a thickness that ranges from 5 μm to 30 μm for a high definition of 1,200 dots per inch (dpi) or higher.

Single Layered Photosensitive Layer

The single layer photosensitive layer mentioned above contains a charge generating material, a charge transport material, a binder resin, and other optional components. Similar to the charge transport layer described above, it does not matter whether the abrasion resistance of the charge transport layer is low because the image bearing member for use in the present disclosure has a structure in which a sub-surface layer is laminated on a single layered photosensitive layer.

The single-layered photosensitive layer preferably has a thickness of from 5 μm to 100 μm and more preferably from 5 μm to 50 μm. When the layer thickness is too thin, the charging property thereof tends to deteriorate. When the layer thickness is too thick, the sensitivity thereof may deteriorate.

Substrate

There is no specific limit to the selection of materials for use in the electroconductive substrate which have a volume resistance of not greater than 10×10¹⁰ Ω·cm. For example, there can be used plastic or paper having a film-like form or cylindrical form covered with a metal such as aluminum, nickel, chrome, nichrome, copper, gold, silver, and platinum, or a metal oxide such as tin oxide and indium oxide by depositing or sputtering.

Also a board formed of aluminum, an aluminum alloy, nickel, and a stainless metal can be used. Moreover, a tube which is manufactured from the board mentioned above by a crafting technique such as extruding and extracting and surface-treatment such as cutting, super finishing, and grinding is also usable. In addition, an endless nickel belt and an endless stainless belt described in JP-S52-36016-A can be used as the electroconductive substrate. Furthermore, nickel foil having a thickness of from 50 μm to 150 μm is also usable. Alternatively, polyethylene terephthalate film having an electroconductively treated surface such as aluminum deposition with a thickness of from 50 μm to 150 μm is also usable.

An electroconductive substrate having an electroconductive layer formed by applying to the substrate mentioned above a liquid application in which electroconductive powder is dispersed in a suitable binder resin is suitable as the electroconductive substrate for use in the present disclosure.

Specific examples of such electroconductive powder include, but are not limited to, carbon black, acetylene black, metal powder, such as powder of aluminum, nickel, iron, nichrome, copper, zinc and silver, and metal oxide powder, such as electroconductive tin oxide powder and ITO powder. Specific examples of the binder resin used simultaneously include, but are not limited to, polystyrene resins, copolymers of styrene and acrylonitrile, copolymers of styrene and butadiene, copolymers of styrene and maleic anhydrate, polyesters resins, polyvinyl chloride resins, copolymers of a vinyl chloride and a vinyl acetate, polyvinyl acetate resins, polyvinylidene chloride resins, polyarylate resins, phenoxy resins, polycarbonate reins, cellulose acetate resins, ethyl cellulose resins, polyvinyl butyral resins, polyvinyl formal resins, polyvinyl toluene resins, poly-N-vinylcarbozole, acrylic resins, silicone resins, epoxy resins, melamine resins, urethane resins, phenolic resins, and alkyd resins.

Such an electroconductive layer can be formed by dispersing the electroconductive powder and the binder resins mentioned above in a suitable solvent, for example, tetrahydrofuran (THF), dichloromethane (MDC), methyl ethyl ketone (MEK), and toluene and applying the resultant to an electroconductive substrate.

In addition, an electroconductive substrate formed by providing a heat contraction tube as an electroconductive layer on a suitable cylindrical substrate can be used as the electroconductive substrate in the present disclosure. The heat contraction tube is formed of material such as polyvinyl chloride, polypropylene, polyester, polystyrene, polyvinylidene chloride, polyethylene, chloride rubber, and TEFLON®, which includes the electroconductive powder mentioned above.

Undercoating Layer

An undercoating layer can be optionally provided between the substrate and the photosensitive layer. The undercoating layer is provided to improve the adhesive property, prevent the occurrence of moiré, improve the coating property of a layer provided thereon, reduce the residual voltage, etc.

Typically, such an undercoating layer is mainly made of a resin. Considering that a photosensitive layer is applied to such an undercoating layer (i.e., resin) in a form of solvent, the resin is preferably hardly soluble in a known organic solvent. Specific examples of such resins include, but are not limited to, water-soluble resins such as polyvinyl alcohol, casein and sodium polyacrylate, alcohol-soluble resins such as copolymerized nylon, and methoxymethylated nylon, curing resins forming three-dimensional structure such as polyurethane, melamine resins, alkyd-melamine resins and epoxy resins.

In addition, fine powder of metal oxides such as titanium oxide, silica, alumina, zirconium oxide, tin oxide, and indium oxide, metal sulfides, and metal nitrides can be optionally added. Such an undercoating layer can be formed by a typical method using a suitable solvent.

An undercoating layer can be formed by anodizing a metal oxide layer of Al₂O₃ formed by a sol-gel process, etc. or by coating organic compounds such as a polyparaxylyene (parylene) or an inorganic compound such as SnO₂, TiO₂, ITO, and CeO₂ using a silane coupling agent, a titanium coupling agent, and a chromium coupling agent by a vacuum thin layer forming method.

There is no specific limit to the thickness of the undercoating layer. The undercoating layer preferably has a thickness of from 0.1 μm to 10 μm and more preferably from 0.1 μm to 5 μm.

Furthermore, in the image bearing member, an anti-oxidizing agent can be added to each layer, i.e., the photosensitive layer, the sub-surface layer, the charge generating layer, the charge transport layer, and the undercoating layer to improve the environmental resistance, in particular, to prevent the degradation of sensitivity and the rise in residual potential.

Configuration of Image Forming Apparatus

Next, the image forming apparatus for use in the present disclosure is described in detail with reference to the accompanying drawings. A device to apply the circulating material described later to the surface of the image bearing member is provided to the image forming apparatus of the present disclosure. To be simple, this device is described after the description of the image forming apparatus.

FIG. 1 is a schematic diagram illustrating an example of the image forming apparatus and the following variations are within the scope of the present disclosure.

In FIG. 1, an image bearing member 11 is a photoreceptor in which a sub-surface layer is laminated. Although the image bearing member 11 has a drum-like form, it may employ a sheet form or an endless belt form.

The charger 12 is a device to uniformly charge the surface of the image bearing member 11. Any known device such as a corotron, scorotoron, a solid state charger, and a charging roller can be used as the charger 12. In terms of reducing the power consumption, the charger is suitably provided in contact with or in the vicinity of an image bearing member. Among these, to prevent contamination of the charger, it is suitable to arrange a charging mechanism in the vicinity of the image bearing member having a suitable gap between the image bearing member and the surface of the charger is suitable.

Typically, the chargers described above can be generally used as the transfer device 16. A combinational use of the transfer charger and the separation charger is preferable.

Typical illumination devices, for example, a fluorescent lamp, a tungsten lamp, a halogen lamp, a mercury lamp, a sodium lamp, a light emitting diode (LED), a semiconductor laser (LD), and an electroluminescence (EL) can be used as the light source for the irradiator 13 or the discharging lamp 1A illustrated in other embodiments. Variety of optical filters, for example, a sharp cut filter, a band-pass filter, a near infrared filter, a dichroic filter, a coherent filter, and a color conversion filter, can be used in combination with these light sources to irradiate the image bearing member with beams of light having only a desired wavelength.

A toner 15 transferred to the image bearing member 11 by the development device 14 is transferred to a recording medium 18 such as printing paper or a transparent sheet (for slide) but not all the toner 15 is transferred and part thereof remains on the image bearing member 11. Such residual toner is removed from the image bearing member 11 by the cleaner 17. Brushes such as a rubber cleaning blade, a fur brush, a magfur brush can be used as the cleaner 17.

When the image bearing member 11 is positively (or negatively) charged by the charger 12 and irradiated according to image data by the irradiator 13, a positive (or negative) latent electrostatic image is formed on the surface of the image bearing member 11. When the latent electrostatic image is developed with a negatively (or positively) charged toner (volt-detecting fine particles), a positive image is formed by the development device 14. When the latent electrostatic image is developed using a positively (or negatively) charged toner, a negative image is formed by the development device 14. Any known method can be applied to such a development device and also a discharging device. The toner image developed on the recording medium 18 is transferred from the position opposing the image bearing member 11 and the transfer device 16 to a fixing device 19 where the toner image is fixed on the recording medium 18.

A circulating material 3A and an application blade 3C to apply the circulating material 3A are arranged between the cleaner 17 and the charger 12 as illustrated in FIG. 1 relative to the moving direction of the photo receptor 11.

That is, the circulating material 3A and the application blade 3C are arranged downstream from the cleaner 17 and upstream from the charger 12 relative to the moving direction of the image bearing member 11. The positional relation is the same in the following embodiments.

FIG. 2 is a diagram illustrating an another example of the electrophotographic process in the present disclosure. In FIG. 2, the image bearing member 11 is a photoreceptor in which a sub-surface layer is laminated. Although the image bearing member 11 has a belt-like form, it may employ a drum-like form, a sheet-like form, or an endless belt-like form. The image bearing member 11 is driven by a driving device 1C, charged by the charger 12, and irradiated by the irradiator 13 to form a latent electrostatic image. The latent electrostatic image is developed and transferred by the transfer device 16. The image bearing member 11 is irradiated before cleaning by a pre-cleaning irradiator 1B, cleaned by the cleaner 17, and discharged by the discharging lamp 1A. This is repeated each time an image is formed.

A circulating material 3A and an application blade 3C to apply the circulating material 3A are arranged between the cleaner 17 and the charger 12 as illustrated in FIG. 1 relative to the moving direction of the photo receptor 11. In FIG. 2, the pre-cleaning irradiation is conducted from the supporting member side of the image bearing member 11 (the supporting member is translucent).

These elecrophotography processes are for the illustrated purpose only for the embodiments in the present disclosure and not limited thereto. For example, in FIG. 2, the pre-cleaning irradiation is conducted from the supporting member side. However, the pre-cleaning irradiation can be conducted from the photosensitive layer side. In addition, image irradiation and discharging irradiation can be conducted from the supporting member side. Although image irradiation, pre-cleaning irradiation, and discharging irradiation are illustrated as the light irradiation processes, other irradiation processes such as pre-transfer irradiation process, pre-image irradiation process, and other known irradiation processes can be provided to irradiate the image bearing member 11.

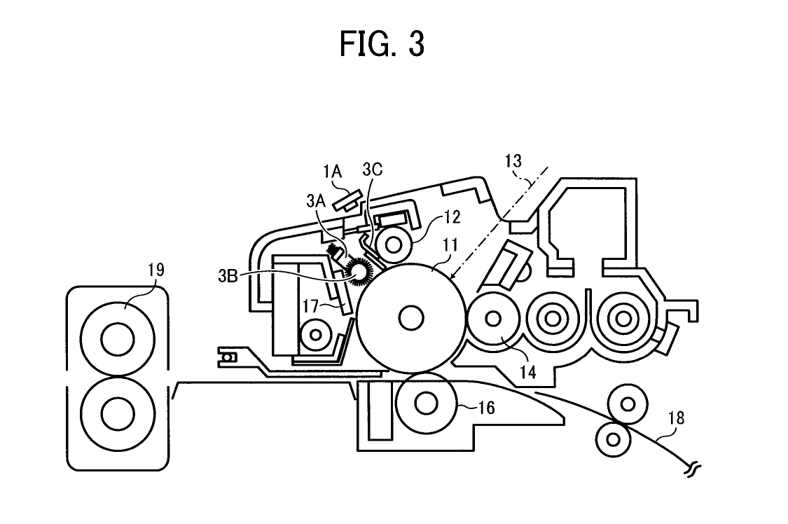

Although the image forming device as described above can be assembled into a photocopier, a facsimile machine, or a printer in a fixed manner, each image forming element can be incorporated into such an apparatus in a form of a process cartridge. There is no specific limit to the form of the process cartridge but a typical form thereof is as illustrated in FIG. 3. Although the image bearing member 11 has a drum-like form, it may employ a sheet-like form or an endless belt-like form. A reference numeral 19 represents a fixing device.

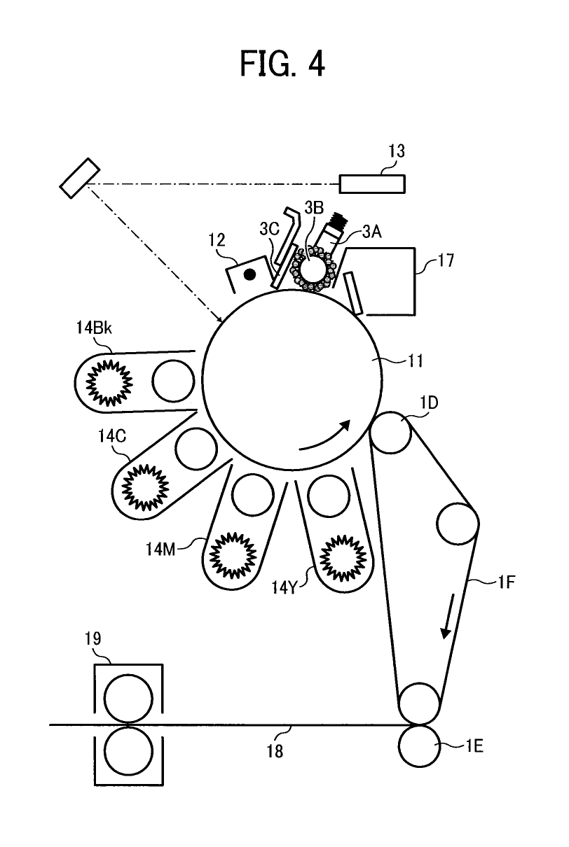

FIG. 4 is a diagram illustrating another example of the image forming apparatus of the present disclosure. In the image forming apparatus, there are provided around the image bearing member 11 the charger 12, the irradiator 13, development devices 14Bk, 14C, 14M, and 14Y) for each color of black (Bk), cyan (C), magenta (M), and yellow (Y), an intermediate transfer belt 1F serving as an intermediate transfer body, and the cleaner 17 sequentially. The symbols of Bk, C, M, and Y illustrated in FIG. 4 correspond to the color of toner. These symbols are attached or omitted on the necessity basis. The image bearing member 11 is a photoreceptor in which the sub-surface layer is laminated. The development devices (14Bk, 14C, 14M, and 14Y) for respective colors are independently controlled and only the development devices for the colors for use in image forming are driven. The toner image formed on the image bearing member 11 is transferred to the intermediate transfer belt 1F by a first transfer device 1D arranged inside the intermediate transfer belt 1F. The first transfer device 1D is arranged in such a manner that it is brought into contact with or separated from the image bearing member 11 and the intermediate transfer belt 1F is brought into contact with the image bearing member 11 only during transfer process. Each color image is formed sequentially and is overlapped on the intermediate transfer belt 1F to obtain an overlapped toner image. The overlapped toner image is transferred once from a second transfer device 1E to the recording medium 18 and thereafter fixed thereon by the fixing device 19 to form an image. The second transfer device 1E is also arranged in such a manner that it is brought into contact with or separated from the intermediate transfer belt 1F. The second transfer device 1E is in contact with the intermediate transfer belt 1F only during transfer operation.

In the image forming apparatus employing a transfer drum system, images cannot be printed on thick paper because each color toner image is sequentially transferred to a recording medium electrostatically attached to a transfer drum. On the other hand, in the image forming apparatus employing the intermediate transfer system as illustrated in FIG. 4, there is no specific limit with regard to the selection of the recording media because each color toner image is overlapped on the intermediate transfer belt 1F. Such an intermediate transfer system can be applied not only to the device as illustrated in FIG. 4 but also to the devices illustrated in FIGS. 1, 2, 3, and 5 (which is described later with a specific example illustrated in FIG. 6).

A circulating material 3A and an application blade 3C to apply the circulating material 3A are arranged between the cleaner 11 and the charger 12 as illustrated in FIG. 1 relative to the moving direction of the photo receptor 11.

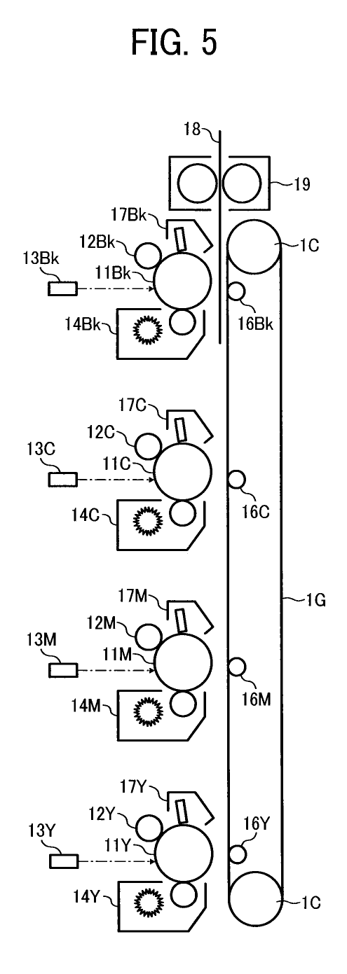

FIG. 5 is a diagram illustrating another example of the image forming apparatus of the present disclosure. This image forming apparatus is a type using toner of four colors of yellow (Y), magenta (M), cyan (C), and black (Bk) and includes the image forming unit for each color. Furthermore, the image bearing members (11Y, 11M, 11C, and 11Bk) are provided for each color. The sub-surface layer is laminated in the image bearing member 11 for use in this image forming apparatus. Around each of the image bearing members 11 (11Y, 11M, 11C, and 11Bk), there are provided the charger 12 (12Y, 12M, 12C, and 12Bk), the irradiator 13 (13Y, 13M, 13C, and 13Bk), the development device 14 (14Y, 14M, 14C, and 14Bk), the cleaner 17 (17Y, 17M, 17C, and 17Bk) etc. In addition, a transfer belt 1G serving as a transfer material bearing member which is configured to be in contact with or separated away from each transfer position of the image bearing members (11Y, 11M, 11C, and 11Bk) arranged in a straight line is suspended over driving devices 1C. The transfer devices 16Y, 16M, 16C, and 16Bk are provided at the transfer position opposing the image bearing members 11Y, 11M, 11C, and 11Bk with the transfer belt 1G therebetween. The circulating material 3A and the application blade 3C to apply the circulating material 3A are arranged between the cleaner 17 and the charger 12 relative to the moving direction of the image bearing member 11.

The image forming apparatus employing a tandem system as illustrated in FIG. 5 has the image bearing members 11Y, 11M, 11C, and 11Bk for respective colors and each color toner image is sequentially transferred to the recording medium 18 borne on the transfer belt 1G. Therefore, in comparison with a full color image forming apparatus having only a single image bearing member, the image forming apparatus employing a tandem system outputs full color images at an extremely high speed. The toner image developed on the recording medium 18 as a transfer medium is transferred from the position opposing the image bearing member 11Bk and the transfer device 16Bk to the fixing device 19 where the toner image is fixed on the recording medium 18.

In addition to the embodiment illustrated in FIG. 5, another embodiment as illustrated in FIG. 6 is also suitable.

That is, instead of the direct transfer system using the transfer belt 1G illustrated in FIG. 5, another configuration using the intermediate transfer belt 1F illustrated in FIG. 6 is suitable.

In the embodiment illustrated in FIG. 6, the image bearing members 11Y, 11M, 11C, and 11Bk are provided for respective colors. Each color toner image formed thereon is sequentially transferred to and laminated on the intermediate transfer belt 1F driven by and suspended over driving devices 1C by a primary transfer device 1D to form a full color toner image. Next, the intermediate transfer belt 1F is furthermore driven and the full color toner image borne thereon is transferred to the position between a secondary transfer device 1E and the roller 1C arranged opposing the secondary transfer device 1E. The toner image is secondarily transferred to the recording medium 18 by the secondary transfer device 1E to form a desired image.

Supply of Circulating Material

As illustrated in FIG. 9, as a circulating material supplier to supply the circulating material 3A to the surface of the image bearing member, a circulating material supplier 3 is provided to all of the image forming apparatuses described above. The circulating material supplier 3 has the fur brush 3B as an applicator, the circulating material 3A, a pressing spring to press the circulating material to the direction of the fur brush 3B, and the application blade 3C to apply the circulating material 3A and regulate the thickness thereof. The circulating material 3A is a circulating material molded to have a bar form. The fur brush 3B is in contact with the surface of the image bearing member, scoops up the circulating material 3A temporarily by rotating around the axis, and bears, transfers, and applies it to the contact position with the surface of the image bearing member.

In addition, when the circulating material 3A is scraped by the fur brush 3B, thereby shrinking the circulating material 3A, the pressing spring presses the circulating material 3A toward the fur brush 3B with a predetermined pressure in order to keep the circulating material 3A in contact with the fur brush 3B. Therefore, the fur brush 3B constantly and uniformly scoops up even a minute amount of the circulating material 3A.

In addition, it is suitable to provide a circulating material supplier to coat the circulating material to the surface of the image bearing member. This device presses a board like a cleaning blade against the image bearing member in a trailing or counter manner.

Specific examples of the circulating material 3A include, but are not limited to, metal salts of aliphatic acid such as lead oleate, zinc oleate, copper oleate, zinc stearate, cobalt stearate, iron stearate, copper stearate, zinc plamitate, copper palmitate, and zinc linolenate, and fluorine-containing resins such as polytetrafluoroethylene, polychlorotrifluoroethylene, polyvinilidene fluoroide, polytrifluorochloroethylene, dichlorodifluoroethylene, copolymers of tetrafluoroethylene and ethylene, and copolymers of tetrafluoroethylene and oxafluoropropylene. The material taking a lamellar structure is excellent in circulation efficiency and furthermore, zinc stearate is advantageous in terms of cost.

Having generally described preferred embodiments of this invention, further understanding can be obtained by reference to certain specific examples, which are provided herein for the purpose of illustration only and are not intended to be limiting. In the descriptions in the following examples, the numbers in parts represent weight ratios in parts unless otherwise specified.

### EXAMPLES

The present invention is described in detail with reference to the Examples but not limited to the following Examples.

Next, the present disclosure is described in detail with reference to Examples but not limited thereto.

### Example 1

### Manufacturing of Image Forming Apparatus

Manufacturing of Image Bearing Member

The liquid application of the undercoating layer having the following recipe, the liquid application of the charge generating layer having the following recipe, and the liquid application of the charge transport layer having the following recipe were sequentially applied to an aluminum drum having a thickness of 1.5 mm, a length of 380 mm, and an outer diameter φ of 100 mm followed by drying to form an undercoating layer having a thickness of 3.5 μm, a charge generating layer having a thickness of 0.2 μm, and a charge transport layer having a thickness of 25 μm. A liquid application of the sub-surface layer was applied thereto by spray coating. In the spray coating, a spray gun (PC-WIDE 308, manufactured by Olympos Co., Ltd.) was used with an atomization pressure of 2.1 kgf/cm² with a distance of 50 mm away from the image bearing member. The discharging amount was about 3 cc. Thereafter, the resultant was placed in a UV irradiation booth in which air was replaced with nitrogen air such that the oxygen density is 2% or less and irradiated with light under the following conditions (metal halide lamp: 160 W/cm, Irradiation distance: 120 mm, Irradiation intensity: 700 mW/cm², Irradiation time: 120 seconds) followed by drying at 130° C. for 20 minutes to form a sub-surface layer having a layer thickness of 3.5 μm. The image bearing member (photoreceptor) of the present disclosure was thus-obtained.

The liquid application of the sub-surface layer is prepared as follows:

100 g of YTZ ball (manufactured by Nikkato Corporation) having a φ of 2 mm was preliminarily placed in a 50 ml bottle of mayonnaise (UM sample bottle). 2 g of α-alumina (SUMICORUNDUM® AA-03, manufactured by Sumitomo Chemical Co., Ltd.: average primary particle diameter: 0.3 μm) and 10.8 g of a mixture of a dispersant and a solvent (THF) were added followed by dispersion for two hours at a vibration intensity of 1,600 rpm by a vibration shaker (ICA A.G) to obtain a mill base. A vehicle was added to the thus-obtained mill base to obtain a liquid application.

Unless otherwise mentioned, the liquid application of the sub-surface layer was prepared in the same manner in the following Examples and Comparative Examples.

Liquid Application for Sub-surface Layer
Alkyd resin (Beckolite M6401-50, manufactured by Dainippon Ink and Chemicals, Inc.): 12 parts
Melamine resin (Super-beckamine G-821-60, manufactured by Dainippon Ink and Chemicals, Inc.): 8.0 parts
Titanium oxide (CR-EL, manufactured by ISHIHARA SANGYO KAISHA, LTD): 40 parts
Methylethylketone: 200 parts
   Liquid Application for Charge Generating Layer
Bisazo pigment (manufactured by Ricoh Co., Ltd.) represented by the following chemical structure: 5.0 parts

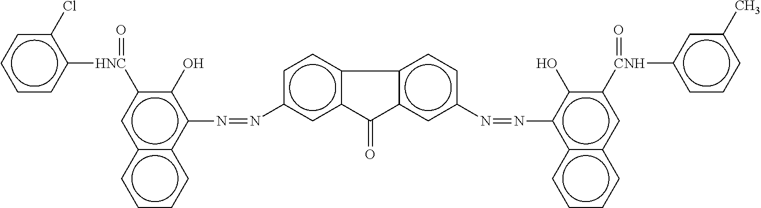

Polyvinyl butyral {XYHL, manufactured by Union Carbide Corporation (UCC)}: 1.0 part
Cyclohexanone: 200 parts
Methylethylketone: 80 parts
   Liquid Application for Charge Transport Layer
Z type polycarbonate (PanLite TS-2050, manufactured by Teijin Chemicals Ltd.): 10 parts
Charge Transport Material represented by the following chemical structure: 7.0 parts

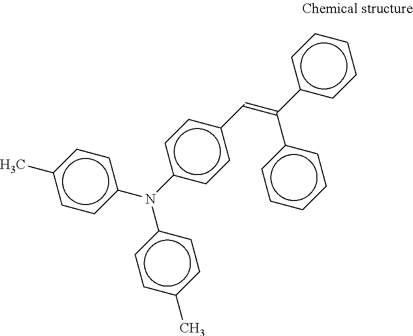

Tetrahydrofuran: 100 parts
1% Silicone oil (KF50-100CS, manufactured by Shin-Etsu Chemical Co., Ltd.): 1 part
   Liquid Application for Sub-surface Layer
Radical polymerizable compound having the following charge transport structure: 43 parts

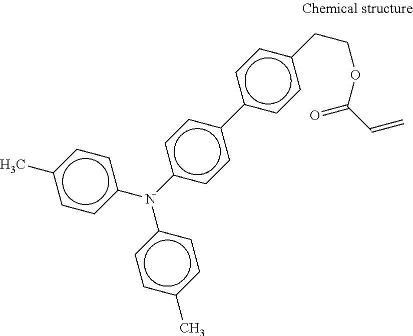

Trimethylol propane triacrylate (KAYARAD TMPTA, manufactured by Nippon Kayaku Co., Ltd.): 21 parts
Caprolactone modified dipentaerythritol hexaacrylate (DPCA-120, manufactured by Nippon Kayaku Co., Ltd.): 21 parts
Oxazole compound II-1 illustrated above: 2 parts
Mixture (BYK-UV3570, manufactured by BYK Chemie Japan) of acylic group containing polyester modified polydimethyl siloxane and propoxy-modified-2-neopentyl glycol diacrylate: 0.1 parts
1-hydroxy-cyclohexy-phenyl ketone (IRGACURE 184, manufactured by Chiba Specialty Chemicals)}: 4 parts
α-alumina (SUMICORUNDUM AA-03, manufactured by Sumitomo Chemical Co., Ltd.): 10 parts
Dispersant (ED-151, manufactured by Kusumoto Chemicals, Ltd.): 1.0 part
Tetrahydrofuran: 566 parts

Circulating Material

Zinc stearate (GF200, manufactured by NOF CORPORATION) was placed in a glass container with a lid followed by melting while being stirred by a hot stirrer in which the temperature was controlled from 160° C. to 250° C.

The stirred and melted protective agent was poured into an aluminum die having an inside dimension of 12 mm0020×8 mm×350 mm preliminarily heated to 150° C. to fill the die. Subsequent to cooling down to 40° C. on a wood board, the solid material was removed from the die followed by cooling down to room temperature while a weight was put thereon to prevent it from warping.

After cooling down, both ends of the solid material in the longitudinal direction were severed and the base was cut to obtain a protective bar having a rectangular column-like form having an dimension of 6 mm×6 mm×322 mm.

Double-faced adhesive tape was attached to the bottom of the protective agent bar to fix it to a metal support.

Circulating Material Applicator

The circulating material applicator was attached to the image forming apparatus together with a device to supply the circulating material to the image bearing member and a device to apply the supplied circulating material to the image bearing member.

A device to supply the circulating material was attached to press the application brush by a pressing spring. The pressing spring had a spring constant under which the solid zinc stearate molded to have a rectangular-form column to be held by a support was consumed in a predetermined amount. The device was to scrape zinc stearate by rotation of the application brush, thereby providing the scraped powder to the image bearing member.

The pressing spring was suitably selected considering the relation between the spring constant and the consumption amount of the circulating material. As a result, a spring was used which had a spring constant of 0.039 N/mm under the condition that the ratio of the consumption (meaning the decreasing amount of the circulating material, including the amount of loss ascribable to, for example, scattering and falling from the application brush in addition to the applied amount to the image bearing member) of the circulating material was 125 mg/km. Movable fins supported by a single point were provided to both sides of the support and the spring was provided therearound to adjust the contact pressure between the application brush and the circulating material by the pulling stress of the spring.

A proper product formed by attaching a fur brush to a metal shaft was used as it was

The application brush was set to rotate counterclockwise about the moving direction of the surface of the image bearing member.

The application blade was polyurethane rubber (ShoreA hardness: 84, impact resilience: 52%, thickness: 1.3 mm) supported by a blade holder of steel plate which contacted the image bearing member at an angle of 19° in the contact direction thereof.

The image bearing member and the circulating material supplier were installed on the cyan development station of imagio MP C4500 (manufactured by Ricoh Co., Ltd.) as illustrated in FIG. 8. The circulating material supplier was installed in the process cartridge of the image bearing member dedicated for imagio MP C4500 in place of the original circulating material applicator thereto.

Measuring and Evaluation

1. Measuring of Surface Form of Image Bearing Member

The surface form of the image bearing member was measured by a surface texture and contour measuring instrument (Surfcom 1400D, manufactured by Tokyo Seimitsu Co., Ltd.) under the condition that a pickup (E-DT-S02A) was attached, the measuring length was 12 mm, the number of total sampling was 30,720, and the measuring speed was 0.06 mm/s.

The single dimensional data arrangement of the surface form of the image bearing member obtained by the measuring were subject to wavelet conversion to conduct multi-resolution analysis (MRA-1) to be separated into six frequency components from HHH to HLL. The thus-obtained single dimensional data arrangement of HLL was thinned out in such a manner that the number of data arrangement was reduced to 1/40 to obtain a thinned-out single dimensional data arrangement. The thinned-out single dimensional data arrangement was further subject to wavelet conversion to conduct multi-resolution analysis (MRA-2) to be separated into the six frequency components from LHH to LLL. The arithmetical mean roughness was calculated for each of the thus-obtained 12 frequency components.

This measuring of the surface form was conducted at four places with a gap of 70 mm therebetween for a single image bearing member and the arithmetical mean roughness was calculated for each frequency component for each place.

Wavelet Toolbox of MATLAB (manufactured by The Matworks Inc.) was used as the wavelet conversion. As described above, the wavelet conversion was conducted on two separate occasions in the present disclosure.

The average of the arithmetical mean roughness of each frequency component at the four places was determined as the arithmetical mean roughness WRa of each frequency component of the measuring results.

Of these, the results of the arithmetical mean roughnesses of MHM, MHL, and HLH and the arithmetical mean roughness of LLH before and after a print test described later are shown in FIG. 6.

2. Image Evaluation

The image bearing member and the circulating material supplier were installed on the cyan development station of imagio MP C4500 (manufactured by Ricoh Co., Ltd.) as illustrated in FIG. 8. The circulating material supplier was installed in the process cartridge of the image bearing member dedicated for imagio MP C4500 in place of the original circulating material applicator thereto and an image bearing member through the print test was installed thereto. A halftone pattern having four dots×four dots in a matrix of eight×eight with a pixel density of 600 dpi×600 dpi and a blank image pattern were alternately and continuously printed one by one five times. The image density of the half tone pattern and the background fouling of the blank image pattern were evaluated according to the following criteria.

The print test was conducted for another image forming apparatus having the same configuration as specified above. In the print test, a pattern image in which bands having a width of 34 mm and a length of 210 mm and bands having a width of 34 mm and a length of 105 mm were arranged in parallel to the sheet passing direction was continuously printed with a run length of 100,000. The test was conducted at the cyan development station.

The results are shown in Table 7.

Criteria
5: Excellent
4: Good
3. Fair (no practical problem)
2. Slightly defective at a practically allowable level
1. Clearly defective at not-allowable level

3: Filming Evaluation

The surface of the image bearing member for use in the image evaluation was observed by a confocal microscope. The confocal microscope was OPTELICS H1200 (manufactured by Lasertec Corporation) and image data are collected by changing the magnification power of the objective lens to 10 times, 20 times, and 100 times. Among these, the area ratio of foreign object (filming) of the surface of the image bearing member distinguished by observation of □1.776 mm obtained by the objective lens with a magnifying power of 10 times was calculated by a command of “Analyze Particles” of an image analysis software (image J, produced by National Institutes of Health).

The results are shown in Table 7.

### Example 2

The image forming apparatus of Example 2 was manufactured in the same manner as in Example 1 except that zinc stearate used in the circulating material of Example 1 was changed to zinc oleate (manufactured by Kanto chemical Co., Inc.).

The obtained image forming apparatus was evaluated in the same manner as in Example 1. The results are shown in Tables 6 and 7.

### Example 3

The image forming apparatus of Example 3 was manufactured in the same manner as in Example 1 except that zinc stearate used in the circulating material of Example 1 was changed to a mixture of 8 parts of zinc oleate, 2 parts of boron nitride, and 1 part of alumina particulates (α-alumina, AA-03, average primary particle diameter: 0.3 μm, manufactured by Sumitomo Chemical Co., Ltd.). The obtained image forming apparatus was evaluated in the same manner as in Example 1. The results are shown in Tables 6 and 7.

### Example 4

The image forming apparatus of Example 4 was manufactured in the same manner as in Example 3 except that alumina particulates used in the circulating material of Example 3 was changed to silica particulates (KMPX 100, manufactured by Shin-Etsu Chemicals Co., Ltd.). The obtained image forming apparatus was evaluated in the same manner as in Example 1. The results are shown in Tables 6 and 7.

### Example 5

The image forming apparatus of Example 5 was manufactured in the same manner as in Example 1 except that α-alumina having an average primary particle diameter of 0.3 μm for use in the surface layer of the image bearing member of Example 1 was changed to α-alumina having an average primary particle diameter of 0.5 μm (AA-05, manufactured by Sumitomo Chemical Co., Ltd.). The obtained image forming apparatus was evaluated in the same manner as in Example 1. The results are shown in Tables 6 and 7.

### Example 6

The image forming apparatus of Example 6 was manufactured in the same manner as in Example 1 except that the liquid application of the sub-surface layer of the image bearing member was changed to the following liquid application. The obtained image forming apparatus was evaluated in the same manner as in Example 1. The results are shown in Tables 6 and 7.

Liquid Application for Sub-surface Layer
Radical polymerizable compound having the charge transport structure represented by the chemical structure: 43 parts

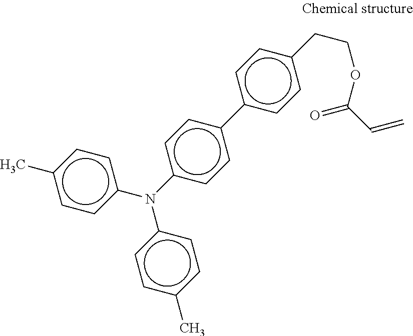

Trimethylol propane triacrylate (KAYARAD TMPTA, manufactured by Nippon Kayak Co., Ltd.): 21 parts
Caprolactone modified dipentaerythritol hexaacrylate (DPCA 120, manufactured by Nippon Kayaku Co., Ltd.): 21 parts
Oxazole compound II-1 illustrated above: 2 parts
Mixture (BYK-UV3570, manufactured by BYK Chemie Japan) of acylic group containing polyester modified polydimethyl siloxane and propoxy-modified-2-neopentyl glycol diacrylate: 0.1 parts
1-hydroxy-cyclohexy-phenyl ketone (IRGACURE 184, manufactured by Chiba Specialty Chemicals)}: 4 parts
α-alumina (SUMICORUNDUM AA-03, manufactured by Sumitomo Chemical Co., Ltd.): 9 parts
Dispersant (ED-151, manufactured by Kusumoto Chemicals, Ltd.) for α-alumina: 0.9 parts
Tin oxide (NanoTek, SnO₂, manufactured by C. I. Kasei Co., Ltd.): 1 part
Dispersant (ED-152, manufactured by Kusumoto Chemicals, Ltd.) for tin oxide: 0.1 parts
Tetrahydrofuran: 566 parts

### Example 7

The image forming apparatus of Example 7 was manufactured in the same manner as in Example 1 except that 1.0 part of the dispersant (ED-151, manufactured by Kusumoto Chemicals, Ltd.) of the liquid application of the sub-surface layer was changed to 0.35 parts of ED-151 and 0.65 parts of the dispersant (WK-13E, manufactured by Kyoeisha Chemical Co., Ltd.). The obtained image forming apparatus was evaluated in the same manner as in Example 1. The results are shown in Tables 6 and 7.

### Example 8

The image forming apparatus of Example 8 was manufactured in the same manner as in Example 1 except that 1.0 part of the dispersant (ED-151, manufactured by Kusumoto Chemicals, Ltd.) of the liquid application of the sub-surface layer was changed to 1 part of the dispersant (Superdyne V-201, manufactured by Takemoto Oil & Fat Co., Ltd.). The obtained image forming apparatus was evaluated in the same manner as in Example 1. The results are shown in Tables 6 and 7.

### Example 9

The image forming apparatus of Example 9 was manufactured in the same manner as in Example 1 except that the Illustrated compound No. II-4 was used in place of the illustrated compound No. II-1. The obtained image forming apparatus was evaluated in the same manner as in Example 1. The results are shown in Tables 6 and 7.

### Example 10

The image forming apparatus of Example 10 was manufactured in the same manner as in Example 1 except that the Illustrated compound No. II-6 was used in place of the illustrated compound No. II-1. The obtained image forming apparatus was evaluated in the same manner as in Example 1. The results are shown in Tables 6 and 7.

### Example 11

The image forming apparatus of Example 11 was manufactured in the same manner as in Example 1 except that the Illustrated compound No. II-7 was used in place of the illustrated compound No. II-1. The obtained image forming apparatus was evaluated in the same manner as in Example 1. The results are shown in Tables 6 and 7.

### Example 12

The image forming apparatus of Example 12 was manufactured in the same manner as in Example 1 except that the Illustrated compound No. II-10 was used in place of the illustrated compound No. II-1. The obtained image forming apparatus was evaluated in the same manner as in Example 1. The results are shown in Tables 6 and 7.

### Example 13

The image forming apparatus of Example 13 was manufactured in the same manner as in Example 1 except that the Illustrated compound No. II-12 was used in place of the illustrated compound No. II-1. The obtained image forming apparatus was evaluated in the same manner as in Example 1. The results are shown in Tables 6 and 7.

### Example 14

The image forming apparatus of Example 14 was manufactured in the same manner as in Example 1 except that the amount of the Illustrated compound No. II-1 was changed from 2 parts to 0.5 parts. The obtained image forming apparatus was evaluated in the same manner as in Example 1. The results are shown in Tables 6 and 7.

### Example 15

The image forming apparatus of Example 15 was manufactured in the same manner as in Example 1 except that the amount of the Illustrated compound No. II-1 was changed from 2 parts to 4 parts. The obtained image forming apparatus was evaluated in the same manner as in Example 1. The results are shown in Tables 6 and 7.

### Example 16

The image forming apparatus of Example 16 was manufactured in the same manner as in Example 1 except that α-alumina particulates used in the circulating material of Example 1 was changed to silica particulates (KMPX 100, manufactured by Shin-Etsu Chemicals Co., Ltd.). The obtained image forming apparatus was evaluated in the same manner as in Example 1. The results are shown in Tables 6 and 7.

### Example 17

The image forming apparatus of Example 17 was manufactured in the same manner as in Example 1 except that α-alumina particulates used in the circulating material of Example 1 was changed to titanium oxide particulates (CR-97, manufactured by Ishihara Sangyo Kaisha, Ltd.). The obtained image forming apparatus was evaluated in the same manner as in Example 1. The results are shown in Tables 6 and 7.

### Comparative Example 1

The image forming apparatus of Comparative Example 1 was manufactured in the same manner as in Example 1 except that α-alumina having an average primary particle diameter of 0.3 μm for use in the surface layer of the image bearing member of Example 1 was changed to α-alumina having an average primary particle diameter of 0.7 μm (AA-07, manufactured by Sumitomo Chemical Co., Ltd.). The obtained image forming apparatus was evaluated in the same manner as in Example 1. The results are shown in Tables 6 and 7.

### Comparative Example 2

The image forming apparatus of Comparative Example 2 was manufactured in the same manner as in Example 1 except that 1.0 part of the dispersant (ED-151, manufactured by Kusumoto Chemicals, Ltd.) of the liquid application of the sub-surface layer of the image bearing member of Example 1 was changed to 0.2 parts of the dispersant (BYK-P104, manufactured by BYK Chemie Japan). The obtained image forming apparatus was evaluated in the same manner as in Example 1. The results are shown in Tables 6 and 7.

### Comparative Example 3

The image forming apparatus of Comparative Example 3 was manufactured in the same manner as in Example 1 except that 1.0 part of the dispersant (ED-151, manufactured by Kusumoto Chemicals, Ltd.) of the liquid application of the sub-surface layer of the image bearing member of Example 1 was changed to 0.2 parts of the dispersant (DOPA33, manufactured by Kyoeisha Chemical Co., Ltd.). The obtained image forming apparatus was evaluated in the same manner as in Example 1. The results are shown in Tables 6 and 7.

### Comparative Example 4

The image forming apparatus of Comparative Example 4 was manufactured in the same manner as in Example 1 except that α-alumina and the dispersant were removed and the content of tetrahydrofuran was changed from 566 parts to 504 parts. The obtained image forming apparatus was evaluated in the same manner as in Example 1. The results are shown in Tables 6 and 7.

### Comparative Example 5

The image forming apparatus of Comparative Example 5 was manufactured in the same manner as in Example 5 except that the oxazole compound was removed and the content of tetrahydrofuran was changed from 566 parts to 504 parts. The obtained image forming apparatus was evaluated in the same manner as in Example 5. The results are shown in Tables 6 and 7.

### Comparative Example 6

The image forming apparatus of Comparative Example 6 was manufactured in the same manner as in Example 5 except that the oxazole compound was removed, the content of tetrahydrofuran was changed from 566 parts to 504 parts, and the UV irradiation time was changed to 240 seconds. The obtained image forming apparatus was evaluated in the same manner as in Example 5. The results are shown in Tables 6 and 7.

### Comparative Example 7

The image forming apparatus of Comparative Example 7 was manufactured in the same manner as in Example 5 except that the oxazole compound was removed, the content of tetrahydrofuran was changed from 566 parts to 504 parts, and the UV irradiation time was changed to 60 seconds. The obtained image forming apparatus was evaluated in the same manner as in Example 5. The results are shown in Tables 6 and 7.

### Comparative Example 8

The image forming apparatus of Comparative Example 8 was manufactured in the same manner as in Example 5 except that an ultraviolet absorbent (UV-1) having the following chemical structure was added instead of the oxazole compound. The obtained image forming apparatus was evaluated in the same manner as in Example 5. The results are shown in Tables 6 and 7.

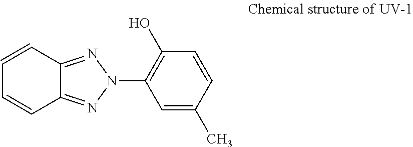 [SMILES: Cc1ccc(O)c(-n2nc3ccccc3n2)c1]

### Comparative Example 9

The image forming apparatus of Comparative Example 9 was manufactured in the same manner as in Example 5 except that an ultraviolet absorbent (UV-2) having the following chemical structure was added instead of the oxazole compound. The obtained image forming apparatus was evaluated in the same manner as in Example 5. The results are shown in Tables 6 and 7.

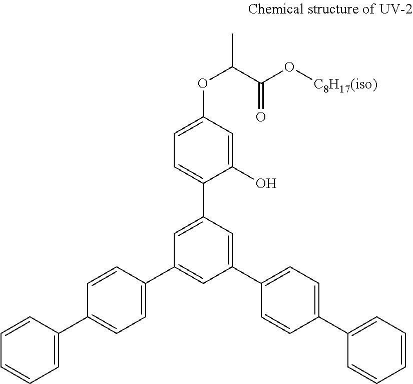

### Comparative Example 10

The image forming apparatus of Comparative Example 10 was manufactured in the same manner as in Example 5 except that an ultraviolet absorbent (Q-1) having the following chemical structure was added instead of the oxazole compound. The obtained image forming apparatus was evaluated in the same manner as in Example 5. The results are shown in Tables 6 and 7.

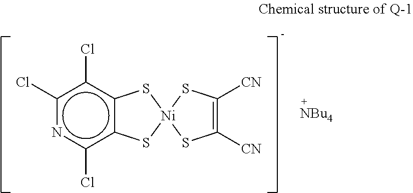

TABLE 6

| | WRa (μm) before test | | | | WRa (μm) after test | | | |
|---|---|---|---|---|---|---|---|---|
| | HMH | HML | HLH | LLH | HMH | HML | HLH | LLH |
| Example 1 | 0.002 | 0.003 | 0.003 | 0.027 | 0.004 | 0.005 | 0.005 | 0.035 |
| Example 2 | 0.002 | 0.003 | 0.003 | 0.026 | 0.004 | 0.004 | 0.005 | 0.041 |
| Example 3 | 0.002 | 0.003 | 0.003 | 0.026 | 0.004 | 0.004 | 0.005 | 0.038 |
| Example 4 | 0.002 | 0.003 | 0.003 | 0.027 | 0.004 | 0.004 | 0.005 | 0.046 |
| Example 5 | 0.002 | 0.003 | 0.004 | 0.031 | 0.003 | 0.004 | 0.005 | 0.044 |
| Example 6 | 0.002 | 0.002 | 0.004 | 0.032 | 0.003 | 0.004 | 0.004 | 0.042 |
| Example 7 | 0.002 | 0.002 | 0.002 | 0.033 | 0.004 | 0.005 | 0.005 | 0.047 |
| Example 8 | 0.002 | 0.003 | 0.003 | 0.040 | 0.003 | 0.004 | 0.005 | 0.046 |
| Example 9 | 0.002 | 0.003 | 0.003 | 0.029 | 0.003 | 0.004 | 0.004 | 0.036 |
| Example 10 | 0.002 | 0.003 | 0.003 | 0.028 | 0.004 | 0.004 | 0.005 | 0.038 |
| Example 11 | 0.002 | 0.003 | 0.003 | 0.028 | 0.003 | 0.004 | 0.004 | 0.06 |
| Example 12 | 0.002 | 0.003 | 0.003 | 0.029 | 0.003 | 0.003 | 0.004 | 0.039 |
| Example 13 | 0.002 | 0.003 | 0.003 | 0.029 | 0.003 | 0.003 | 0.004 | 0.036 |
| Example 14 | 0.002 | 0.003 | 0.003 | 0.028 | 0.004 | 0.005 | 0.004 | 0.037 |
| Example 15 | 0.002 | 0.003 | 0.003 | 0.028 | 0.004 | 0.005 | 0.004 | 0.041 |
| Example 16 | 0.002 | 0.003 | 0.002 | 0.025 | 0.004 | 0.005 | 0.004 | 0.046 |
| Example 17 | 0.00 | 0.003 | 0.003 | 0.027 | 0.004 | 0.005 | 0.004 | 0.048 |
| Comparative | 0.002 | 0.004 | 0.007 | 0.035 | 0.003 | 0.005 | 0.010 | 0.042 |
| Example 1 | | | | | | | | |
| Comparative | 0.002 | 0.002 | 0.004 | 0.092 | 0.004 | 0.004 | 0.004 | 0.123 |
| Example 2 | | | | | | | | |
| Comparative | 0.003 | 0.005 | 0.007 | 0.036 | 0.006 | 0.008 | 0.010 | 0.158 |
| Example 3 | | | | | | | | |
| Comparative | 0.002 | 0.001 | 0.001 | 0.041 | 0.004 | 0.006 | 0.005 | 0.175 |
| Example 4 | | | | | | | | |
| Comparative | 0.002 | 0.003 | 0.003 | 0.027 | 0.004 | 0.004 | 0.006 | 0.037 |
| Example 5 | | | | | | | | |
| Comparative | 0.002 | 0.003 | 0.003 | 0.025 | 0.005 | 0.005 | 0.006 | 0.035 |
| Example 6 | | | | | | | | |
| Comparative | 0.002 | 0.003 | 0.003 | 0.026 | 0.006 | 0.007 | 0.011 | 0.136 |
| Example 7 | | | | | | | | |
| Comparative | 0.002 | 0.003 | 0.003 | 0.028 | 0.004 | 0.004 | 0.004 | 0.038 |
| Example 8 | | | | | | | | |
| Comparative | 0.002 | 0.003 | 0.003 | 0.026 | 0.003 | 0.004 | 0.005 | 0.041 |
| Example 9 | | | | | | | | |
| Comparative | 0.002 | 0.003 | 0.003 | 0.025 | 0.004 | 0.005 | 0.005 | 0.039 |
| Example 10 | | | | | | | | |

TABLE 7

| | | Filming | |
|---|---|---|---|
| | Image | area | |
| | evaluation | (%) | Note |
| Example 1 | 4 | 1.2 | Good |
| Example 2 | 4 | 1.1 | Good |
| Example 3 | 5 | 0.4 | Particularly good |
| Example 4 | 5 | 0.6 | Particularly good |
| Example 5 | 4 | 1.6 | Good |
| Example 6 | 4 | 1.8 | Good |
| Example 7 | 5 | 0.5 | Particularly good |
| Example 8 | 5 | 0.6 | Particularly good |
| Example 9 | 4 | 1.2 | Good |
| Example 10 | 4 | 1.3 | Good |
| Example 11 | 4 | 1.1 | Good |
| Example 12 | 4 | 1.5 | Good |
| Example 13 | 4 | 1.4 | Good |
| Example 14 | 4 | 1.1 | Slightly low image |
| | | | density |
| Example 15 | 4 | 1.3 | Good |
| Example 16 | 4 | 1.6 | Slightly dot scattered |
| Example 17 | 4 | 1.5 | Slightly low image |
| | | | density |
| Comparative Example 1 | 2 | 8.2 | Background fouling |
| | | | with streaks locally |
| Comparative Example 2 | 2 | 7.8 | Uneven image density |
| | | | (streak) |
| Comparative Example 3 | 1 | 11.4 | Uneven image density |
| | | | (streak) |
| Comparative Example 4 | 2 | 8.8 | Background fouling |
| | | | with streaks locally |
| Comparative Example 5 | 2 | 1.1 | Low image density |
| Comparative Example 6 | 2 | 1.0 | Low image density |
| Comparative Example 7 | 2 | 6.8 | Background fouling |
| | | | with streaks locally |
| Comparative Example 8 | 2 | 1.2 | Low image density |
| Comparative Example 9 | 2 | 1.7 | Low image density |
| Comparative Example | 1 | 1.6 | Extremely low image |
| 10 | | | density |

The image forming apparatuses of Examples 1 to 17 maintained the quality level such that the surfaces of the image bearing members after a durability test were not distinguishable from that of a fresh image bearing member and the variation of the surface roughness before and after the test was extremely small. This is the result of forming the circulating surface layer on the surface of the image bearing member. For this reason, the area of filming of output images was greatly reduced. To the contrary, the areas of filming of the output images of Comparative Examples 1 to 4 were large, which indicates that the sub-surface layer was contaminated. In addition, background fouling of streaks or uneven image density ascribable to this filming were also observed. This is inferred that since the surface forms of the sub-surface layers were not suitable to form circulating surface layers, circulating surface layers like those of Examples were not formed.

In addition, in Examples 3 and 4, inorganic fillers were contained in the circulating materials, which leads to less filming in particular. For this reason, quality images were produced and the change of the surface forms was subdued. Moreover, the level of the image density was good without a problem. This is inferred that since the oxazole compound was contained while photoenergy during cross-linking was made large to avoid abrasion of the sub-surface layer by the inorganic filler in the circulating material, decomposition of the charge transport compound was subdued, thereby subduing rises of voltage at the irradiated portions.

To the contrary, in Comparative Examples 5 and 6, filming was subdued successfully but the image density was reduced overall. This is inferred that since no oxazole compound was contained in Comparative Examples 5 and 6, the charge transport compound was decomposed upon application of light during cross-linking, which led to a rise of voltage at irradiated portions. In addition, the area of filming was increased in Comparative Example 7 in which cross-linking was conducted with normal irradiation energy. This is inferred that since the sub-surface layer was abraded by the circulating material containing a filler, that is, the surface form changed, the circulating surface layer was not formed properly. Furthermore, with regard to Comparative Examples 8 to 10, it is inferred that, by adding an ultraviolet ray absorbent to the sub-surface layer having a charge transport feature, the charge transport was inhibited, thereby raising the voltages at irradiated portions, which led to a decrease of image density.

### Example 18

### Manufacturing of Image Forming Apparatus

Manufacturing of Image Bearing Member

The liquid application of the undercoating layer having the following recipe, the liquid application of the charge generating layer having the following recipe, and the liquid application of the charge transport layer having the following recipe were sequentially applied to an aluminum drum having a thickness of 1.2 mm, a length of 346 mm, and an outer diameter φ of 40 mm followed by drying to form an undercoating layer having a thickness of 3.5 μm, a charge generating layer having a thickness of 0.2 μm, and a charge transport layer having a thickness of 25 μm. A liquid application of the sub-surface layer was applied thereto by spray coating. In the spray coating, a spray gun (PC-WIDE 2, manufactured by Olympos Co., Ltd.) was used with an atomization pressure of 2.1 kgf/cm² with a distance of 50 mm away from the image bearing member. The discharging amount was about 3 cc. Thereafter, the resultant was placed in a UV irradiation booth in which air was replaced with nitrogen air such that the oxygen density was 2% or less and irradiated with light under the following conditions (metal halide lamp: 160 W/cm, Irradiation distance: 120 mm, Irradiation intensity: 700 mW/cm², Irradiation time: 40 seconds) followed by drying at 130° C. for 20 minutes to form a sub-surface layer having a thickness of 3.5 μm. The image bearing member (photoreceptor) of the present disclosure was thus-obtained.

The liquid application of the sub-surface layer was prepared as follows:

100 g of YTZ ball (manufactured by Nikkato Corporation) having a φ of 2 mm was preliminarily placed in a 50 ml bottle of mayonnaise (UM sample bottle). 1.2 g of α-alumina (SUMICORUNDUM® AA-03, manufactured by Sumitomo Chemical Co., Ltd.: average primary particle diameter: 0.3 μm) and 10.8 g of a mixture of a dispersant and a solvent (THF) were added followed by dispersion for two hours at a vibration intensity of 1,600 rpm by a vibration shaker (ICA A.G) to obtain a mill base. A vehicle was added to the thus-obtained mill base to obtain a liquid application.

Unless otherwise mentioned, the liquid application of the sub-surface layer was prepared in the same manner in the following Examples and Comparative Examples.

Liquid Application for Sub-surface Layer
Alkyd resin (Beckozole 6401-50-EL, manufactured by Dainippon Ink and Chemicals, Inc.): 12 parts
Melamine resin (Super-beckamine G-821-60, manufactured by Dainippon Ink and Chemicals, Inc.): 8.0 parts
Titanium oxide (CR-EL, manufactured by ISHIHARA SANGYO KAISHA, LTD): 40 parts
Methylethylketone: 200 parts
   Liquid Application for Charge Generating Layer
      Bisazo pigment (manufactured by Ricoh Co., Ltd.) represented by the following chemical structure: 5.0 parts

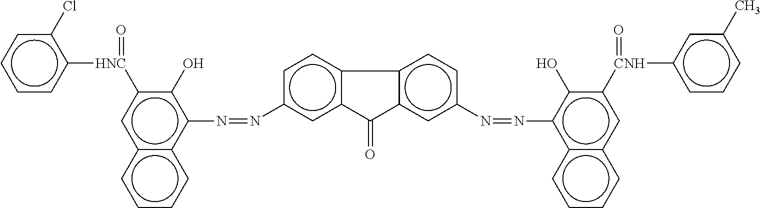

Polyvinyl butyral (XYHL, manufactured by Union Carbide Corporation (UCC)} 1.0 part
Cyclohexanone: 200 parts
Methylethylketone: 80 parts
Liquid Application for Charge Transport Layer
   Z type polycarbonate (PanLite TS-2050, manufactured by Teijin Chemicals Ltd.): 10 parts
   Charge Transport Material represented by the following chemical structure: 7.0 parts

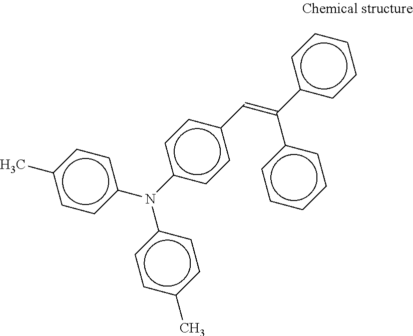

Tetrahydrofuran: 100 parts
1% Silicone oil (KF50-100CS, manufactured by Shin-Etsu Chemical Co., Ltd.): 1 part
   Liquid Application for Sub-surface Layer
Radical polymerizable compound having the charge transport structure represented by the chemical structure: 43 parts

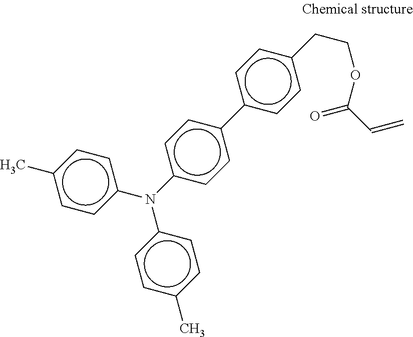

Trimethylol propane triacrylate (KAYARAD TMPTA, manufactured by Nippon Kayaku Co., Ltd.): 21 parts
Caprolactone modified dipentaerythritol hexaacrylate (DPCA 120, manufactured by Nippon Kayaku Co., Ltd.): 21 parts
Diamine compound A-1: 1 part
Mixture (BYK-UV3570, manufactured by BYK Chemie Japan) of acylic group containing polyester modified polydimethyl siloxane and propoxy-modified-2-neopentyl glycol diacrylate: 0.1 parts
1-hydroxy-cyclohexy-phenyl ketone (IRGACURE 184, manufactured by Chiba Specialty Chemicals)}: 4 parts
α-alumina (SUMICORUNDUM AA-03, manufactured by Sumitomo Chemical Co., Ltd.): 10 parts
Dispersant (ED-151, manufactured by Kusumoto Chemicals, Ltd.): 1.0 part
Tetrahydrofuran: 566 parts

Circulating Material

Zinc stearate (GF200, manufactured by NOF CORPORATION) was placed in a glass container with a lid followed by melting while being stirred by a hot stirrer in which the temperature was controlled from 160° C. to 250° C.

The stirred and melted protective agent was poured into an aluminum die having an inside dimension of 12 mm×8 mm×350 mm preliminarily heated to 150° C. to fill the die. Subsequent to cooling down to 40° on a wood board, the solid material was removed from the die followed by cooling down to room temperature while a weight was put thereon to prevent it from warping.

After cooling down, both ends of the solid material in the longitudinal direction were severed and the base was cut to obtain a protective bar having a rectangular column-like form having a dimension of 6 mm×6 mm×322 mm.

Double-faced adhesive tape was attached to the bottom of the protective agent bar 5 to fix it to a metal support.

Circulating Material Applicator

The circulating material applicator was attached to the image forming apparatus together with a device to supply the circulating material to the image bearing member and a device to apply the supplied circulating material to the image bearing member.

A device to supply the circulating material was attached to press the application brush with a pressing spring. The pressing spring had a spring constant under which the solid zinc stearate molded to have a rectangular-form column to be held by a support was consumed in a predetermined amount. The device was to scrape zinc stearate by rotation of the application brush, thereby providing the scraped powder to the image bearing member.

The pressing spring was suitably selected considering the relation between the spring constant and the consumption amount of the circulating material. As a result, a spring was used which had a spring constant of 0.039 N/mm under the condition that the ratio of the consumption (meaning the decreasing amount of the circulating material, including the amount of loss ascribable to, for example, scattering and falling from the application brush in addition to the applied amount to the image bearing member) of the circulating material was 125 mg/km. Movable fins supported by a single point were provided to both sides of the support and the spring was provided therearound to adjust the contact pressure between the application brush and the circulating material by the pulling stress of the spring.

A proper product formed by attaching a fur brush to a metal shaft was used as it was. The application brush was set to rotate counterclockwise about the moving direction of the surface of the image bearing member.

The application blade was polyurethane rubber (ShoreA hardness: 84, impact resilience: 52%, thickness: 1.3 mm) supported by a blade holder of steel plate which contacted the image bearing member at an angle of 19° in the contact direction thereof.

The image bearing member and the circulating material supplier were installed on the cyan development station of imagio MP C4500 (manufactured by Ricoh Co., Ltd.) as illustrated in FIG. 8.

The circulating material supplier was installed in the process cartridge of the image bearing member dedicated for imagio MP C4500 in place of the original circulating material applicator thereto.

Measuring and Evaluation

The surface form of the image bearing member was measured and the image and the filming were evaluated in the same manner as in Example 1.

The results are shown in Tables 8 and 9.

### Example 19

The image forming apparatus of Example 19 was manufactured in the same manner as in Example 18 except that zinc stearate used in the circulating material of Example 18 was changed to zinc oleate (manufactured by Kanto chemical Co., Inc.). The obtained image forming apparatus was evaluated in the same manner as in Example 18. The results are shown in Tables 8 and 9.

### Example 20

The image forming apparatus of Example 20 was manufactured in the same manner as in Example 18 except that zinc stearate used in the circulating material of Example 18 was changed to a mixture of 8 parts of zinc oleate, 2 parts of boron nitride, and 1 part of alumina particulates (α-alumina, AA-03, manufactured by Sumitomo Chemical Co., Ltd.). The obtained image forming apparatus was evaluated in the same manner as in Example 18. The results are shown in Tables 8 and 9.

### Example 21

The image forming apparatus of Example 21 was manufactured in the same manner as in Example 20 except that alumina particulates used in the circulating material of Example 20 was changed to silica particulates (KMPX 100, manufactured by Shin-Etsu Chemicals Co., Ltd.). The obtained image forming apparatus was evaluated in the same manner as in Example 18. The results are shown in Tables 8 and 9.

### Example 22

The image forming apparatus of Example 22 was manufactured in the same manner as in Example 18 except that α-alumina having an average primary particle diameter of 0.3 μm for use in the surface layer of the image bearing member of Example 18 was changed to α-alumina having an average primary particle diameter of 0.5 μm (AA-05, manufactured by Sumitomo Chemical Co., Ltd.). The obtained image forming apparatus was evaluated in the same manner as in Example 18. The results are shown in Tables 8 and 9.

### Example 23

The image forming apparatus of Example 23 was manufactured in the same manner as in Example 18 except that the liquid application of the sub-surface layer of the image bearing member was changed to the following liquid application. The obtained image forming apparatus was evaluated in the same manner as in Example 18. The results are shown in Tables 8 and 9.

Liquid Application for Sub-surface Layer
Radical polymerizable compound having the charge transport structure represented by the chemical structure: 43 parts

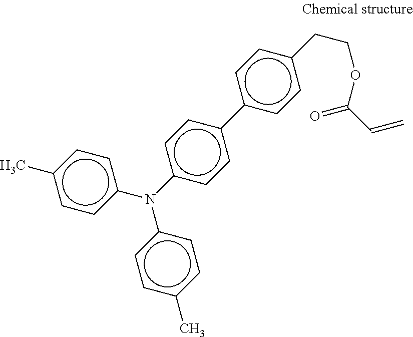

Trimethylol propane triacrylate (KAYARAD TMPTA, manufactured by Nippon Kayaku Co., Ltd.): 21 parts
Caprolactone modified dipentaerythritol hexaacrylate (DPCA 120, manufactured by Nippon Kayaku Co., Ltd.): 21 parts
Diamine compound A-1: 1 part
Mixture (BYK-UV3570, manufactured by BYK Chemie Japan) of acrylic group containing polyester modified polydimethyl siloxane and propoxy-modified-2-neopentyl glycol diacrylate: 0.1 parts
1-hydroxy-cyclohexy-phenyl ketone (IRGACURE 184, manufactured by Chiba Specialty Chemicals)}: 4 parts
α-alumina (SUMICORUNDUM AA-03, manufactured by Sumitomo Chemical Co., Ltd.): 9 parts
Dispersant (ED-151, manufactured by Kusumoto Chemicals, Ltd.) for α-alumina: 0.9 parts
Tin oxide (NanoTek, SnO₂, manufactured by C. I. Kasei Co., Ltd.): 1 part
Dispersant (ED-152, manufactured by Kusumoto Chemicals, Ltd.) for tin oxide: 0.1 parts
Tetrahydrofuran: 566 parts

### Example 24

The image forming apparatus of Example 24 was manufactured in the same manner as in Example 18 except that 1.0 part of the dispersant (ED-151, manufactured by Kusumoto Chemicals, Ltd.) of the liquid application of the sub-surface layer was changed to 0.35 parts of ED-151 and 0.65 parts of the dispersant (WK-13E, manufactured by Kyoeisha Chemical Co., Ltd.). The obtained image forming apparatus was evaluated in the same manner as in Example 18. The results are shown in Tables 8 and 9.

### Example 25

The image forming apparatus of Example 25 was manufactured in the same manner as in Example 1 except that 1.0 part of the dispersant (ED-151, manufactured by Kusumoto Chemicals, Ltd.) of the liquid application of the sub-surface layer was changed to 1 part of the dispersant (Superdyne V-201, manufactured by Takemoto Oil & Fat Co., Ltd.). The obtained image forming apparatus was evaluated in the same manner as in Example 18. The results are shown in Tables 8 and 9.

### Example 26

The image forming apparatus of Example 26 was manufactured in the same manner as in Example 18 except that the diamine compound A-2 was used in place of the diamine compound A-1. The obtained image forming apparatus was evaluated in the same manner as in Example 18. The results are shown in Tables 8 and 9.

### Example 27

The image forming apparatus of Example 27 was manufactured in the same manner as in Example 18 except that the diamine compound A-3 was used in place of the diamine compound A-1. The obtained image forming apparatus was evaluated in the same manner as in Example 18. The results are shown in Tables 8 and 9.

### Example 28

The image forming apparatus of Example 28 was manufactured in the same manner as in Example 18 except that the diamine compound A-4 was used in place of the diamine compound A-1. The obtained image forming apparatus was evaluated in the same manner as in Example 18. The results are shown in Tables 8 and 9.

### Example 29

The image forming apparatus of Example 29 was manufactured in the same manner as in Example 18 except that the diamine compound A-5 was used in place of the diamine compound A-1. The obtained image forming apparatus was evaluated in the same manner as in Example 18. The results are shown in Tables 8 and 9.

### Example 30

The image forming apparatus of Example 30 was manufactured in the same manner as in Example 18 except that the diamine compound A-6 was used in place of the diamine compound A-1. The obtained image forming apparatus was evaluated in the same manner as in Example 18. The results are shown in Tables 8 and 9.

### Example 31

The image forming apparatus of Example 31 was manufactured in the same manner as in Example 18 except that the diamine compound A-7 was used in place of the diamine compound A-1. The obtained image forming apparatus was evaluated in the same manner as in Example 18. The results are shown in Tables 8 and 9.

### Example 32

The image forming apparatus of Example 32 was manufactured in the same manner as in Example 18 except that the content of the diamine compound A-1 was changed from 1 parts to 0.5 parts. The obtained image forming apparatus was evaluated in the same manner as in Example 18. The results are shown in Tables 8 and 9.

### Example 33

The image forming apparatus of Example 33 was manufactured in the same manner as in Example 18 except that the content of the diamine compound A-1 was changed from 1 part to 2 parts. The obtained image forming apparatus was evaluated in the same manner as in Example 18. The results are shown in Tables 8 and 9.

### Example 34

The image forming apparatus of Example 16 was manufactured in the same manner as in Example 18 except that α-alumina particulates used in the circulating material of Example 18 was changed to silica particulates (KMPX 100, manufactured by Shin-Etsu Chemicals Co., Ltd.). The obtained image forming apparatus was evaluated in the same manner as in Example 18. The results are shown in Tables 8 and 9.

### Example 35

The image forming apparatus of Example 35 was manufactured in the same manner as in Example 18 except that α-alumina particulates used in the circulating material of Example 18 was changed to titanium oxide particulates (CR-97, manufactured by Ishihara Sangyo Kaisha, Ltd.). The obtained image forming apparatus was evaluated in the same manner as in Example 18. The results are shown in Tables 8 and 9.

### Comparative Example 11

The image forming apparatus of Comparative Example 11 was manufactured in the same manner as in Example 18 except that α-alumina having an average primary particle diameter of 0.3 μm for use in the surface layer of the image bearing member of Example 18 was changed to α-alumina having an average primary particle diameter of 0.7 μm (AA-07, manufactured by Sumitomo Chemical Co., Ltd.). The obtained image forming apparatus was evaluated in the same manner as in Example 18. The results are shown in Tables 8 and 9.

### Comparative Example 12

The image forming apparatus of Comparative Example 12 was manufactured in the same manner as in Example 18 except that 1.0 part of the dispersant (ED-151, manufactured by Kusumoto Chemicals, Ltd.) of the liquid application of the sub-surface layer of the image bearing member of Example 18 was changed to 0.2 parts of the dispersant (BYK-P104, manufactured by BYK Chemie Japan). The obtained image forming apparatus was evaluated in the same manner as in Example 18. The results are shown in Tables 8 and 9.

### Comparative Example 13

The image forming apparatus of Comparative Example 13 was manufactured in the same manner as in Example 18 except that 1.0 part of the dispersant (ED-151, manufactured by Kusumoto Chemicals, Ltd.) of the liquid application of the sub-surface layer of the image bearing member of Example 18 was changed to 0.2 parts of the dispersant (DOPA33, manufactured by Kyoeisha Chemical Co., Ltd.). The obtained image forming apparatus was evaluated in the same manner as in Example 18. The results are shown in Tables 8 and 9.

### Comparative Example 14

The image forming apparatus of Comparative Example 22 was manufactured in the same manner as in Example 22 except that the diamine compound was removed and the content of tetrahydrofuran was changed from 566 parts to 504 parts. The obtained image forming apparatus was evaluated in the same manner as in Example 22. The results are shown in Tables 8 and 9.

### Comparative Example 15

The image forming apparatus of Comparative Example 15 was manufactured in the same manner as in Example 22 except that anti-oxidant having the following chemical structure was added instead of the diamine compound for use in the sub-surface layer of the image bearing member of Example 22. The obtained image forming apparatus was evaluated in the same manner as in Example 22. The results are shown in Tables 8 and 9.

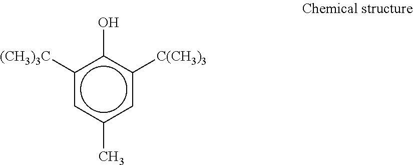

### Comparative Example 16

The image forming apparatus of Comparative Example 16 was manufactured in the same manner as in Example 22 except that anti-oxidant having the following chemical structure was added instead of the diamine compound for use in the sub-surface layer of the image bearing member of Example 22. The obtained image forming apparatus was evaluated in the same manner as in Example 22. The results are shown in Tables 8 and 9.

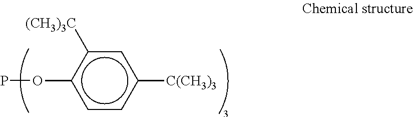

TABLE 8

| | WRa (μm) before test | | | | WRa (μm) after test | | | |
|---|---|---|---|---|---|---|---|---|
| | HMH | HML | HLH | LLH | HMH | HML | HLH | LLH |
| Example 18 | 0.002 | 0.003 | 0.003 | 0.027 | 0.004 | 0.005 | 0.005 | 0.036 |
| Example 19 | 0.002 | 0.003 | 0.003 | 0.026 | 0.004 | 0.004 | 0.005 | 0.042 |
| Example 20 | 0.002 | 0.003 | 0.003 | 0.026 | 0.004 | 0.004 | 0.005 | 0.043 |
| Example 21 | 0.002 | 0.003 | 0.003 | 0.027 | 0.004 | 0.004 | 0.005 | 0.048 |
| Example 22 | 0.002 | 0.003 | 0.004 | 0.031 | 0.003 | 0.004 | 0.005 | 0.044 |
| Example 23 | 0.002 | 0.002 | 0.004 | 0.032 | 0.003 | 0.004 | 0.004 | 0.042 |
| Example 24 | 0.002 | 0.002 | 0.002 | 0.033 | 0.004 | 0.005 | 0.005 | 0.046 |
| Example 25 | 0.002 | 0.003 | 0.003 | 0.04 | 0.003 | 0.004 | 0.005 | 0.047 |
| Example 26 | 0.002 | 0.003 | 0.003 | 0.029 | 0.003 | 0.004 | 0.004 | 0.037 |
| Example 27 | 0.002 | 0.003 | 0.003 | 0.027 | 0.004 | 0.004 | 0.005 | 0.039 |
| Example 28 | 0.002 | 0.003 | 0.003 | 0.028 | 0.004 | 0.005 | 0.004 | 0.037 |
| Example 29 | 0.002 | 0.003 | 0.003 | 0.029 | 0.003 | 0.003 | 0.004 | 0.037 |
| Example 30 | 0.002 | 0.003 | 0.003 | 0.028 | 0.004 | 0.004 | 0.004 | 0.037 |
| Example 31 | 0.002 | 0.003 | 0.003 | 0.029 | 0.003 | 0.004 | 0.004 | 0.038 |
| Example 32 | 0.002 | 0.003 | 0.003 | 0.028 | 0.004 | 0.005 | 0.004 | 0.037 |
| Example 33 | 0.002 | 0.003 | 0.003 | 0.028 | 0.004 | 0.005 | 0.004 | 0.041 |
| Example 34 | 0.002 | 0.003 | 0.002 | 0.025 | 0.004 | 0.005 | 0.004 | 0.046 |
| Example 35 | 0.002 | 0.003 | 0.003 | 0.027 | 0.004 | 0.005 | 0.004 | 0.048 |
| Comparative | 0.002 | 0.005 | 0.007 | 0.036 | 0.003 | 0.005 | 0.01 | 0.042 |
| Example 11 | | | | | | | | |
| Comparative | 0.003 | 0.003 | 0.004 | 0.092 | 0.004 | 0.004 | 0.004 | 0.123 |
| Example 12 | | | | | | | | |
| Comparative | 0.003 | 0.006 | 0.007 | 0.036 | 0.004 | 0.008 | 0.01 | 0.158 |
| Example 13 | | | | | | | | |
| Comparative | 0.002 | 0.003 | 0.003 | 0.026 | 0.006 | 0.007 | 0.011 | 0.136 |
| Example 14 | | | | | | | | |
| Comparative | 0.002 | 0.003 | 0.003 | 0.026 | 0.003 | 0.004 | 0.005 | 0.041 |
| Example 15 | | | | | | | | |
| Comparative | 0.002 | 0.003 | 0.003 | 0.028 | 0.004 | 0.004 | 0.004 | 0.038 |
| Example 16 | | | | | | | | |

TABLE 9

| | | Filming | |
|---|---|---|---|
| | Image | area | |
| | evaluation | (%) | Note |
| Example 18 | 4 | 1.3 | Good |
| Example 19 | 4 | 1.2 | Good |
| Example 20 | 5 | 0.6 | Good |
| Example 21 | 5 | 0.7 | Good |
| Example 22 | 4 | 1.7 | Good |
| Example 23 | 4 | 1.8 | Good |
| Example 24 | 5 | 0.7 | Particularly good |
| Example 25 | 5 | 0.7 | Particularly good |
| Example 26 | 4 | 1.3 | Good |
| Example 27 | 4 | 1.3 | Good |
| Example 28 | 4 | 1.2 | Good |
| Example 29 | 4 | 1.6 | Good |
| Example 30 | 4 | 1.4 | Good |
| Example 31 | 4 | 1.2 | Good |
| Example 32 | 4 | 1.9 | Good |
| Example 33 | 4 | 1.8 | Slightly low image |
| | | | density |
| Example 34 | 4 | 1.6 | Slightly dot scattered |
| Example 35 | 4 | 1.5 | Slightly low image |
| | | | density |
| Comparative Example | 2 | 8.2 | Background fouling |
| 11 | | | with streaks locally |
| Comparative Example | 2 | 7.8 | Uneven image density |
| 12 | | | (streak) |
| Comparative Example | 1 | 10.8 | Uneven image density |
| 13 | | | (streak) |
| Comparative Example | 2 | 6.8 | Background fouling |
| 14 | | | with streaks locally |
| | | | Low image density |
| Comparative Example | 2 | 1.2 | Low image density |
| 15 | | | |
| Comparative Example | 2 | 1.7 | Low image density |
| 16 | | | |

The image forming apparatuses of Examples 18 to 35 maintained the quality level such that the surfaces of the image bearing members after a durability test were not distinguishable from that of a fresh image bearing member and the variation of the surface roughness before and after the test was extremely small. This is the result of forming the circulating surface layer on the surface of the image bearing member. For this reason, the area of filming of output images was greatly reduced. To the contrary, the areas of filming of the output images of Comparative Examples 11 to 13 were large, which indicates that the sub-surface layer was contaminated. In addition, background fouling of streaks or uneven image density ascribable to this filming was also observed. This is inferred that since the surface forms of the sub-surface layers were not suitable to form circulating surface layers, circulating surface layers like those of Examples were not formed.

In addition, in Examples 20 and 21, inorganic fillers were contained in the circulating materials, which leads to less filming in particular. For this reason, quality images were produced and the change of the surface forms was subdued. Moreover, the level of the image density was good without a problem.

The area of filming was increased in Comparative Example 14 in which no diamine compound was added. Also, the image density was decreased. This is inferred that since the sub-surface layer was deformed by abrasion of the surface layer ascribable to degradation of the sub-surface layer, a circulating surface layer was not formed properly. Moreover, since the charge transport material was degraded at the same time, the voltage at irradiated portions rose, thereby reducing the image density.

Furthermore, with regard to Comparative Examples 15 to 16, it is inferred that, by adding an anti-oxidant to the sub-surface layer having a charge transport feature, the charge transport was inhibited, thereby raising the voltages at irradiated portions, which leads to decrease of image density.

### Synthesis Example 1

### Synthesis of Diamine Compound No. 4

5.00 g (16.6 mmol) of aldehyde compound represented by the following chemical formula M1, 3.27 g (16.6 mmol) of dibenzyl amine, 5.18 g (23.2 mmol) of sodium triacetoxy borohydride, and 70 ml of tetrahydrofuran (THF) were stirred in argon atmosphere at 25° C. (inside temperature) for 2 hours.

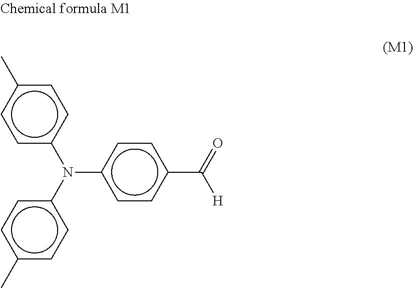

After two hours, 50 ml of 1M aqueous solution of sodium carbonate was poured to the resultant followed by a 30 minute stirring to conduct extraction with ethyl acetate. The resultant was condensed by washing the organic layer to obtain colorless transparent oil of the diamine compound No. 4 represented by the following chemical formula M2. 6.44 g (13.3 mmol) Yield: 80.1%

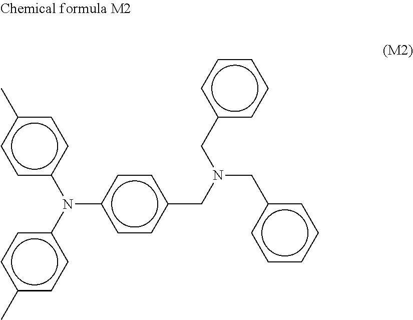

The-thus obtained oil was analyzed by Liquid Chromatography—Mass Spectrometry (LC-MS). A peak of 483.52 corresponding to molecule ion [M+H]+ in which a proton was added to the target compound Diamine compound No. 4 (molecular weight calculation value: 482.66) was observed.

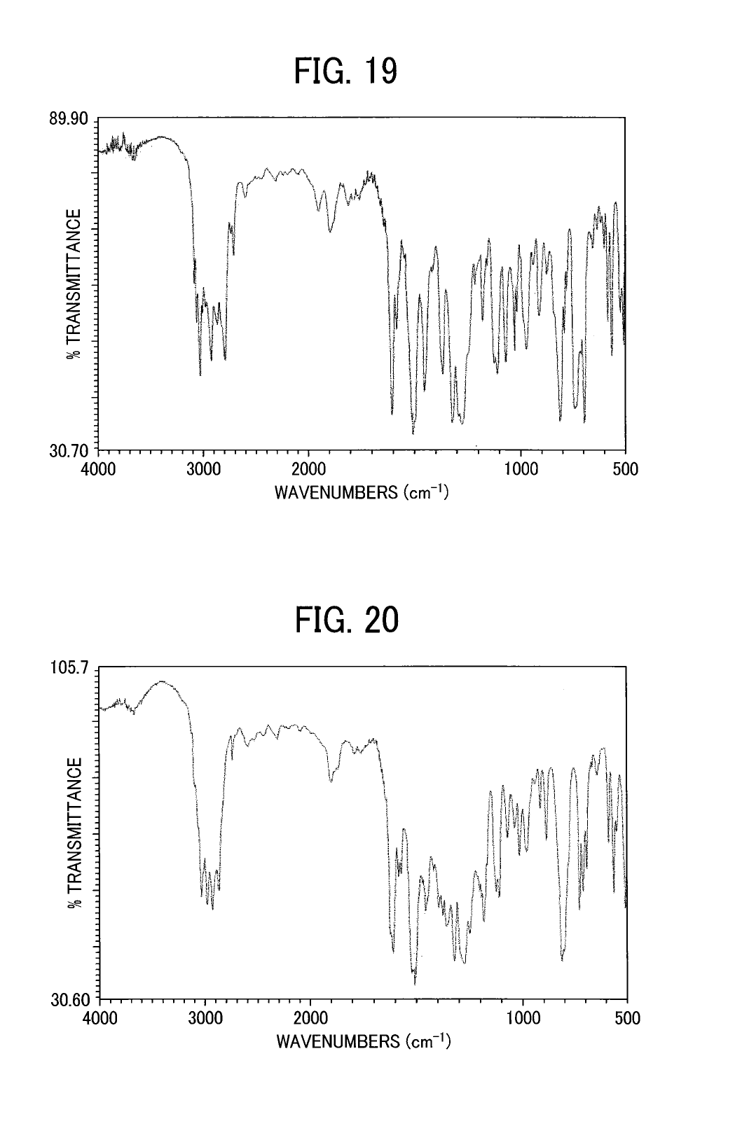

The infra-red absorption spectrum graph (NaCl method) is shown as FIG. 19.

### Synthesis Example 2

### Synthesis of Diamine Compound No. 5

5.00 g (16.6 mmol) of aldehyde compound represented by the following chemical formula M3, 2.75 g (18.3 mmol) of N-ethyl-p-toluidine, 5.18 g (23.2 mmol) of sodium triacetoxy borohydride, and 70 ml of tetrahydrofuran (THF) were stirred in argon atmosphere at 25° C. (inside temperature) for 22 hours.

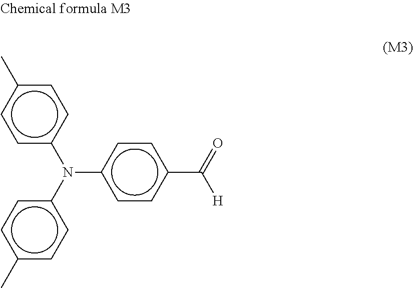

After 22 hours, 50 ml of 1M aqueous solution of sodium carbonate was poured to the resultant followed by a 30 minute stirring to conduct extraction with ethyl acetate. The resultant was condensed by washing the organic layer to obtain yellow oil of the diamine compound No. 5 represented by the following chemical formula M4. 2.59 g (6.2 mmol) Yield: 37.3%

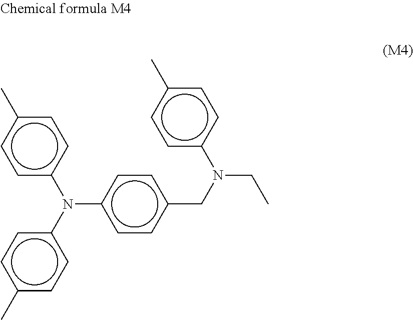

The-thus obtained oil was analyzed by Liquid Chromatography—Mass Spectrometry (LC-MS). A peak of 421.60 corresponding to molecule ion [M+H]⁺ in which a proton was added to the target compound Diamine compound No. 5 (molecular weight calculation value: 420.59) was observed.

The infra-red absorption spectrum graph (NaCl method) is shown as FIG. 20.

### Synthesis Example 3

### Synthesis of Diamine Compound No. 6

5.00 g (16.6 mmol) of aldehyde compound represented by the following chemical formula M5, 2.69 g (18.3 mmol) of N-ethyl-benzyl amine, 5.18 g (23.2 mmol) of sodium triacetoxy borohydride, and 70 ml of tetrahydrofuran (THF) were stirred in argon atmosphere at 25° C. (inside temperature) for 4 hours.

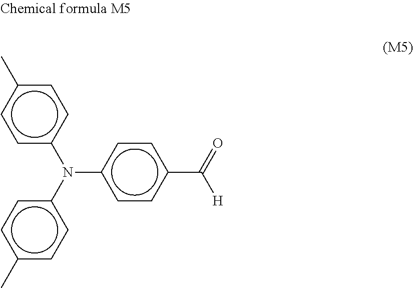

After 4 hours, 50 ml of 1M aqueous solution of sodium carbonate was poured to the resultant followed by a 30 minute stirring to conduct extraction with ethyl acetate. The resultant was condensed by washing the organic layer to obtain yellow oil of the diamine compound No. 6 represented by the following chemical formula M6. 4.56 g (10.8 mmol) Yield: 65.1%

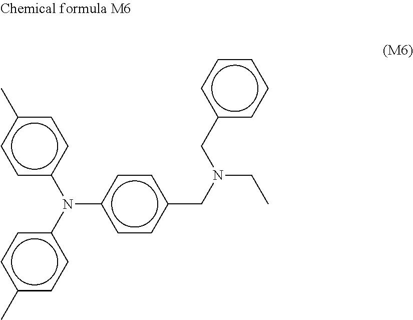

The thus-obtained oil was analyzed by Liquid Chromatography—Mass Spectrometry (LC-MS). A peak of 421.52 corresponding to molecule ion [M+H]⁺ in which a proton was added to the target compound Diamine compound No. 6 (molecular weight calculation value: 420.59) was observed.

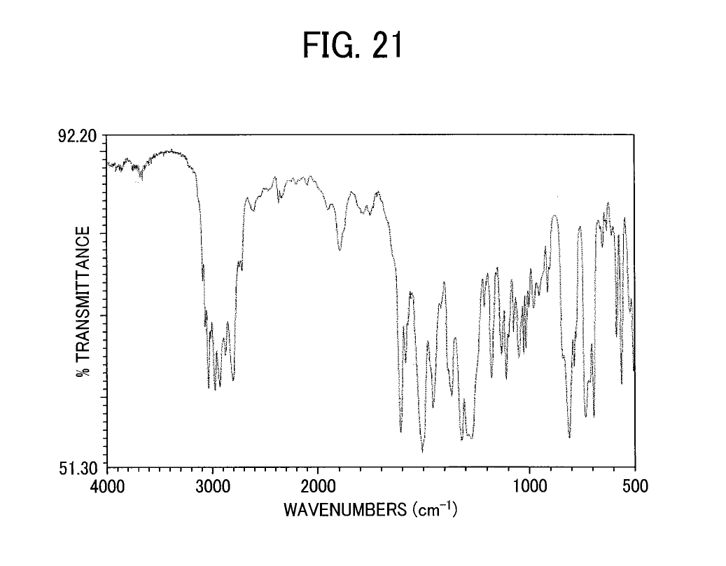

The infra-red absorption spectrum graph (NaCl method) is shown as FIG. 21.

### Example 36

The image forming apparatus of Example 36 was manufactured in the same manner as in Example 18 except that the diamine compound No. 4 was used in place of the diamine compound A-1. The obtained image forming apparatus was evaluated in the same manner as in Example 18. The results are shown in Tables 10 and 11.

### Example 37

The image forming apparatus of Example 37 was manufactured in the same manner as in Example 36 except that zinc stearate used in the circulating material of Example 36 was changed to zinc oleate (manufactured by Kanto chemical Co., Inc.). The obtained image forming apparatus was evaluated in the same manner as in Example 36. The results are shown in Tables 10 and 11.

### Example 38

The image forming apparatus of Example 38 was manufactured in the same manner as in Example 36 except that zinc stearate used in the circulating material of Example 36 was changed to a mixture of 8 parts of zinc oleate, 2 parts of boron nitride, and 1 part of alumina particulates (α-alumina, AA-03, manufactured by Sumitomo Chemical Co., Ltd.). The obtained image forming apparatus was evaluated in the same manner as in Example 36. The results are shown in Tables 10 and 11.

### Example 39

The image forming apparatus of Example 39 was manufactured in the same manner as in Example 38 except that alumina particulates used in the circulating material of Example 38 was changed to silica particulates (KMPX 100, manufactured by Shin-Etsu Chemicals Co., Ltd.). The obtained image forming apparatus was evaluated in the same manner as in Example 36. The results are shown in Tables 10 and 11.

### Example 40

The image forming apparatus of Example 40 was manufactured in the same manner as in Example 36 except that α-alumina having an average primary particle diameter of 0.3 μm for use in the surface layer of the image bearing member of Example 36 was changed to α-alumina having an average primary particle diameter of 0.5 μm (AA-05, manufactured by Sumitomo Chemical Co., Ltd.). The obtained image forming apparatus was evaluated in the same manner as in Example 36. The results are shown in Tables 10 and 11.

### Example 41

The image forming apparatus of Example 41 was manufactured in the same manner as in Example 36 except that the liquid application of the sub-surface layer of the image bearing member was changed to the following liquid application. The obtained image forming apparatus was evaluated in the same manner as in Example 36. The results are shown in Tables 10 and 11.

Liquid Application for Sub-surface Layer
Radical polymerizable compound having the charge transport structure represented by the chemical structure: 43 parts

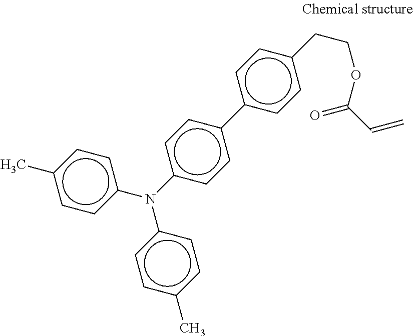

Trimethylol propane triacrylate (KAYARAD TMPTA, manufactured by Nippon Kayaku Co., Ltd.): 21 parts
Caprolactone modified dipentaerythritol hexaacrylate (DPCA 120, manufactured by Nippon Kayaku Co., Ltd.): 21 parts
Diamine compound No. 4: 1 part
Mixture (BYK-UV3570, manufactured by BYK Chemie Japan) of acylic group containing polyester modified polydimethyl siloxane and propoxy-modified-2-neopentyl glycol diacrylate: 0.1 parts
1-hydroxy-cyclohexy-phenyl ketone (IRGACURE 184, manufactured by Chiba Specialty Chemicals)}: 4 parts
α-alumina (SUMICORUNDUM AA-03, manufactured by Sumitomo Chemical Co., Ltd.): 9 parts
Dispersant (ED-151, manufactured by Kusumoto Chemicals, Ltd.) for α-alumina: 0.9 part
Tin oxide (NanoTek, SnO₂, manufactured by C. I. Kasei Co., Ltd.): 1 part
Dispersant (ED-152, manufactured by Kusumoto Chemicals, Ltd.) for tin oxide: 0.1 parts
Tetrahydrofuran: 566 parts

### Example 42

The image forming apparatus of Example 42 was manufactured in the same manner as in Example 36 except that 1.0 part of the dispersant (ED-151, manufactured by Kusumoto Chemicals, Ltd.) of the liquid application of the sub-surface layer was changed to 0.35 parts of ED-151 and 0.65 parts of the dispersant (WK-13E, manufactured by Kyoeisha Chemical Co., Ltd.). The obtained image forming apparatus was evaluated in the same manner as in Example 36. The results are shown in Tables 10 and 11.

### Example 43

The image forming apparatus of Example 43 was manufactured in the same manner as in Example 36 except that 1.0 part of the dispersant (ED-151, manufactured by Kusumoto Chemicals, Ltd.) of the liquid application of the sub-surface layer was changed to 1 part of the dispersant (Superdyne V-201, manufactured by Takemoto Oil & Fat Co., Ltd.). The obtained image forming apparatus was evaluated in the same manner as in Example 36. The results are shown in Tables 10 and 11.

### Example 44

The image forming apparatus of Example 44 was manufactured in the same manner as in Example 36 except that the diamine compound No. 1 was used in place of the diamine compound No. 4. The obtained image forming apparatus was evaluated in the same manner as in Example 36. The results are shown in Tables 10 and 11.

### Example 45

The image forming apparatus of Example 45 was manufactured in the same manner as in Example 36 except that the diamine compound No. 2 was used in place of the diamine compound No. 4. The obtained image forming apparatus was evaluated in the same manner as in Example 36. The results are shown in Tables 10 and 11.

### Example 46

The image forming apparatus of Example 46 was manufactured in the same manner as in Example 36 except that the diamine compound No. 3 was used in place of the diamine compound No. 4. The obtained image forming apparatus was evaluated in the same manner as in Example 36. The results are shown in Tables 10 and 11.

### Example 47

The image forming apparatus of Example 47 was manufactured in the same manner as in Example 36 except that the diamine compound No. 5 was used in place of the diamine compound No. 4. The obtained image forming apparatus was evaluated in the same manner as in Example 36. The results are shown in Tables 10 and 11.

### Example 48

The image forming apparatus of Example 48 was manufactured in the same manner as in Example 36 except that the diamine compound No. 6 was used in place of the diamine compound No. 4. The obtained image forming apparatus was evaluated in the same manner as in Example 36. The results are shown in Tables 10 and 11.

### Example 49

The image forming apparatus of Example 48 was manufactured in the same manner as in Example 36 except that the diamine compound No. 11 was used in place of the diamine compound No. 4. The obtained image forming apparatus was evaluated in the same manner as in Example 36. The results are shown in Tables 10 and 11.

### Example 50

The image forming apparatus of Example 50 was manufactured in the same manner as in Example 36 except that the content of the diamine compound No. 4 was changed from 1 part to 0.5 parts. The obtained image forming apparatus was evaluated in the same manner as in Example 36. The results are shown in Tables 10 and 11.

### Example 51

The image forming apparatus of Example 51 was manufactured in the same manner as in Example 36 except that the content of the diamine compound No. 4 was changed from 1 part to 2 parts. The obtained image forming apparatus was evaluated in the same manner as in Example 36. The results are shown in Tables 10 and 11.

### Example 52

The image forming apparatus of Example 52 was manufactured in the same manner as in Example 36 except that α-alumina particulates used in the circulating material of Example 36 was changed to silica particulates (KMPX 100, manufactured by Shin-Etsu Chemicals Co., Ltd.). The obtained image forming apparatus was evaluated in the same manner as in Example 36. The results are shown in Tables 10 and 11.

### Example 53

The image forming apparatus of Example 53 was manufactured in the same manner as in Example 36 except that α-alumina particulates used in the circulating material of Example 36 was changed to titanium oxide particulates (CR-97, manufactured by Ishihara Sangyo Kaisha, Ltd.). The obtained image forming apparatus was evaluated in the same manner as in Example 36. The results are shown in Tables 10 and 11.

### Comparative Example 17

The image forming apparatus of Comparative Example 17 was manufactured in the same manner as in Example 36 except that α-alumina having an average primary particle diameter of 0.3 μm for use in the surface layer of the image bearing member of Example 36 was changed to α-alumina having an average primary particle diameter of 0.7 μm (AA-07, manufactured by Sumitomo Chemical Co., Ltd.). The obtained image forming apparatus was evaluated in the same manner as in Example 36. The results are shown in Tables 10 and 11.

### Comparative Example 18

The image forming apparatus of Comparative Example 18 was manufactured in the same manner as in Example 36 except that 1.0 part of the dispersant (ED-151, manufactured by Kusumoto Chemicals, Ltd.) of the liquid application of the sub-surface layer of the image bearing member of Example 36 was changed to 0.2 parts of the dispersant (BYK-P104, manufactured by BYK Chemie Japan). The obtained image forming apparatus was evaluated in the same manner as in Example 36. The results are shown in Tables 10 and 11.

### Comparative Example 19

The image forming apparatus of Comparative Example 19 was manufactured in the same manner as in Example 36 except that 1.0 part of the dispersant (ED-151, manufactured by Kusumoto Chemicals, Ltd.) of the liquid application of the sub-surface layer of the image bearing member of Example 36 was changed to 0.2 parts of the dispersant (DOPA33, manufactured by Kyoeisha Chemical Co., Ltd.). The obtained image forming apparatus was evaluated in the same manner as in Example 36. The results are shown in Tables 10 and 11.

### Comparative Example 20

The image forming apparatus of Comparative Example 20 was manufactured in the same manner as in Example 36 except that α-alumina and the dispersant were removed and the content of tetrahydrofuran was changed from 566 parts to 504 parts. The obtained image forming apparatus was evaluated in the same manner as in Example 36. The results are shown in Tables 10 and 11.

### Comparative Example 21

The image forming apparatus of Comparative Example 21 was manufactured in the same manner as in Example 40 except that the diamine compound was removed and the content of tetrahydrofuran was changed from 566 parts to 504 parts. The obtained image forming apparatus was evaluated in the same manner as in Example 40. The results are shown in Tables 10 and 11.

### Comparative Example 22

The image forming apparatus of Comparative Example 23 was manufactured in the same manner as in Example 40 except that an anti-oxidant having the following chemical structure was added instead of the diamine compound for use in the sub-surface layer of the image bearing member of Example 40. The obtained image forming apparatus was evaluated in the same manner as in Example 40. The results are shown in Tables 10 and 11.

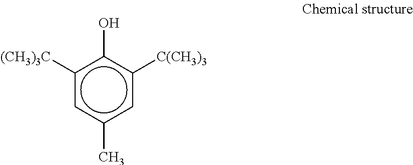

### Comparative Example 23

The image forming apparatus of Comparative Example 23 was manufactured in the same manner as in Example 40 except that an anti-oxidant having the following chemical structure was added instead of the diamine compound for use in the sub-surface layer of the image bearing member of Example 40. The obtained image forming apparatus was evaluated in the same manner as in Example 40. The results are shown in Tables 10 and 11.

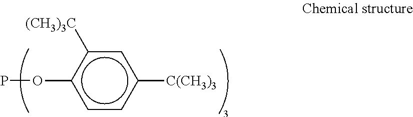

TABLE 10

| | WRa (μm) before test | | | | WRa (μm) after test | | | |
|---|---|---|---|---|---|---|---|---|
| | HMH | HML | HLH | LLH | HMH | HML | HLH | LLH |
| Example 36 | 0.002 | 0.003 | 0.003 | 0.026 | 0.005 | 0.006 | 0.006 | 0.037 |
| Example 37 | 0.002 | 0.003 | 0.003 | 0.025 | 0.005 | 0.005 | 0.006 | 0.043 |
| Example 38 | 0.002 | 0.003 | 0.003 | 0.025 | 0.005 | 0.005 | 0.006 | 0.044 |
| Example 39 | 0.002 | 0.003 | 0.003 | 0.026 | 0.005 | 0.005 | 0.006 | 0.049 |
| Example 40 | 0.002 | 0.003 | 0.004 | 0.03 | 0.004 | 0.005 | 0.006 | 0.045 |
| Example 41 | 0.002 | 0.003 | 0.004 | 0.031 | 0.004 | 0.005 | 0.005 | 0.043 |
| Example 42 | 0.002 | 0.003 | 0.002 | 0.032 | 0.005 | 0.006 | 0.006 | 0.047 |
| Example 43 | 0.002 | 0.003 | 0.003 | 0.039 | 0.004 | 0.005 | 0.006 | 0.048 |
| Example 44 | 0.002 | 0.003 | 0.003 | 0.028 | 0.004 | 0.005 | 0.005 | 0.038 |
| Example 45 | 0.002 | 0.003 | 0.003 | 0.026 | 0.005 | 0.005 | 0.006 | 0.04 |
| Example 46 | 0.002 | 0.003 | 0.003 | 0.027 | 0.005 | 0.006 | 0.005 | 0.038 |
| Example 47 | 0.002 | 0.003 | 0.003 | 0.028 | 0.004 | 0.004 | 0.005 | 0.038 |
| Example 48 | 0.002 | 0.003 | 0.003 | 0.027 | 0.005 | 0.005 | 0.005 | 0.038 |
| Example 49 | 0.002 | 0.003 | 0.003 | 0.028 | 0.004 | 0.005 | 0.005 | 0.039 |
| Example 50 | 0.002 | 0.003 | 0.003 | 0.027 | 0.005 | 0.006 | 0.006 | 0.038 |
| Example 51 | 0.002 | 0.003 | 0.003 | 0.027 | 0.005 | 0.006 | 0.005 | 0.042 |
| Example 52 | 0.002 | 0.003 | 0.002 | 0.024 | 0.005 | 0.006 | 0.005 | 0.047 |
| Example 53 | 0.002 | 0.003 | 0.003 | 0.026 | 0.005 | 0.006 | 0.005 | 0.049 |
| Comparative | 0.002 | 0.006 | 0.008 | 0.037 | 0.004 | 0.006 | 0.011 | 0.043 |
| Example 17 | | | | | | | | |
| Comparative | 0.002 | 0.004 | 0.005 | 0.093 | 0.005 | 0.005 | 0.005 | 0.124 |
| Example 18 | | | | | | | | |
| Comparative | 0.002 | 0.007 | 0.008 | 0.037 | 0.007 | 0.009 | 0.011 | 0.159 |
| Example 19 | | | | | | | | |
| Comparative | 0.002 | 0.003 | 0.006 | 0.041 | 0.005 | 0.007 | 0.006 | 0.176 |
| Example 20 | | | | | | | | |
| Comparative | 0.002 | 0.003 | 0.003 | 0.026 | 0.007 | 0.008 | 0.012 | 0.137 |
| Example 21 | | | | | | | | |
| Comparative | 0.002 | 0.003 | 0.003 | 0.026 | 0.004 | 0.005 | 0.006 | 0.042 |
| Example 22 | | | | | | | | |
| Comparative | 0.002 | 0.003 | 0.003 | 0.028 | 0.005 | 0.005 | 0.005 | 0.039 |
| Example 23 | | | | | | | | |

TABLE 11

| | | Filming | |
|---|---|---|---|
| | Image | area | |
| | evaluation | (%) | Note |
| Example 36 | 4 | 1.4 | Good |
| Example 37 | 4 | 1.3 | Good |
| Example 38 | 5 | 0.7 | Particularly good |
| Example 39 | 5 | 0.8 | Particularly good |
| Example 40 | 4 | 1.8 | Good |
| Example 41 | 4 | 1.9 | Good |
| Example 42 | 5 | 0.8 | Particularly good |
| Example 43 | 5 | 0.8 | Particularly good |
| Example 44 | 4 | 1.4 | Good |
| Example 45 | 4 | 1.4 | Good |
| Example 46 | 4 | 1.3 | Good |
| Example 47 | 4 | 1.7 | Good |
| Example 48 | 4 | 1.5 | Good |
| Example 49 | 4 | 1.3 | Good |
| Example 50 | 4 | 2 | Good |
| Example 51 | 4 | 1.9 | Slightly low image |
| | | | density |
| Example 52 | 4 | 1.7 | Slightly dot scattered |
| Example 53 | 4 | 1.6 | Slightly low image |
| | | | density |
| Comparative Example | 2 | 8.3 | Background fouling |
| 17 | | | with streaks locally |
| Comparative Example | 2 | 7.9 | Uneven image density |
| 18 | | | (streak) |
| Comparative Example | 1 | 10.9 | Uneven image density |
| 19 | | | (streak) |
| Comparative Example | 2 | 8.9 | Background fouling |
| 20 | | | with streaks locally |
| Comparative Example | 2 | 1.9 | Background fouling |
| 21 | | | with streaks locally |
| | | | Low image density |
| Comparative Example | 2 | 1.3 | Low image density |
| 22 | | | |
| Comparative Example | 2 | 1.8 | Low image density |
| 23 | | | |

The image forming apparatuses of Examples 36 to 53 maintained the quality level such that the surfaces of the image bearing members after a durability test were not distinguishable from that of a fresh image bearing member and the variation of the surface roughness before and after the test was extremely small. This is the result of forming the circulating surface layer on the surface of the image bearing member. For this reason, the area of filming of output images was greatly reduced. To the contrary, the areas of filming of the output images of Comparative Examples 17 to 20 were large, which indicates that the sub-surface layer was contaminated. In addition, background fouling of streaks or uneven image density ascribable to this filming were also observed. This is inferred that since the surface forms of the sub-surface layers were not suitable to form circulating surface layers, circulating surface layers like those of Examples were not formed.

In addition, in Examples 38 and 39, inorganic fillers were contained in the circulating materials, which leads to less filming in particular. For this reason, quality images were produced and the change of the surface forms was subdued. Moreover, the level of the image density was good without a problem.

The area of filming increased in Comparative Example 21 in which no diamine compound was added. Also, the image density decreased. This is inferred that since the sub-surface layer was deformed by abrasion of the surface layer ascribable to degradation of the sub-surface layer, a circulating surface layer was not formed properly. Moreover, since the charge transport material was degraded at the same time, the voltage at irradiated portions rose, thereby reducing the image density.

Furthermore, with regard to Comparative Examples 22 to 23, it is inferred that, by adding an anti-oxidant to the sub-surface layer having a charge transport feature, the charge transport was inhibited, thereby raising the voltages at irradiated portions, which leads to decrease of image density.

As described above, the present invention provides an image forming apparatus and a process cartridge which are capable of outputting quality images for an extended period of time for an extended period of time with long service life and low print cost.

According to the present invention, an image forming apparatus is provided which has a long service life with low print cost.

Having now fully described embodiments of the present invention, it will be apparent to one of ordinary skill in the art that many changes and modifications can be made thereto without departing from the spirit and scope of embodiments of the invention as set forth herein.

What is claimed is:

1. An image forming apparatus comprising:
an image bearing member comprising:
a photosensitive layer; and
a sub-surface layer having a charge transportability overlying the photosensitive layer;
a charger to charge a surface of the image bearing member;
an irradiator to irradiate the surface of the image bearing member to form a latent electrostatic image thereon;
a development device to develop the latent electrostatic image to obtain a visible image;
a transfer device to transfer the visible image to a recording medium;
a cleaning device to clean the surface of the image bearing member; and
a circulating material applicator that contacts the image bearing member to apply a circulating material to the surface thereof to form a circulating surface layer as an uppermost surface layer of the image bearing member, the circulating material applicator being arranged upstream from the charger and downstream from the cleaning device relative to a rotation direction of the image bearing member,
wherein the sub-surface layer comprises a cured material formed of a radical polymerizable monomer having three or more functional groups with no charge transport structure and a radical polymerizable compound having a charge transport structure,
wherein, when an arithmetical mean roughness WRa about each of frequency components is obtained by the following processes I to V of,
I. Making single dimensional data arrangement by measuring by a surface texture and the contour form measuring device;
II. Separating the single dimensional data arrangement into six frequency components of HHH, HHL, HMH, HML, HLH, and HLL) from high frequency components to low frequency components by wavelet conversion by multi-resolution analysis,
III. Thinning out a single dimensional data arrangement of a minimum frequency component of the six frequency components such that the number of data arrangement is reduced to 1/10 to 1/100,
IV. Conducting separation into additional six frequency components of LHH, LHL, LMH, LML, LLH, and LLL from high frequency components to low frequency components by wavelet conversion by multi-resolution analysis, and
V. Calculating the arithmetical mean roughness WRa of each of 12 frequency components obtained as above, of the frequency components obtained in II and IV, WRas of bandwidths of HMH, HML, and HLH range from 0.002 μm to 0.005 μm and WRa of LLH is 0.05 μm or less,
wherein the sub-surface layer comprises at least one of an oxazole compound represented by a chemical formula 1 or a chemical formula 2 or a diamine compound represented by a chemical formula 3 or a chemical formula 4, 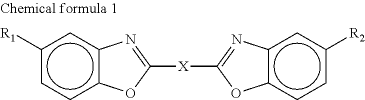
Where, R₁ and R₂ each, independently represent hydrogen atoms or alkyl groups having one to four carbon atoms and X represents a vinylene group, a bifunctional group of an aromatic hydrocarbon having 6 to 14 carbon atoms, or 2,5-thiophenediyl group, 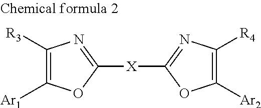
where, Ar₁ and Ar₂ each, independently represent monofunctional groups of aromatic hydrocarbons having 6 to 14 carbon atoms, Y represents a bifunctional group of an aromatic hydrocarbon having 6 to 14 carbon atoms, and R₃ and R₄ each, independently represent hydrogen atoms or methyl groups, 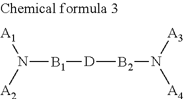
where, D represents an arylene group with or without a substitution group or a group represented by the following chemical structure, 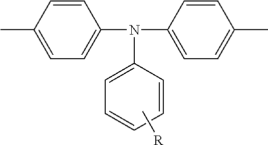
where, R represents a hydrogen atom, an alkyl group having one to four alkyl group, an alkoxy group having one to four carbon atoms,
A₁, A₂, A₃, and A₄ each, independently represent groups selected from the following i, ii, or iii,
i: an alkyl group having one to four carbon atoms,
ii: —CH₂(CH₂)mZ, where Z represents an aryl group, a cycloalkyl group, or a heterocycloalkyl group with or without a substitution group and m represents 0 or 1, and
iii: an aryl group with or without a substitution group, and
B₁ and B₂ each, independently represent —CH₂—, —CH₂CH₂—, —CH₂—Ar—, —Ar—CH₂—, —CH₂CH₂—Ar—, or —Ar—CH₂CH₂—, where Ar represents an arylene group with or without a substitution group, 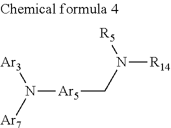
where, R₅ and R₁₄ each, independently, alkyl groups with or without a substitution group, aralkyl groups with or without a substitution group, or monofunctional groups of aromatic hydrocarbon with or without a substitution group, Ar₅ represents bifunctional groups of substituted or non-substituted aromatic hydrocarbon, Ar₇ and Ar³ each, independently represent, alkyl groups with or without a substitution group, aralkyl groups with or without a substitution group, or monofunctional groups of aromatic hydrocarbon with or without a substitution group, Ar₅ and Ar₇ or Ar₇ and Ar₃ are mutually bonded to share a substituted or non-substituted heterocyclic ring having a nitrogen atom,
wherein the frequency components are as follows:
WRa (HHH): Ra in a bandwidth in which a cycle length of convexoconcave ranges from 0.3 μm to 3 μm;
WRa (HHL): Ra in a bandwidth in which a cycle length of convexoconcave ranges from 1 μm to 6 μm;
WRa (HHL): Ra in a bandwidth in which a cycle length of convexoconcave ranges from 2 μm to 13 μm;
WRa (HML): Ra in a bandwidth in which a cycle length of convexoconcave ranges from 4 μm to 25 μm;
WRa (HLH): Ra in a bandwidth in which a cycle length of convexoconcave ranges from 10 μm to 50 μm;
WRa (HLL): Ra in a bandwidth in which a cycle length of convexoconcave ranges from 24 μm to 99 μm;
WRa (LHH): Ra in a bandwidth in which a cycle length of convexoconcave ranges from 26 μm to 106 μm;
WRa (LHL): Ra in a bandwidth in which a cycle length of convexoconcave ranges from 53 μm to 183 μm;
WRa (LMH): Ra in a bandwidth in which a cycle length of convexoconcave ranges from 106 μm to 318 μm;
WRa (LML): Ra in a bandwidth in which a cycle length of convexoconcave ranges from 214 μm to 551 μm;
WRa (LLH): Ra in a bandwidth in which a cycle length of convexoconcave ranges from 431 μm to 954 μm; and
WRa (LLL): Ra in a bandwidth in which a cycle length of convexoconcave ranges from 867 μm to 1,654 μm.

2. The image forming apparatus according to claim 1, wherein the circulating surface layer comprises a compound having a lamellar structure.

3. The image forming apparatus according to claim 2, wherein the compound having a lamellar structure is zinc stearate.

4. The image forming apparatus according to claim 1, wherein the circulating material supplied by the circulating material applicator comprises filler particulates.

5. The image forming apparatus according to claim 4, wherein the filler particulates are metal oxide particulates.

6. The image forming apparatus according to claim 5, wherein the metal oxide particulates comprises aluminum oxide.

7. The image forming apparatus according to claim 1, wherein the sub-surface layer comprises the oxazole compound and a mass ratio of the oxazole compound to the radical polymerizable compound having a charge transport structure ranges from 0.5% by weight to 10% by weight.

8. The image forming apparatus according to claim 1, wherein the sub-surface layer comprises the diamine compound and a mass ratio of the diamine compound to the sub-surface layer ranges from 0.5% by weight to 2.0% by weight.

9. The image forming apparatus according to claim 1, wherein filler particulates are dispersed in the sub-surface layer.

10. The image forming apparatus according to claim 9, wherein the filler particulates are metal oxide particulates.

11. The image forming apparatus according to claim 10, wherein the metal oxide particulates comprises aluminum oxide.

12. A process cartridge comprising:
an image bearing member comprising:
a photosensitive layer; and
a sub-surface layer having a charge transportability overlying the photosensitive layer; and
at least one of a charger to charge a surface of the image bearing member; an irradiator to irradiate the surface of the image bearing member to form a latent electrostatic image thereon; a development device to develop the latent electrostatic image to obtain a visible image; a cleaning device to clean the surface of the image bearing member; a circulating material supplier; or a circulating material applicator that contacts the image bearing member to apply a circulating material to the surface thereof to form a circulating surface layer as an uppermost surface layer of the image bearing member,
wherein the process cartridge is detachably attachable to the image forming apparatus of claim 1.
